(19) United States
(12) Patent Application Publication
(10) Pub. No.: US 2015/0154384 A1
(43) Pub. Date: Jun. 4, 2015

(54) Media Distribution System and Method

(71) Applicant: James Robert Curtis, Carrollton, TX (US)

(72) Inventor: James Robert Curtis, Carrollton, TX (US)

(21) Appl. No.: 14/618,266

(22) Filed: Feb. 10, 2015

Related U.S. Application Data
(63) Continuation-in-part of application No. 13/108,837, filed on May 16, 2011.
Application No. 13/108,837 is a continuation-in-part of application No. 12/839,294, filed on Jul. 19, 2010, now abandoned.
Application No. 12/839,294 is a continuation-in-part of application No. 12/505,342, filed on Jul. 17, 2009, now abandoned.

(51) Int. Cl. G06F 21/10

(52) U.S. Cl. CPC G06F 21/10; G06F 2221/07

(57) ABSTRACT

A media distribution system and method incorporating parallel delivery of media content is disclosed. The system/method incorporates a media distribution kiosk (MDK) having a media duplication device (MDD) to write media transportation unit (MTU) with secure media content to be distributed to a consumer. The MTU is electrically coupled to the MDD via a media robotic arm (MRA) under direction of a computing control device (CCD). The MDD stores media content retrieved from a media storage server (MSS) on the MTU in response to a local or remote consumer media transaction (CMT) with the MDK. Once written, the MTU is decoupled from the MDD by the MRA and placed in a secure media lockbox (SML). The SML is associated with the CMT by the CCD such that the consumer may access the lockbox via a secure keypad and/or credit/debit card reader.

### CROSS REFERENCE TO RELATED APPLICATIONS

### U.S. Utility Patent Applications

This is a Continuation-In-Part patent application of United States Utility Patent Application for UNIVERSAL MULTIMEDIA DISTRIBUTION, STORAGE, AND PLAYBACK SYSTEMS, AND METHODS by inventor James Curtis, filed electronically with the USPTO on May 16, 2011, with Ser. No. 13/108,837, EFS ID 10102252, confirmation number 1279, docket CCURT.0102CIP2.

### U.S. Utility Patent Applications

This application claims benefit under 35 U.S.C. §120 and incorporates by reference United States Utility Patent Application for UNIVERSAL MULTIMEDIA DISTRIBUTION, STORAGE, AND PLAYBACK SYSTEMS, AND METHODS by inventor James Curtis, filed electronically with the USPTO on May 16, 2011, with Ser. No. 13/108,837, EFS ID 10102252, confirmation number 1279, docket CCURT.0102CIP2.

### U.S. Utility Patent Applications

This application claims benefit under 35 U.S.C. §120 and incorporates by reference United States Utility Patent Application for UNIVERSAL MULTIMEDIA DISTRIBUTION, STORAGE, AND PLAYBACK SYSTEMS, AND METHODS by inventor James Curtis, filed electronically with the USPTO on Jul. 19, 2010, with Ser. No. 12/839,294, EFS ID 8047331, confirmation number 7919, docket CCURT.0102CIP1.

### U.S. Utility Patent Applications

This application claims benefit under 35 U.S.C. §120 and incorporates by reference United States Utility Patent Application for UNIVERSAL MULTIMEDIA DISTRIBUTION, STORAGE, AND PLAYBACK SYSTEMS, AND METHODS by inventor James Curtis, filed electronically with the USPTO on Jul. 17, 2009, with Ser. No. 12/505,342, EFS ID 5727232, confirmation number 1950, docket CCURT.0102.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to systems and methods in the field of digital media distribution, and specifically in applications where physical digital media must be securely delivered to consumers on demand, in volume, on a timely basis.

### PRIOR ART AND BACKGROUND OF THE INVENTION

### Overview

In recent years, consumers of digital media have seen a growing proliferation of various types of devices and systems for accessing, storing, and viewing multimedia content that is acquired via data networks such as the Internet. For example, a number of online media distributors offer consumers having internet access, the ability to purchase and download video and audio content via proprietary software that is connected to large content databases. The proprietary software permits consumers to store the media content on personal electronic devices such as a personal computer, laptop computer, personal digital assistant (PDA), personal media player, or mobile phone. Consumers may then play the content on such devices or transfer the content to other devices for storage and playback.

However, persons in approximately forty percent of households in the United States are not able to access the Internet via broadband. In fact, many households do not have access to the Internet at all. As a result, it is much more burdensome or impossible for individuals living in such households to acquire media content through the Internet. The majority of consumers not having Internet access but desiring to acquire and use digital multimedia content have until recently, had only a few available options. One option is that media content can be purchased, or rented from a retail establishment located at a site physically remote from the consumer's home. After acquiring the media, the consumer can view and/or listen to the content via a portable or fixed playback device. In the case of media acquired via rental, the media must be returned by the consumer, an often burdensome task.

Equally burdensome for the consumer who purchases media is the task of storing said media in an orderly manner and protecting it from being damaged. Because most media is still distributed in physical media device formats such as DVDs and CDs (containing video, audio, and gaming products), most consumers have accumulated a substantial number of purchased discs and other assorted media that is stored in a disorganized manner and is often unprotected from damage in the consumer's household. Devices and other systems disclosed in the prior art have sought to improve upon the means by which consumers acquire, store, and playback multimedia content.

One such system is disclosed in U.S. Patent Publication No. 2009/0117846 A1, published on May 7, 2009, and assigned to Apple, Inc. (hereinafter “the Apple '846 publication”). The Apple '846 publication discloses systems and methods that enable a media distribution system to distribute media content to a media device via one or more media distribution kiosks that are connected via a data network to a centralized media storage server. In particular, the Apple '846 publication teaches a portable media device that is configured to establish a connection (wired or wirelessly) to a media distribution kiosk so as to allow a consumer to purchase media content and download it onto his or her portable media device. The portable media device taught by the Apple '846 publication is capable of uploading media to a remote host or other client system.

Other devices disclosed in the prior art, such as the KALEIDESCAPE® 1080p Player (as configured at the time of the filing of this application) (see http://www.kaleidescape.com), are configured to permit consumers to insert optical discs such as DVDs and CDs into a player device which is capable of decrypting the information residing on the discs and storing a copy of the information onto a local or external storage drive. These prior art devices also provide users with easy to use navigational menus for accessing and playing the stored media. The foregoing capability allows consumers to store the media contained on their amassed collection of optical discs into one easily accessible system. However, one drawback of these prior art media player/storage devices is that they are not capable of communicating with a portable media storage device such as might be used in connection with the media distribution system taught by the Apple '846 publication. In fact, such systems are only capable of accessing media stored on optical discs or via data networks.

Other systems for media distribution found in the prior art suffer from similar drawbacks. One such system is the digital media distribution system disclosed in U.S. Patent Publication No. 2004/0254940 A1, published on Dec. 16, 2004, and naming Hector Cesar Brush as the inventor (hereinafter “the Brush '940 publication”). The Brush '940 publication teaches a media distribution kiosk similar to that which is taught by the Apple '846 publication. A portable digital media card is disclosed that is capable of communicating with the media distribution kiosk such that media is transferred to said media card. The Brush '940 publication further teaches a media player that is capable of receiving, reading, and storing the information residing on the portable digital media card. One drawback of the system taught by the Brush '940 publication is that the media player disclosed therein is not capable of receiving and reading optical discs. As discussed above, most consumers have a substantial collection of DVDs and CDs. The media player taught by the Brush '940 publication would not be capable of playing such DVDs or CDs, which would require consumers to use a separate player for playback of such media.

Further, existing media distribution systems tend to be stand-alone systems with no or limited ability to communicate with other like systems. Performing media updates on multiple stand-alone systems can be rather burdensome. Also, it is highly inefficient to have a cluster of distribution systems, such as in a shopping mall area, all having the same stored media. Such redundancy is highly inefficient with regards to memory capacity usage. Moreover, to increase memory storage capacity, it is necessary to upgrade each distribution system, which is even more burdensome than merely updating the media. It is the object of the invention disclosed herein to remedy these and other deficiencies found in the prior art.

### DEFICIENCIES IN THE PRIOR ART

The prior art as detailed above suffers from the following deficiencies:
Prior art media distribution systems have not addressed the issue of media security, and lack methodologies to prevent copying of media as distributed to consumers.
Prior art media distribution systems have not addressed the issue of timely on-demand duplication of media at the point of consumer sale.
Prior art media distribution systems have not addressed the issue of high definition media duplication at the point of consumer sale.
Prior art media distribution systems have not addressed the issue of coordinating delivery of media to consumers spanning large geographic areas.
Prior art media distribution systems have not addressed the issue of “peak demand” delivery to support the impulse demands for media of a given content.
Prior art media distribution systems have not addressed the issue of consumer throughput, and have limited methodologies to address media delivery to a large number of consumers at a single or multiple locations of distribution.

While some of the prior art may teach some solutions to several of these problems, the core deficiencies in the prior art systems have not been addressed.

### OBJECTIVES OF THE INVENTION

Accordingly, the objectives of the present invention are (among others) to circumvent the deficiencies in the prior art and affect the following objectives:
(1) Provide for a media distribution system and method that addresses the issue of media security, and provide methodologies to prevent copying of media as distributed to consumers.
(2) Provide for a media distribution system and method that addresses the issue of timely on-demand duplication of media at the point of consumer sale.
(3) Provide for a media distribution system and method that addresses the issue of high definition media duplication at the point of consumer sale.
(4) Provide for a media distribution system and method that addresses the issue of coordinating delivery of media to consumers spanning large geographic areas.
(5) Provide for a media distribution system and method that addresses the issue of “peak demand” delivery to support the impulse demands for media of a given content.
(6) Provide for a media distribution system and method that addresses the issue of high consumer throughput, and provide methodologies to address media delivery to a large number of consumers at a single or multiple locations of distribution.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention addresses several of the deficiencies in the prior art by integrating the duplication of digital media content with custom hardware designed to provide the required digital rights management (DRM) security. This is accomplished using a combination of custom USB hardware integrating foreground file system (FFS) and a background file system (BFS) that allows only authorized access to the digital media content. This hardware security in conjunction with automated media duplication that may be performed in the background and storage of the duplicated media in secure media lockboxes allows a higher throughput of media replication than possible using conventional media duplicators and kiosks.

The system/method incorporates a media distribution kiosk (MDK) having a media duplication device (MDD) to write media transportation unit (MTU) with secure media content to be distributed to a consumer. The MTU is electrically coupled to the MDD via a media robotic arm (MRA) under direction of a computing control device (CCD). The MDD stores media content retrieved from a media storage server (MSS) on the MTU in response to a local or remote consumer media transaction (CMT) with the MDK. Once written, the MTU is decoupled from the MDD by the MRA and placed in a secure media lockbox (SML). The SML is associated with the CMT by the CCD such that the consumer may access the lockbox via a secure keypad and/or credit/debit card reader.

### BRIEF DESCRIPTION OF THE DRAWINGS

For a fuller understanding of the advantages provided by the invention, reference should be made to the following detailed description together with the accompanying drawings wherein:

FIG. 1 illustrates an overview block diagram depicting a presently preferred invention system embodiment;

FIG. 2 illustrates an overview flowchart depicting a presently preferred invention method embodiment (1 of 2);

FIG. 3 illustrates an overview flowchart depicting a presently preferred invention method embodiment (2 of 2);

FIG. 4 illustrates exemplary physical media transportation within the system;

FIG. 5 illustrates a flowchart depicting a presently preferred invention media distribution consumer interface method embodiment (1 of 2);

FIG. 6 illustrates a flowchart depicting a presently preferred invention media distribution consumer interface method embodiment (2 of 2);

FIG. 7 illustrates a flowchart depicting a presently preferred invention Media Distribution Anticipatory Media Duplication method embodiment;

FIG. 8 illustrates a flowchart depicting a presently preferred invention Media Distribution Kiosk Background Media Duplication Tasking method embodiment;

FIG. 9 illustrates an overview block diagram depicting an exemplary USB thumb drive (UTD) media distribution hardware system complement useful in some preferred invention embodiments;

FIG. 10 illustrates a detail schematic diagram depicting an exemplary USB thumb drive (UTD) media distribution hardware system complement useful in some preferred invention embodiments;

FIG. 11 illustrates detail of the FFS and BFS and the phantom UTD access protocol;

FIG. 12 illustrates detail of the FFS and the DSA;

FIG. 13 illustrates detail of UTD configuration steps performed by the MDC;

FIG. 14 illustrates steps to activating the BFS via a UTD PPI protocol match;

FIG. 15 illustrates steps to registering the UTD with a MDA;

FIG. 16 illustrates interaction between the FFS and the BFS to support dynamic DRM checking in conjunction with data extracted from the UTD RTC;

FIG. 17 illustrates a flowchart depicting a preferred exemplary UTD MDK recording method;

FIG. 18 illustrates a flowchart depicting a preferred exemplary UTD registration method;

FIG. 19 illustrates a flowchart depicting a preferred exemplary UTD playback method;

FIG. 20 illustrates a flowchart depicting a preferred exemplary UTD playback termination method;

FIG. 21 illustrates a system block diagram of a preferred exemplary system depicting interaction between a movie delivery agent (MDA) and a media distribution kiosk (MDK);

FIG. 22 illustrates detail associated with a content management database (CMD);

FIG. 23 illustrates a flowchart depicting a preferred exemplary movie expiration management method;

FIG. 24 illustrates a flowchart depicting a preferred exemplary content management database update method;

FIG. 25 illustrates a front view of a preferred exemplary invention embodiment customer interface console;

FIG. 26 illustrates a side view of a preferred exemplary invention embodiment customer interface console;

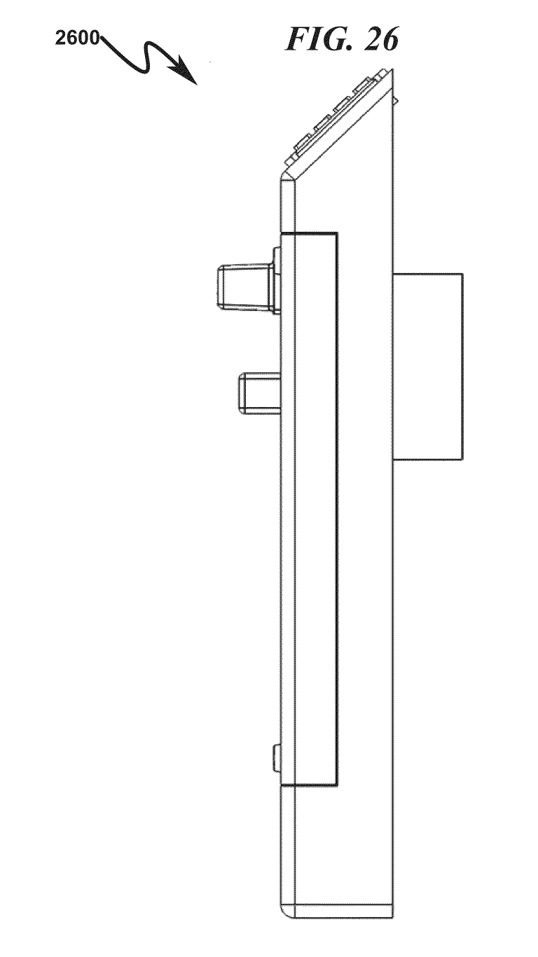

FIG. 27 illustrates a front right top perspective view of a preferred exemplary invention embodiment customer interface console;

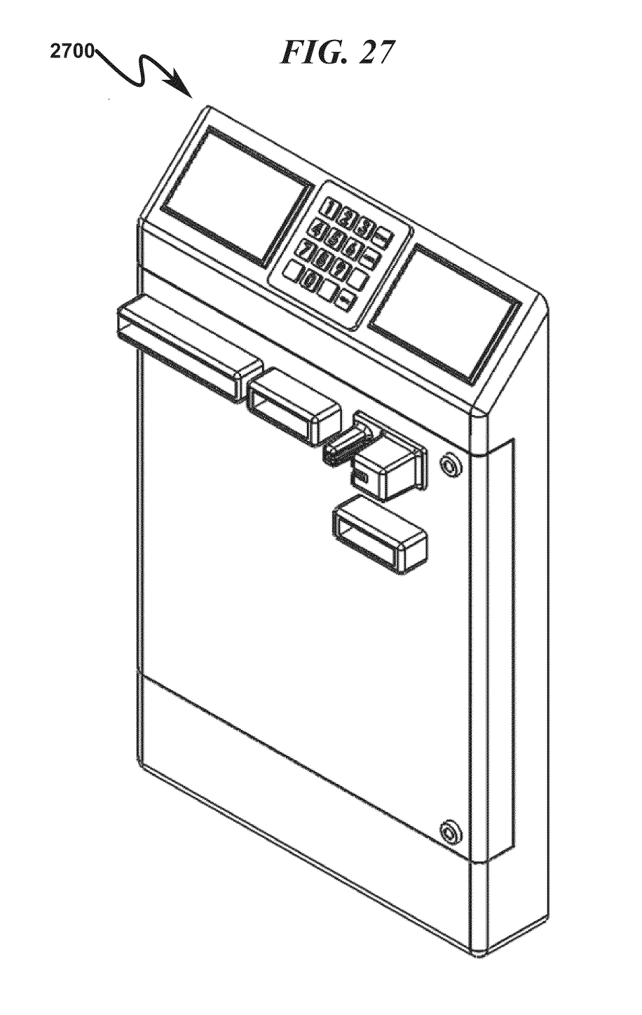

FIG. 28 illustrates a front left top perspective view of a preferred exemplary invention embodiment customer interface console;

FIG. 29 illustrates a front view of a preferred exemplary invention embodiment secure media lockbox (SML) customer interface;

FIG. 30 illustrates a side view of a preferred exemplary invention embodiment secure media lockbox (SML) customer interface;

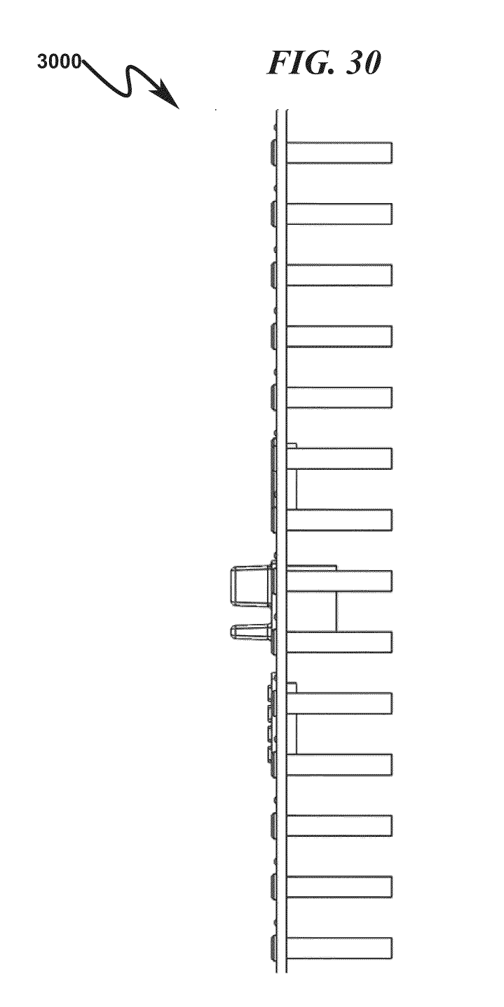

FIG. 31 illustrates a right top perspective view of a preferred exemplary invention embodiment secure media lockbox (SML) customer interface;

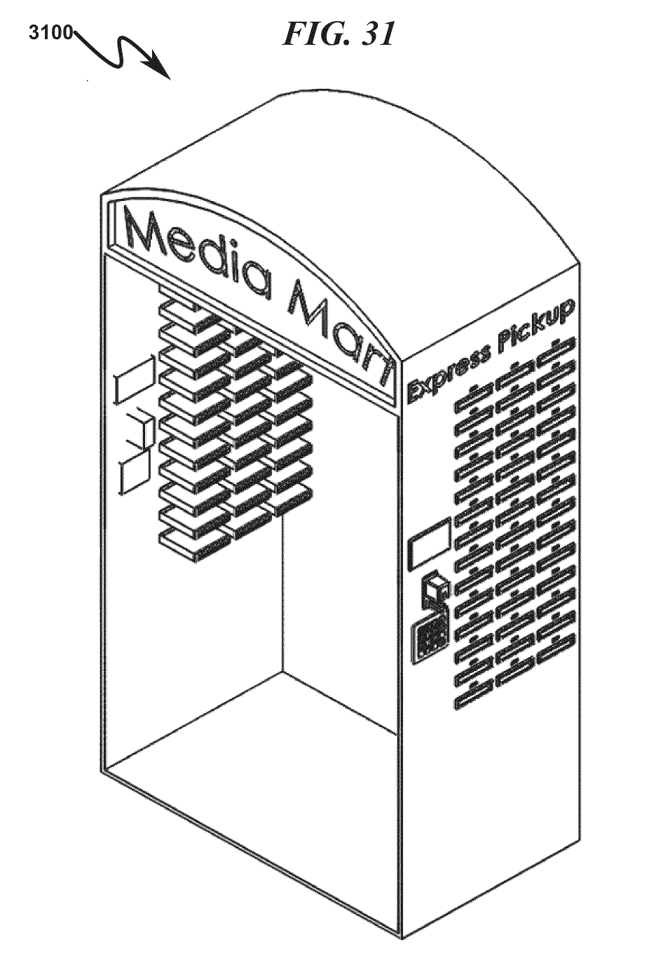

FIG. 32 illustrates a left top perspective view of a preferred exemplary invention embodiment secure media lockbox (SML) customer interface;

FIG. 33 illustrates a front view of a preferred exemplary invention embodiment implemented as a single-sided media distribution unit;

FIG. 34 illustrates a back view of a preferred exemplary invention embodiment implemented as a single-sided media distribution unit;

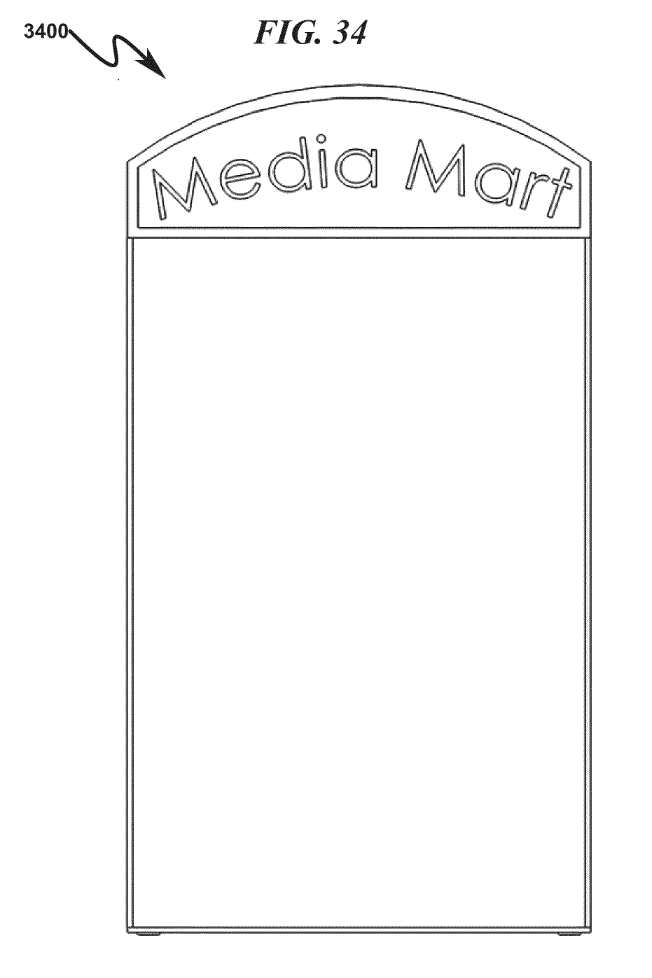

FIG. 35 illustrates a right side view of a preferred exemplary invention embodiment implemented as a single-sided media distribution unit;

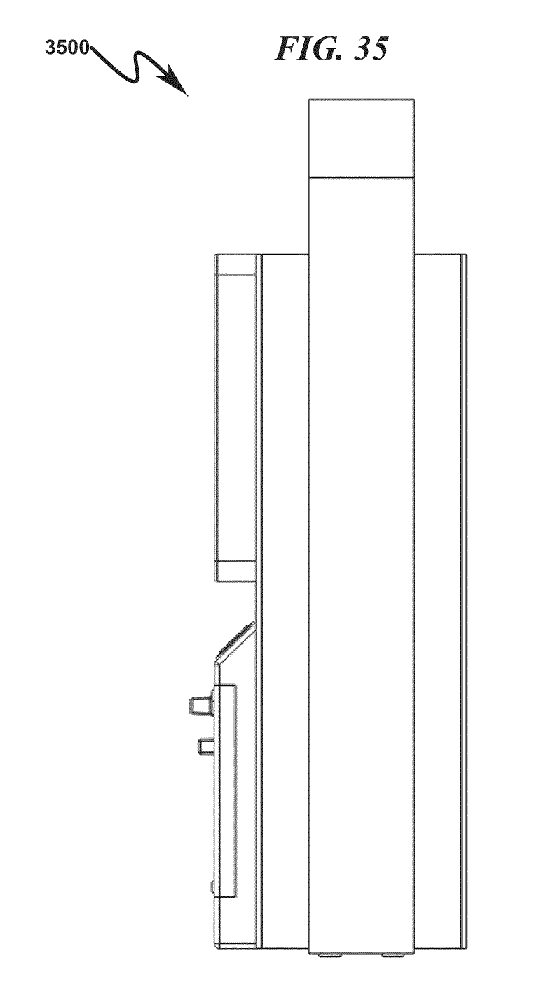

FIG. 36 illustrates a left side view of a preferred exemplary invention embodiment implemented as a single-sided media distribution unit;

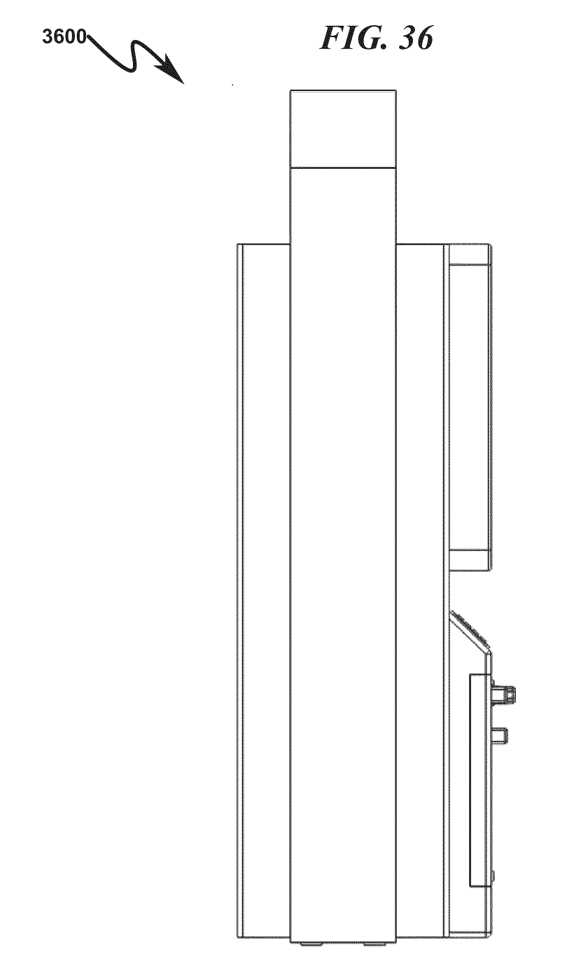

FIG. 37 illustrates a top view of a preferred exemplary invention embodiment implemented as a single-sided media distribution unit;

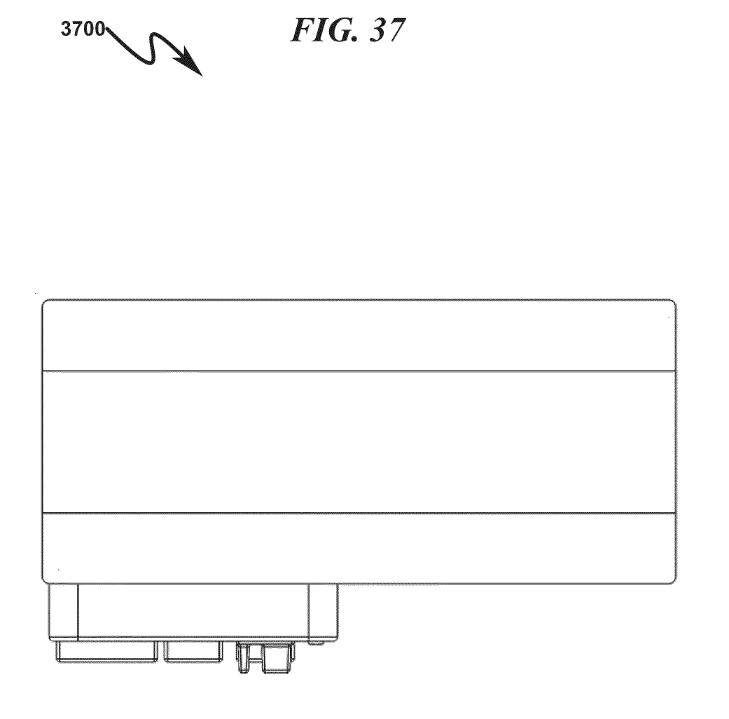

FIG. 38 illustrates a top right perspective view of a preferred exemplary invention embodiment implemented as a single-sided media distribution unit;

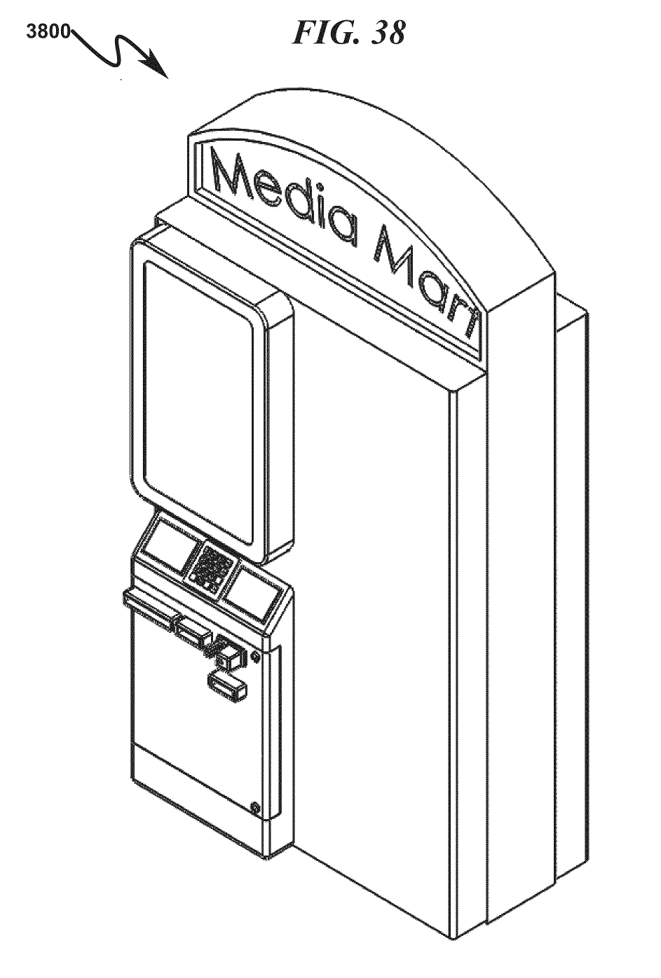

FIG. 39 illustrates a top left perspective view of a preferred exemplary invention embodiment implemented as a single-sided media distribution unit;

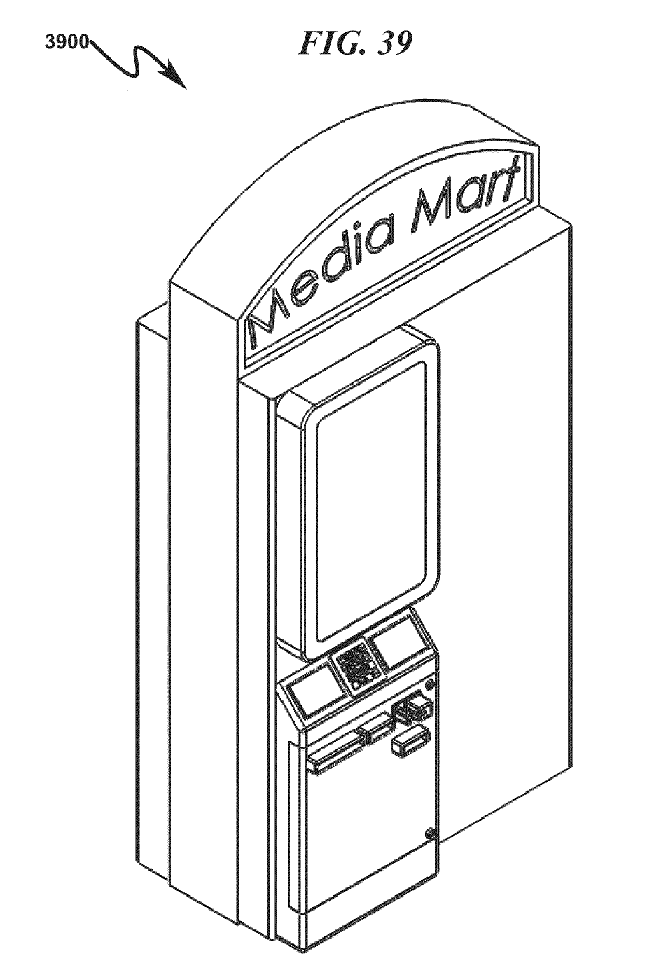

FIG. 40 illustrates a back perspective view of a preferred exemplary invention embodiment implemented as a single-sided media distribution unit;

FIG. 41 illustrates a front view of a preferred exemplary invention embodiment implemented as a mirrored single-sided paired media distribution unit, wherein each paired unit is configured with side-by-side customer interfaces;

FIG. 42 illustrates a back view of a preferred exemplary invention embodiment implemented as a mirrored single-sided paired media distribution unit, wherein each paired unit is configured with side-by-side customer interfaces;

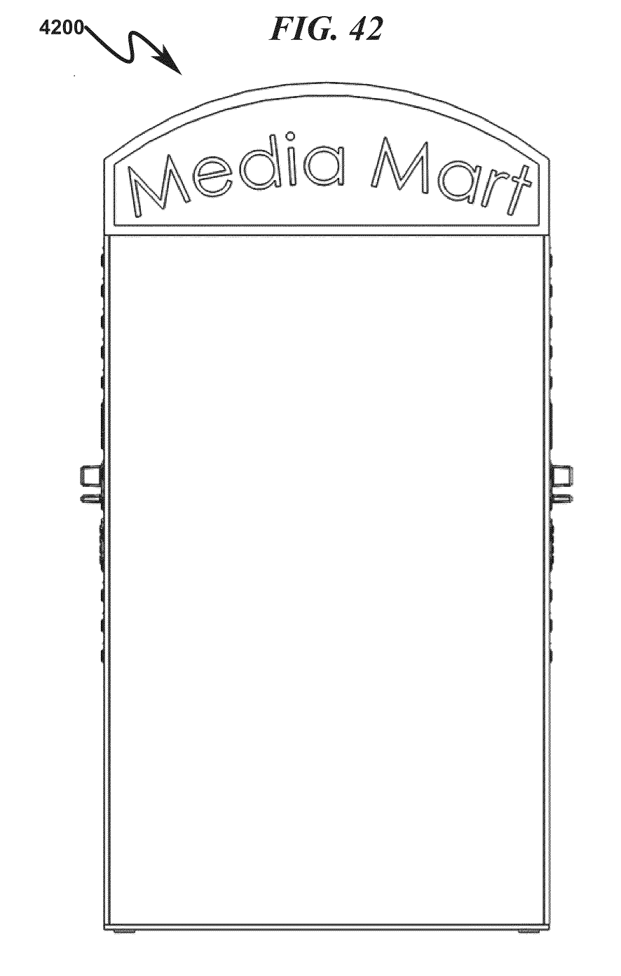

FIG. 43 illustrates a right side view of a preferred exemplary invention embodiment implemented as a mirrored single-sided paired media distribution unit, wherein each paired unit is configured with side-by-side customer interfaces;

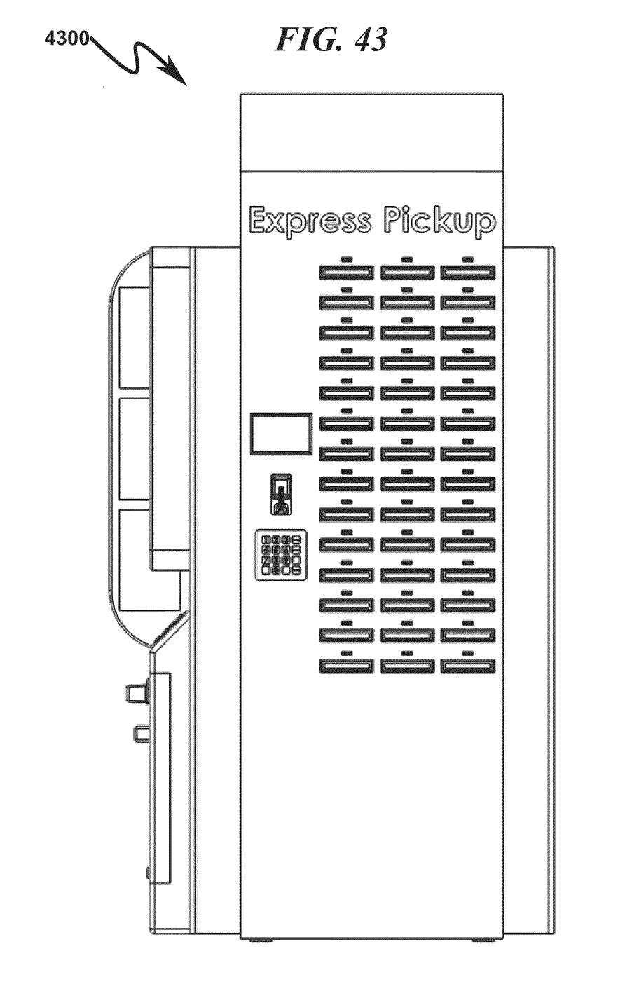

FIG. 44 illustrates a left side view of a preferred exemplary invention embodiment implemented as a mirrored single-sided paired media distribution unit, wherein each paired unit is configured with side-by-side customer interfaces;

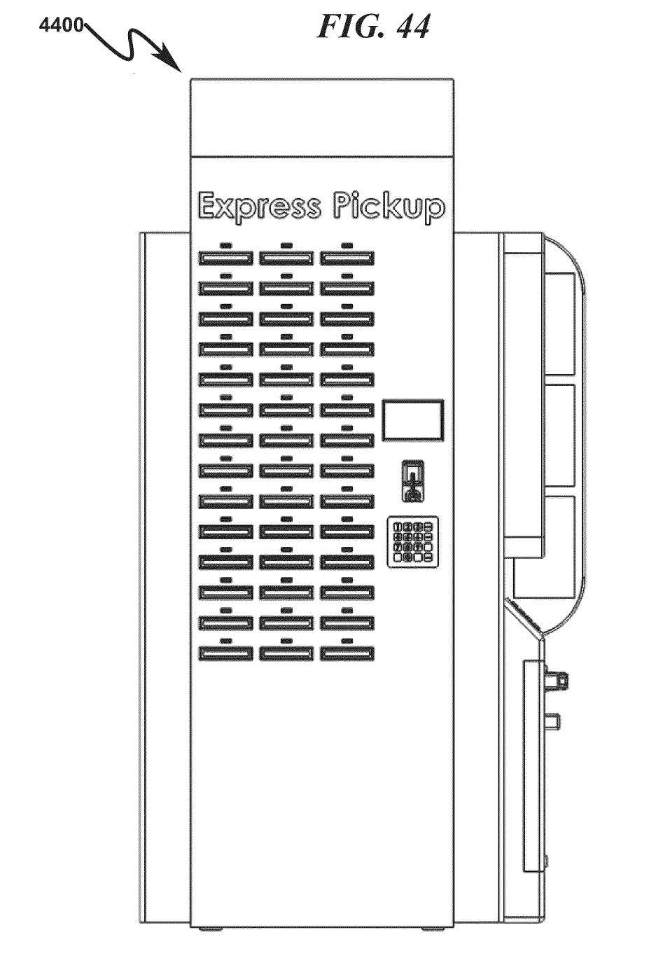

FIG. 45 illustrates a top view of a preferred exemplary invention embodiment implemented as a mirrored single-sided paired media distribution unit, wherein each paired unit is configured with side-by-side customer interfaces;

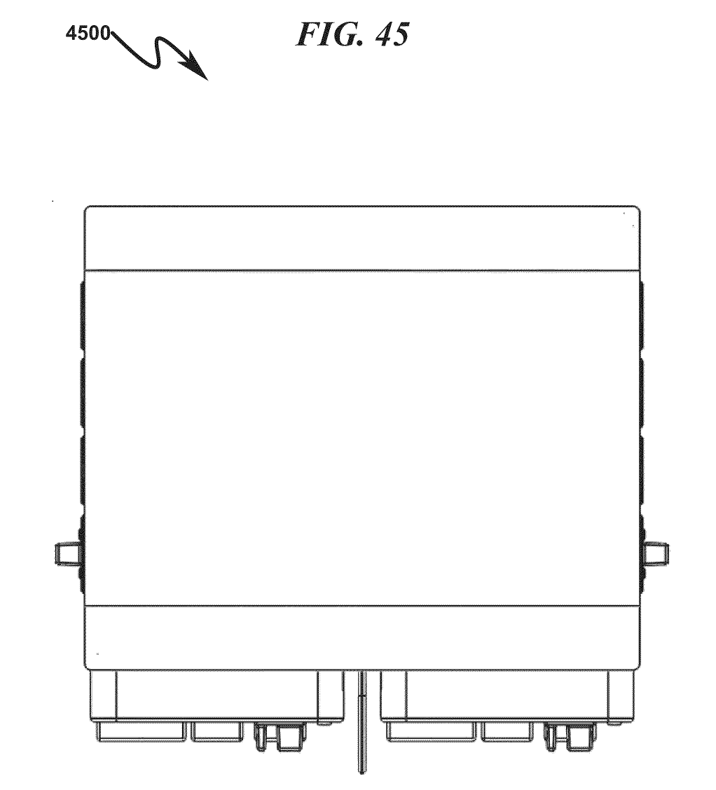

FIG. 46 illustrates a top right perspective view of a preferred exemplary invention embodiment implemented as a mirrored single-sided paired media distribution unit, wherein each paired unit is configured with side-by-side customer interfaces;

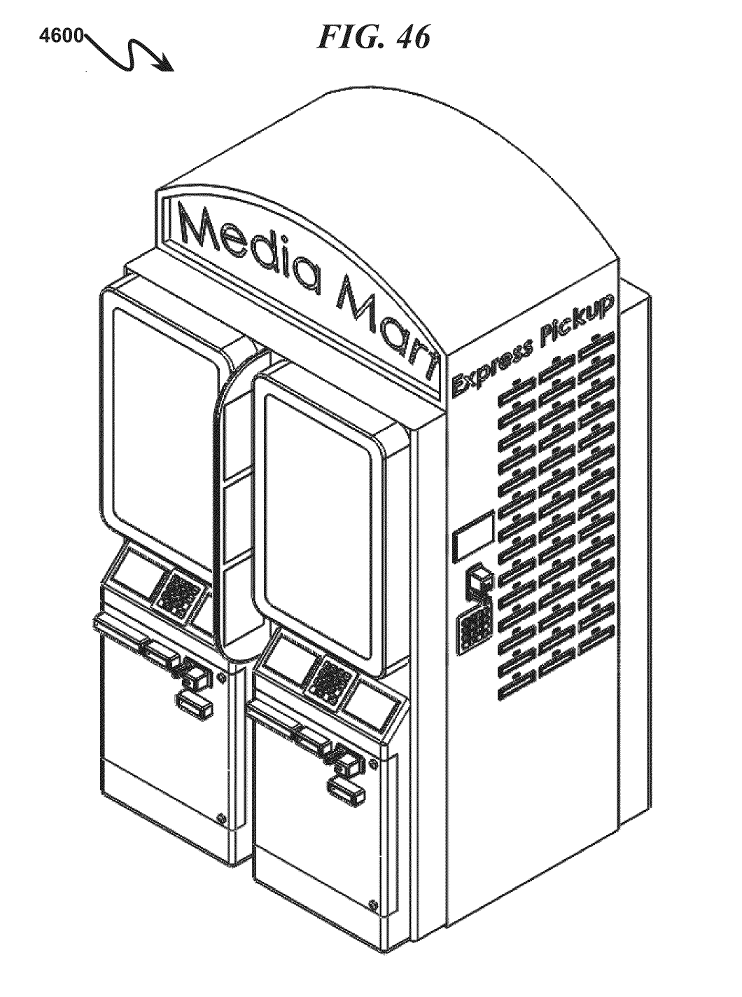

FIG. 47 illustrates a top left perspective view of a preferred exemplary invention embodiment implemented as a mirrored single-sided paired media distribution unit, wherein each paired unit is configured with side-by-side customer interfaces;

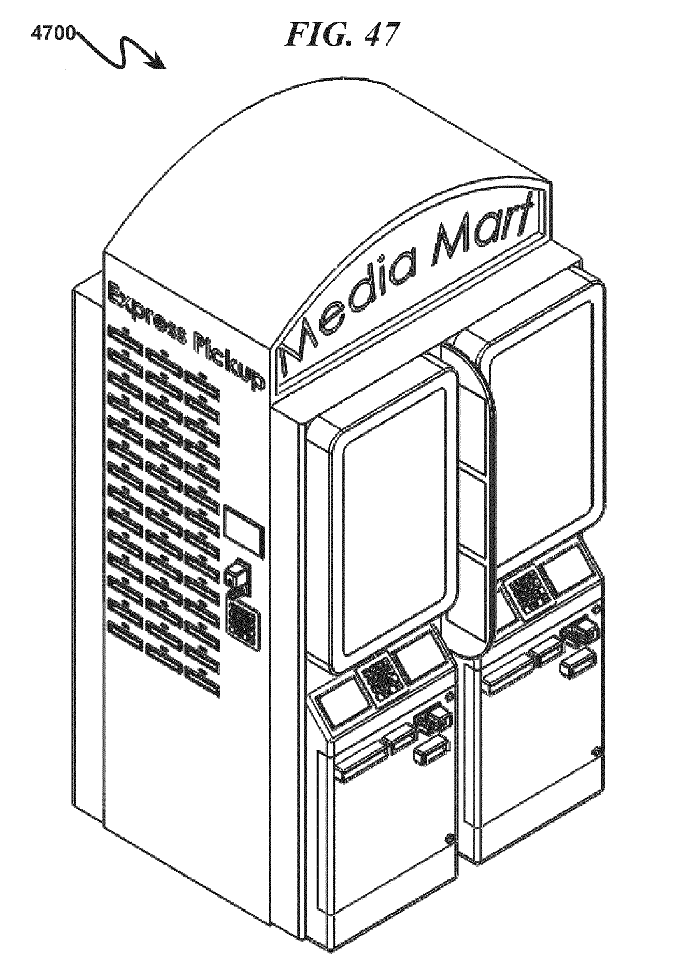

FIG. 48 illustrates a back perspective view of a preferred exemplary invention embodiment implemented as a mirrored single-sided paired media distribution unit, wherein each paired unit is configured with side-by-side customer interfaces;

FIG. 49 illustrates a front view of a preferred exemplary invention embodiment implemented as a mirrored double-sided paired media distribution unit, wherein each paired unit is configured with side-by-side customer interfaces;

FIG. 50 illustrates a back view of a preferred exemplary invention embodiment implemented as a mirrored double-sided paired media distribution unit, wherein each paired unit is configured with side-by-side customer interfaces;

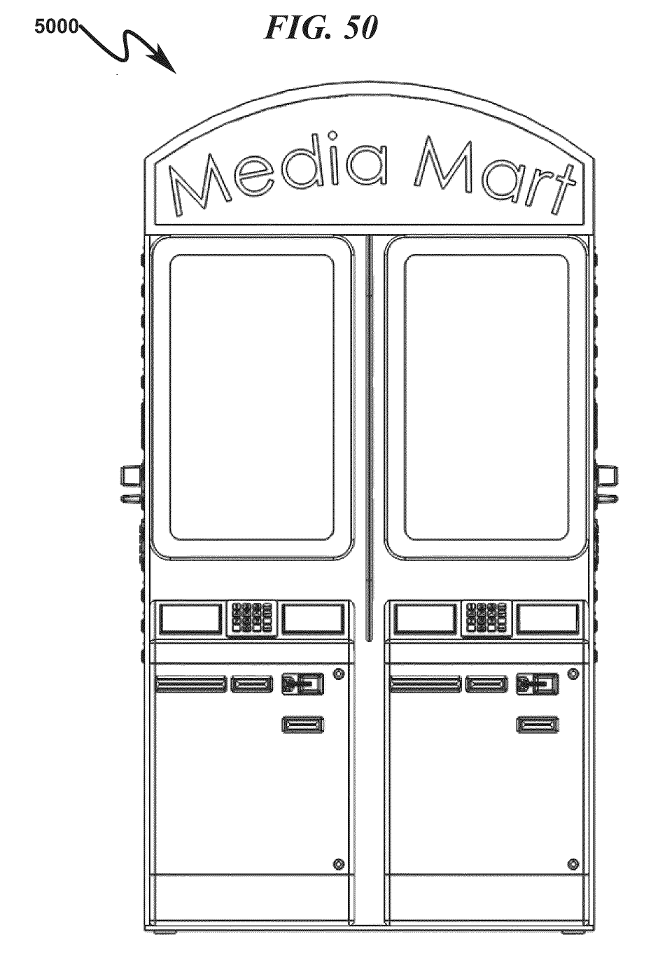

FIG. 51 illustrates a right side view of a preferred exemplary invention embodiment implemented as a mirrored double-sided paired media distribution unit, wherein each paired unit is configured with side-by-side customer interfaces;

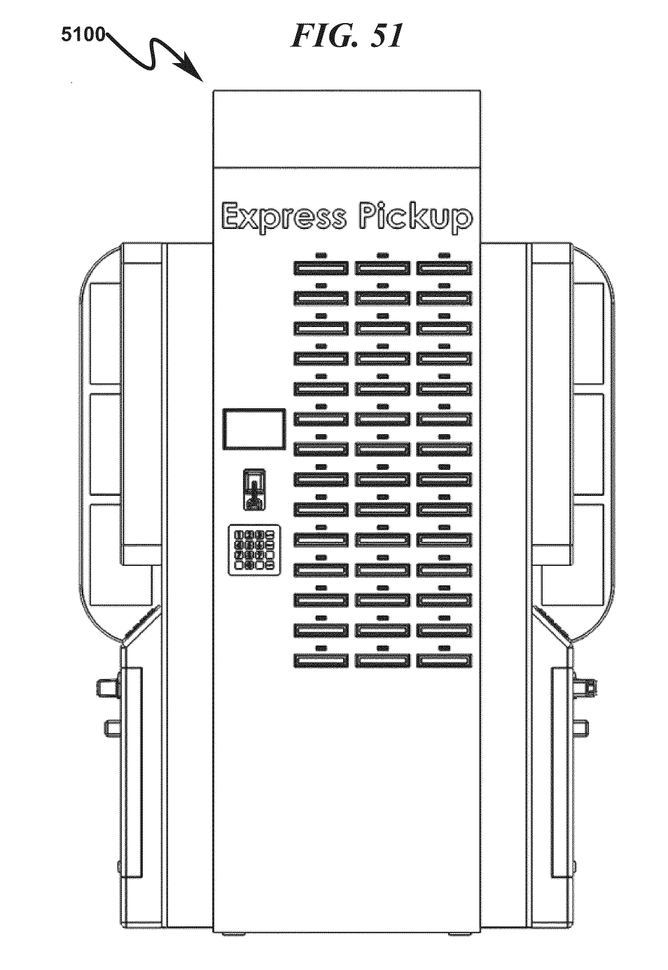

FIG. 52 illustrates a left side view of a preferred exemplary invention embodiment implemented as a mirrored double-sided paired media distribution unit, wherein each paired unit is configured with side-by-side customer interfaces;

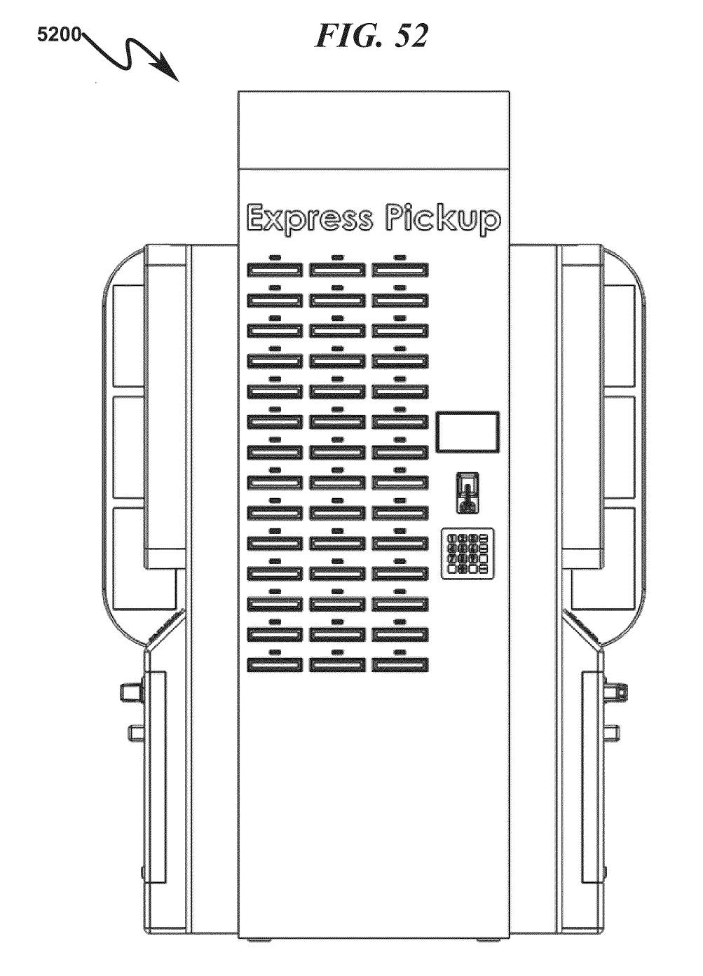

FIG. 53 illustrates a top view of a preferred exemplary invention embodiment implemented as a mirrored double-sided paired media distribution unit, wherein each paired unit is configured with side-by-side customer interfaces;

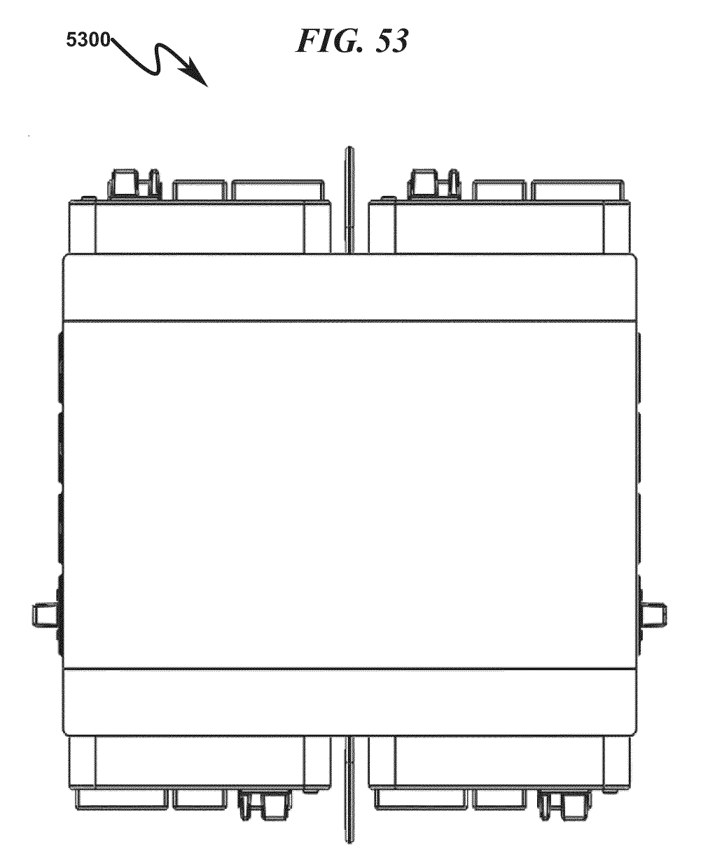

FIG. 54 illustrates a top right perspective view of a preferred exemplary invention embodiment implemented as a mirrored double-sided paired media distribution unit, wherein each paired unit is configured with side-by-side customer interfaces;

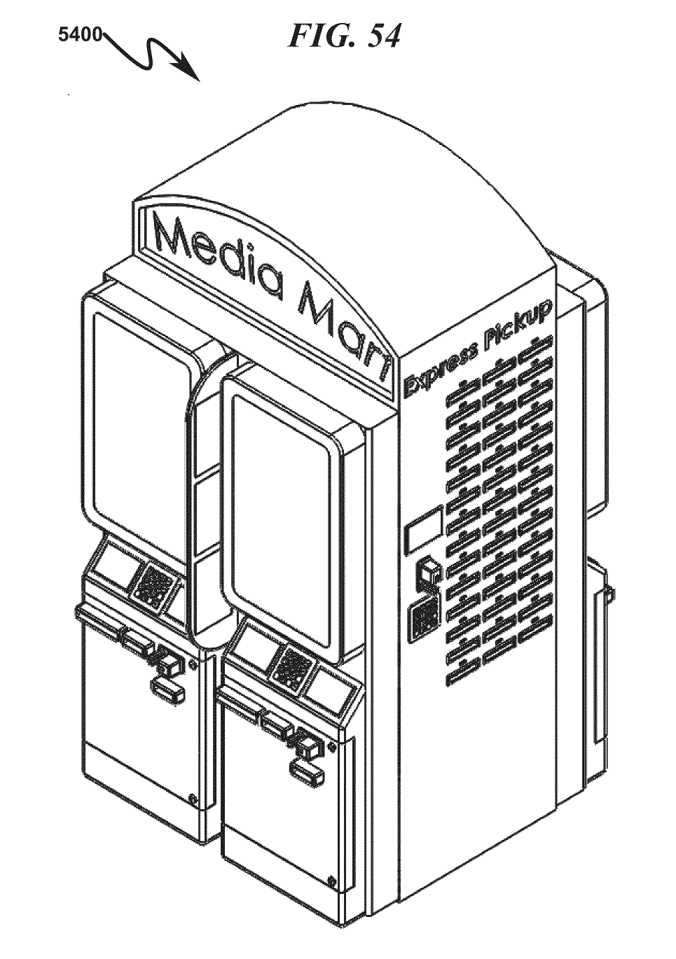

FIG. 55 illustrates a top left perspective view of a preferred exemplary invention embodiment implemented as a mirrored double-sided paired media distribution unit, wherein each paired unit is configured with side-by-side customer interfaces;

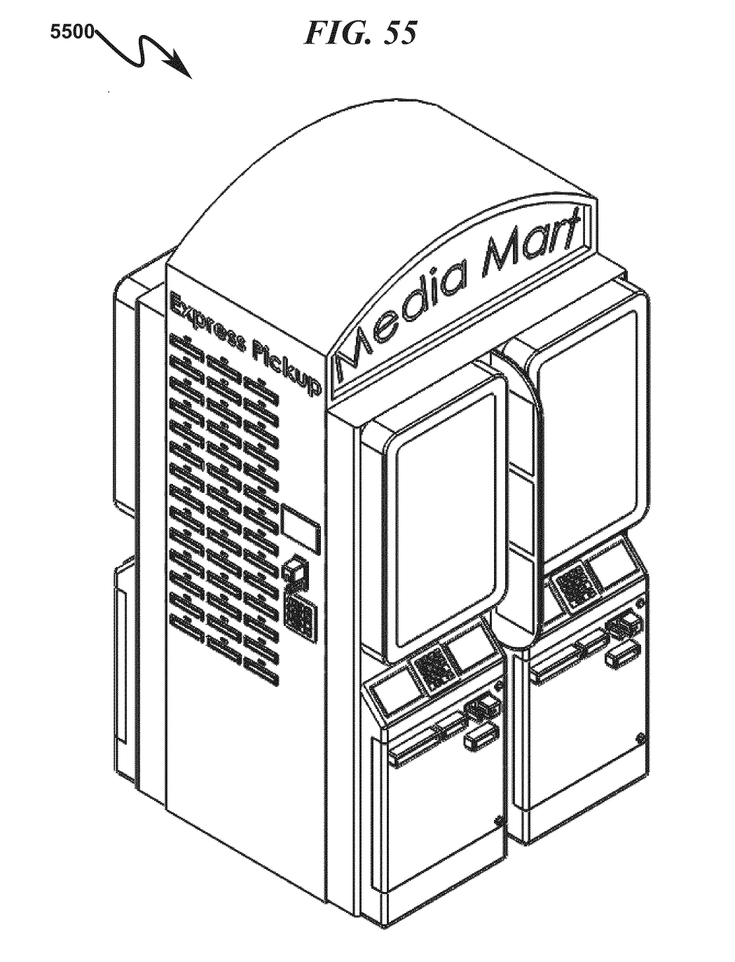

FIG. 56 illustrates a back perspective view of a preferred exemplary invention embodiment implemented as a mirrored double-sided paired media distribution unit, wherein each paired unit is configured with side-by-side customer interfaces;

FIG. 57 illustrates a front view of a preferred exemplary invention embodiment implemented as a triad of paired media distribution units;

FIG. 58 illustrates a back view of a preferred exemplary invention embodiment implemented as a triad of paired media distribution units;

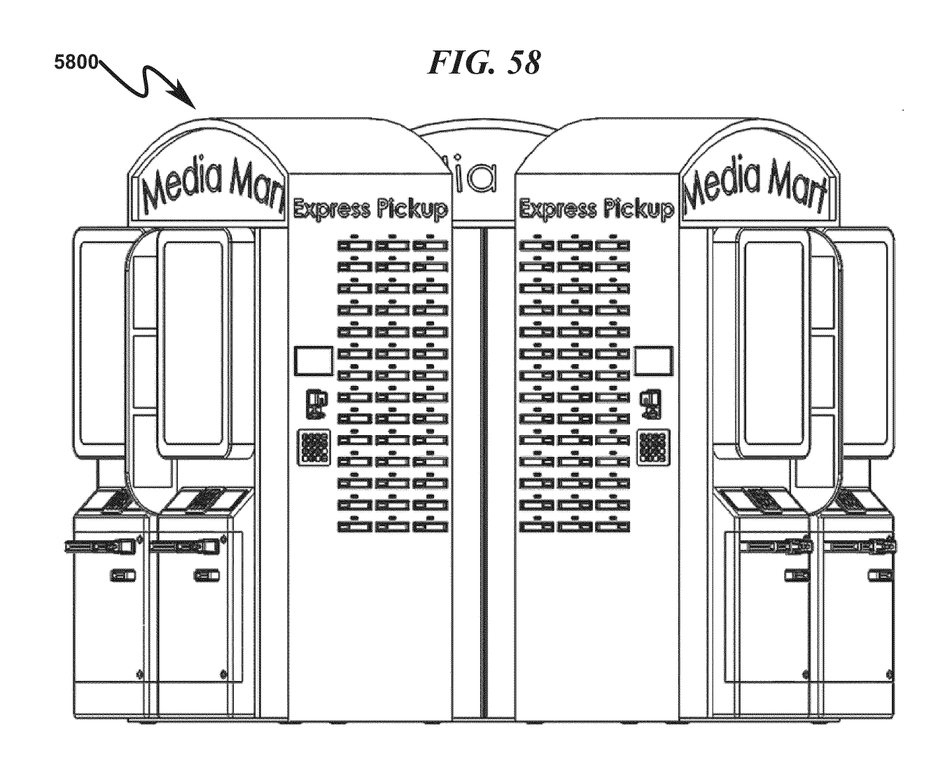

FIG. 59 illustrates a right side view of a preferred exemplary invention embodiment implemented as a triad of paired media distribution units;

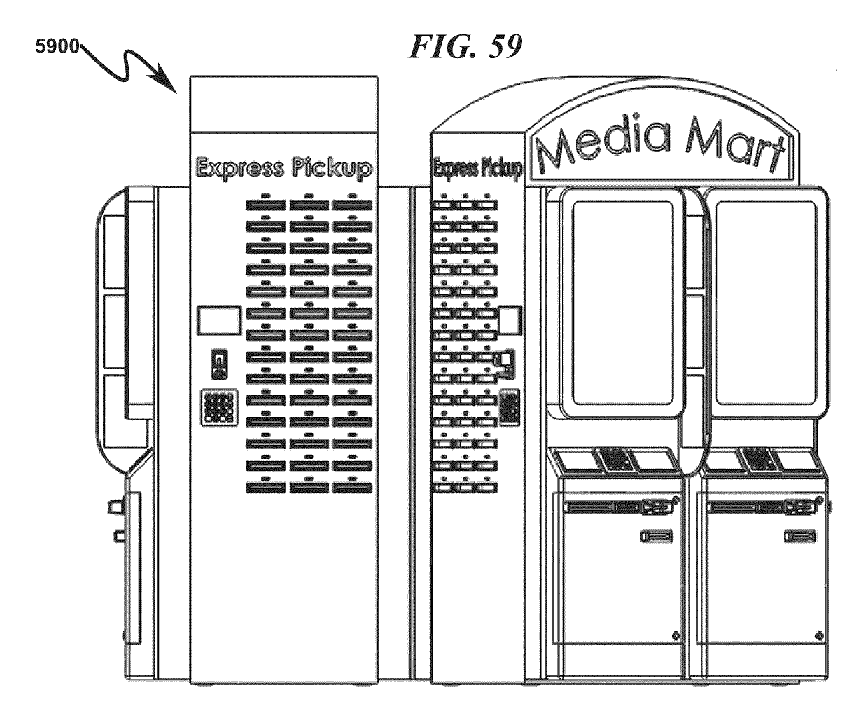

FIG. 60 illustrates a left side view of a preferred exemplary invention embodiment implemented as a triad of paired media distribution units;

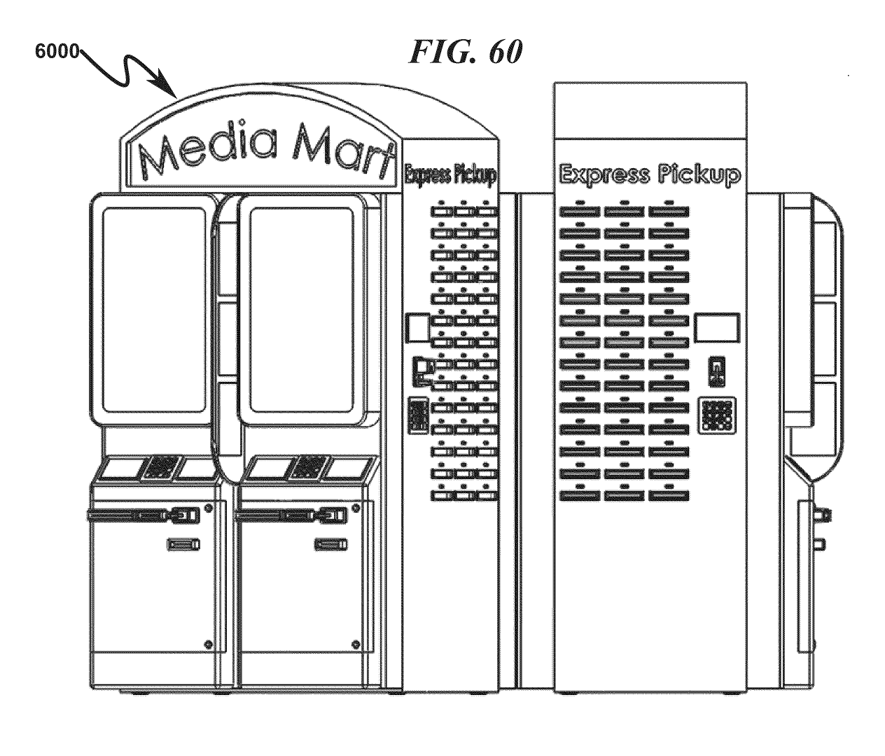

FIG. 61 illustrates a top view of a preferred exemplary invention embodiment implemented as a triad of paired media distribution units;

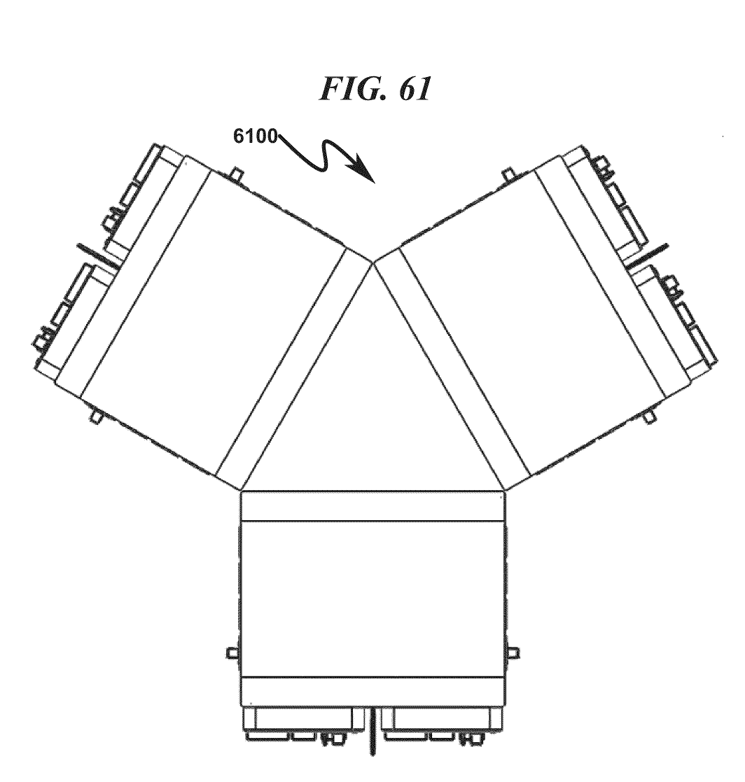

FIG. 62 illustrates a top right perspective view of a preferred exemplary invention embodiment implemented as a triad of paired media distribution units;

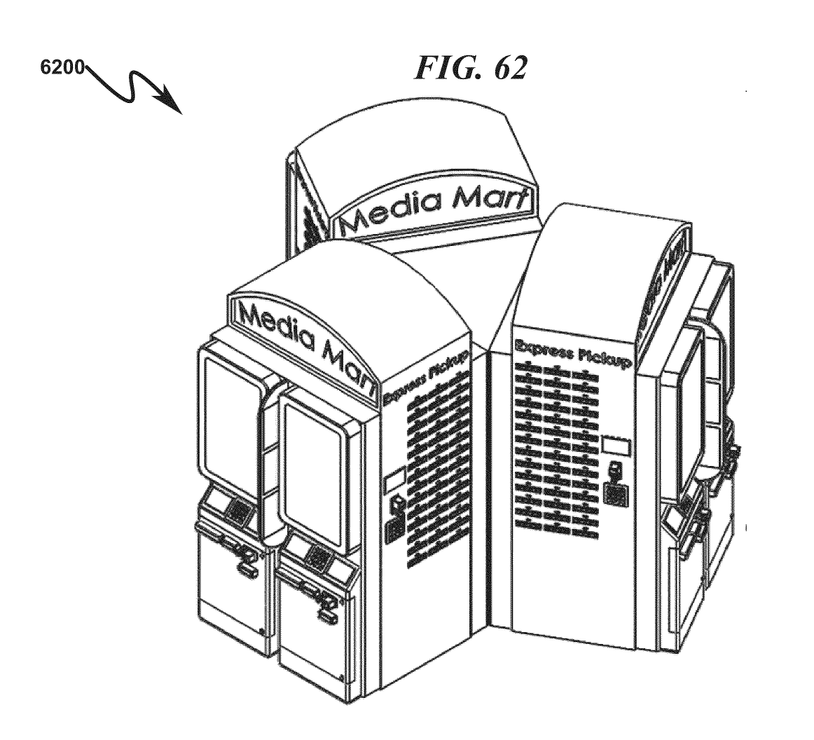

FIG. 63 illustrates a top left perspective view of a preferred exemplary invention embodiment implemented as a triad of paired media distribution units;

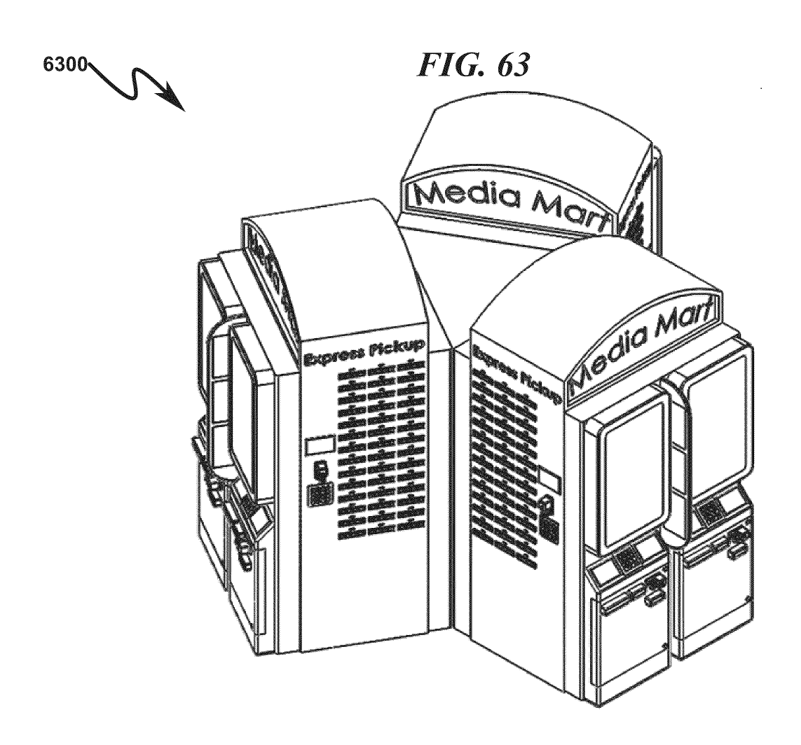

FIG. 64 illustrates a back perspective view of a preferred exemplary invention embodiment implemented as a triad of paired media distribution units;

FIG. 65 illustrates a front top perspective view of a preferred exemplary implementation of a robotic arm computer (RAC) and articulating robotic arm (ARM) useful in many preferred invention embodiments with the ARM positioned over a source media stack;

FIG. 66 illustrates a front top perspective view of a preferred exemplary implementation of a robotic arm computer (RAC) and articulating robotic arm (ARM) useful in many preferred invention embodiments with the ARM positioned over a media duplicator;

FIG. 67 illustrates a front view of a preferred exemplary implementation of a robotic arm computer (RAC) and articulating robotic arm (ARM) useful in many preferred invention embodiments depicting various system components;

FIG. 68 illustrates a front view of a preferred exemplary implementation of a robotic arm computer (RAC) and articulating robotic arm (ARM) useful in many preferred invention embodiments depicting typical system dimensions in centimeters;

FIG. 69 illustrates a top view of a preferred exemplary implementation of a robotic arm computer (RAC) and articulating robotic arm (ARM) useful in many preferred invention embodiments depicting typical system dimensions in centimeters;

FIG. 70 illustrates a side view of a preferred exemplary implementation of a robotic arm computer (RAC) and articulating robotic arm (ARM) useful in many preferred invention embodiments;

FIG. 71 illustrates an exemplary system block diagram of a preferred exemplary implementation of a robotic arm computer (RAC) and articulating robotic arm (ARM) useful in many preferred invention embodiments; and

FIG. 72 illustrates a front top perspective view of a preferred exemplary implementation of a USB thumb drive (UTD) media and UTD media writer useful in many preferred invention embodiments.

### DESCRIPTION OF THE PRESENTLY PREFERRED EXEMPLARY EMBODIMENTS

While the present invention is susceptible of embodiment in many different forms, there is shown in the drawings and will herein be described in detailed preferred embodiments of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a MEDIA DISTRIBUTION SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### System Overview (0100)

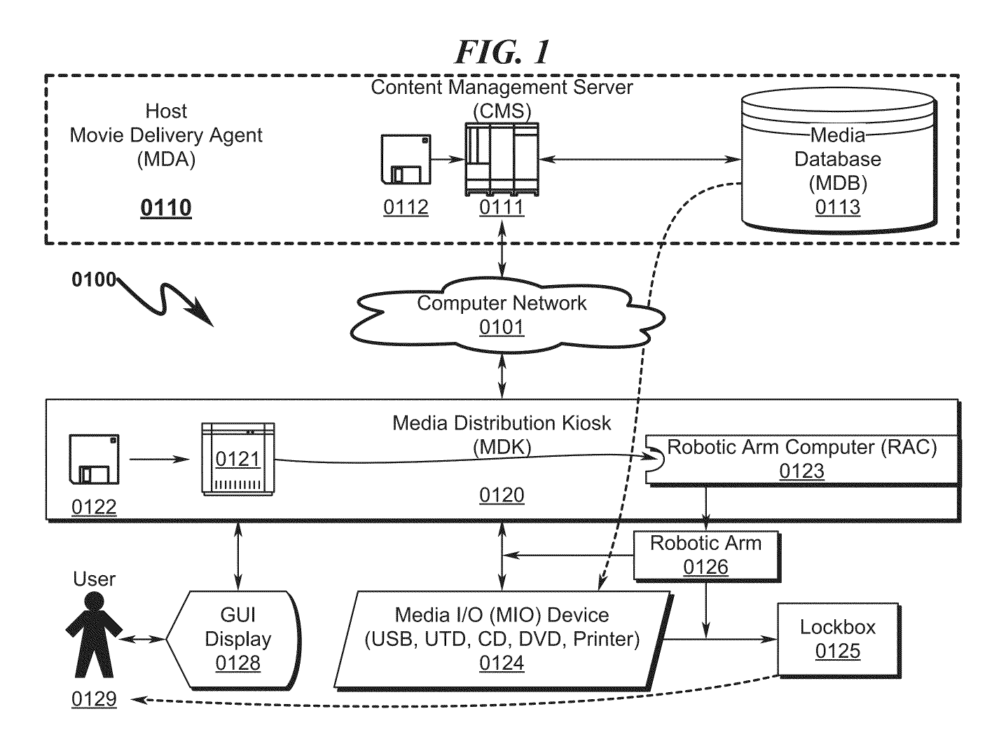

An overview of the present invention system functionality is depicted in FIG. 1 (0100). In this application context a host movie delivery agent (MDA) (0110) communicates with a media distribution kiosk (MDK) (0120) via a computer communication network (CCN) (0101) (typically the Internet). A content management server (CMS) (0111) running under control of machine instructions read from a computer readable medium (0112) and operates to make available content from a movie database (0113) to the MDK (0120). The MDK (0120) incorporates a computing control device (0121) operating under control of machine instructions read from a computer readable medium (0122) to coordinate commands to a robotic arm computer (RAC) (0123). The RAC (0123) is configured to place unwritten digital media into a media I/O (MIO) device (0124) (typically a media duplication device (MDD) such as a DVD writer or USB thumb drive writer) and then transport this written digital media to a secure media lockbox (SML) (0125) via the use of an articulating robotic arm (ARM) (0126). A graphical user interface (GUI) (0128) permits a consumer (0129) to enter authorization information to then retrieve digital media content (DMC) (as embodied on a media transportation unit (MTU) written by the MIO device) from the secure media lockbox (SML) (0125).

### Method Overview (0200)-(0300)

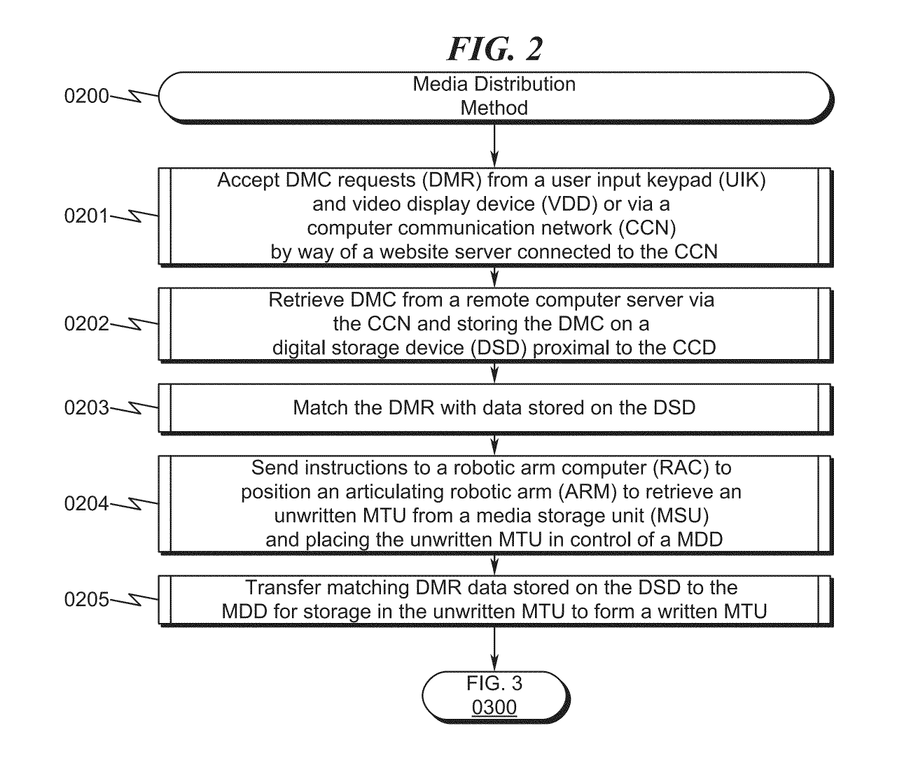

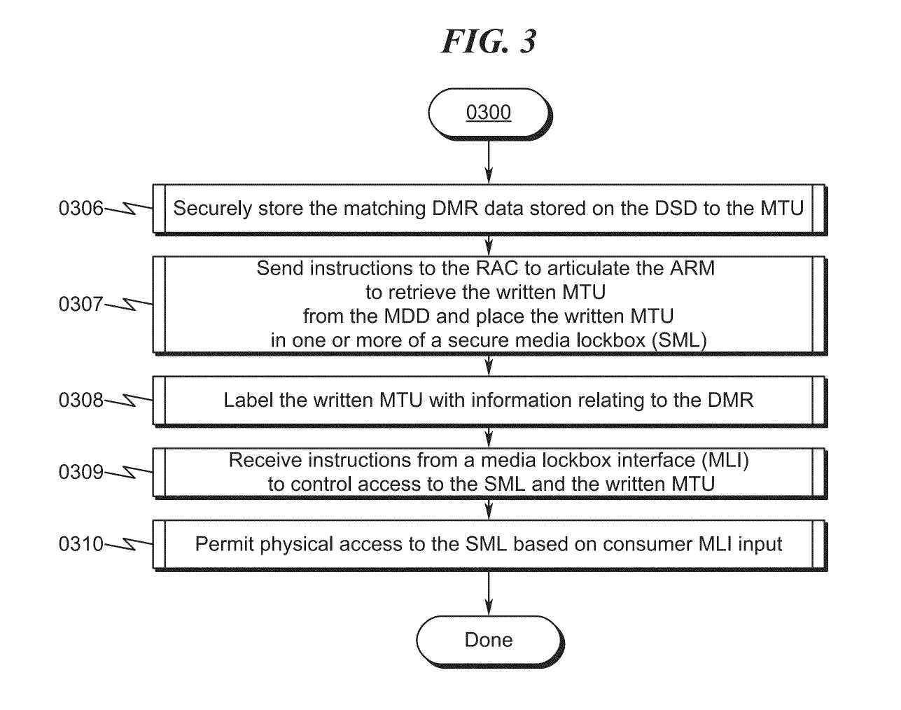

An exemplary present invention overview method can be generally described in the flowcharts of FIG. 2 (0200) and FIG. 3 (0300) as incorporating the following steps:
(1) with a computing control device (CCD), accepting digital media content requests (DMR) from a user input keypad (UIK) and video display device (VDD) or via a computer communication network (CCN) by way of a website server connected to the CCN (0201);
(2) with the CCD, retrieving digital media content (DMC) from a remote computer server via the CCN and storing the DMC on a digital storage device (DSD) proximal to the CCD (0202);
(3) with the CCN, matching the DMR with data stored on the DSD (0203);
(4) with the CCN, sending instructions to a robotic arm computer (RAC) to position an articulating robotic arm (ARM) to retrieve an unwritten media transportation unit (MTU) from a media storage unit (MSU) and placing the unwritten MTU in control of a media duplication device (MDD) (0204);
(5) with the CCN, transferring matching DMR data stored on the DSD to the MDD for storage in the unwritten MTU to form a written MTU (0205);
(6) with the CCN, securely storing the matching DMR data stored on the DSD to the MTU (0306);
(7) with the CCN, sending instructions to the RAC to articulate the ARM to retrieve the written MTU from the MDD and place the written MTU in one or more of a secure media lockbox (SML) (0307);
(8) with a media content labeler (MCL), labeling the written MTU with information relating to the DMR (0308);
(9) with the CCN, receiving instructions from a media lockbox interface (MLI) to control access to the SML and the written MTU (0309); and
(10) with said CCN, permitting physical access to the SML based on consumer MLI input (0310).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Physical Media Transportation (0400)

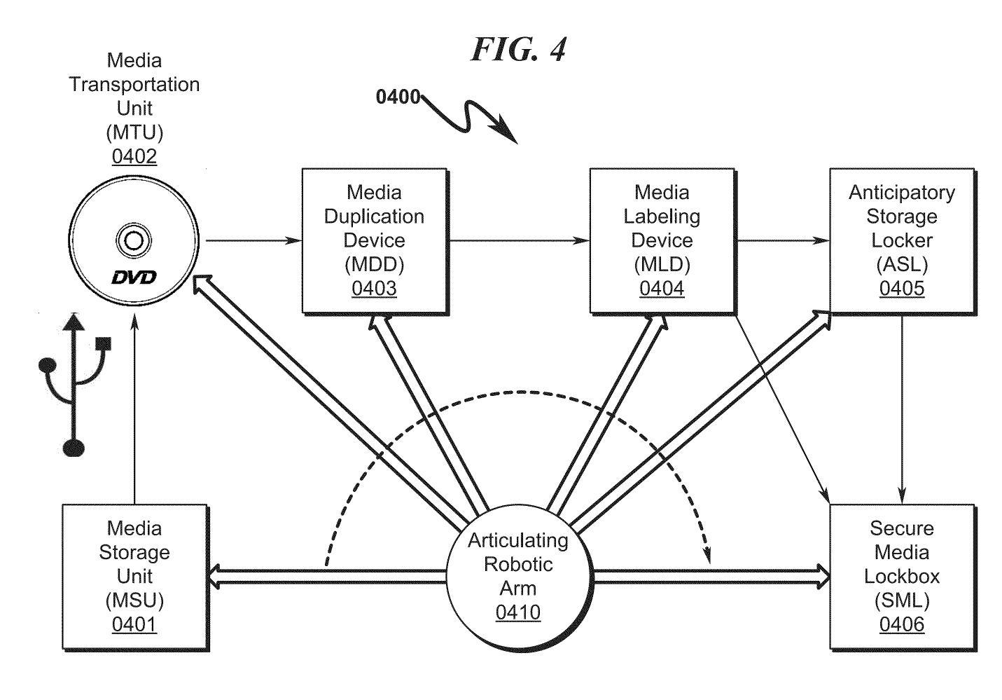

The present invention physically transports media between unwritten storage and the final destination of a secure media lockbox (SML). This process is depicted in FIG. 4 (0400) wherein the articulating robotic arm (0410) under control of a robotic arm computer (RAC) (as per item (0123) FIG. 1 (0100)) interfaces with a media storage unit (MSU) (0401) that physically contains a plurality of unwritten media transportation units (MTUs). These MTUs (0402) are individually retrieved from the MSU (0401) and transported to the media duplication device (MDD) (0403) where they are securely written with digital media content selected by the consumer via either the kiosk user interface or remotely via a secure website interface. Once written, the MTU (0402) is transported from the MDD (0403) to a media labeling device (MLD) that imprints identifying information on the MTU (0402) and optionally transports this labeled unit to an anticipatory storage locker (ASL) (0405) for temporary bulk storage of MTUs that are in high consumer demand. Alternatively, the written MTU is placed in a secure media lockbox (0406) awaiting pickup by the consumer.

### Consumer Interface Method (0500)-(0600)

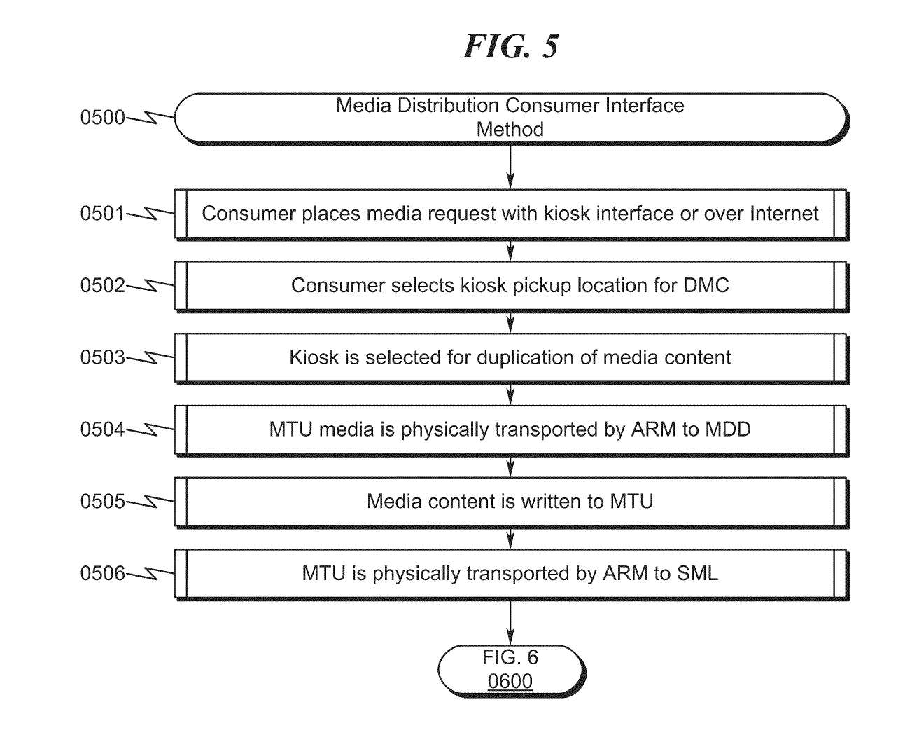

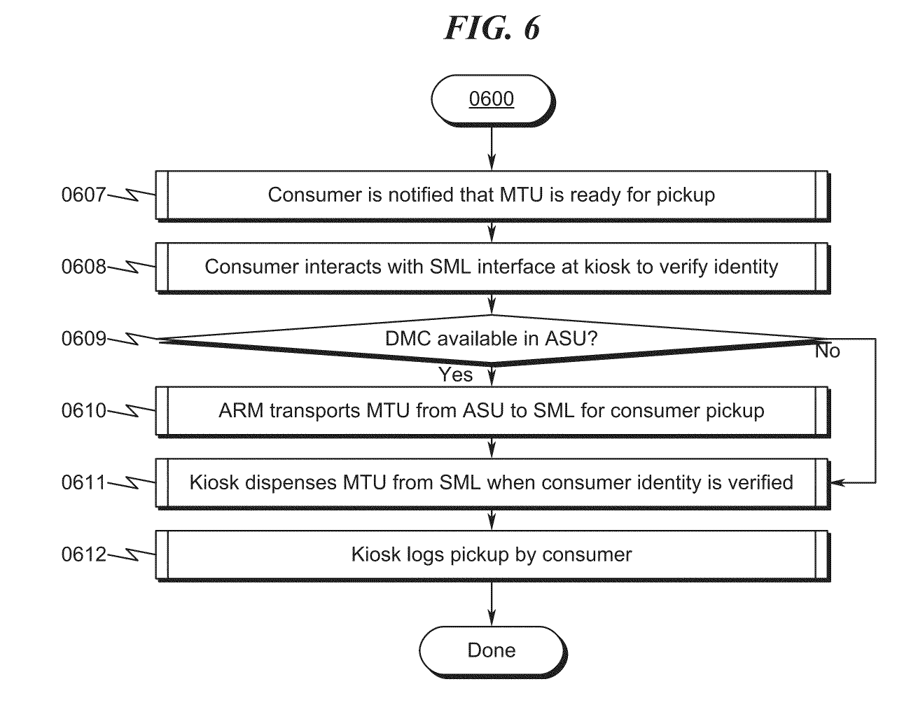

An exemplary present invention media distribution consumer interface method can be generally described in the flowcharts of FIG. 5 (0500) and FIG. 6 (0600) as incorporating the following steps:
(1) placing a DMC media request order with a kiosk interface or over the internet (0501);
(2) selecting the kiosk pickup location for the DMC (0502);
(3) selecting which kiosk at the selected location will be responsible for generating the DMC MTU (0503);
(4) physically transporting the MTU from the MSU to the MDD using the ARM (0504);
(5) writing DMC media content securely to the MTU (0505);
(6) physically transporting the MTU to the SML using the ARM (0506);
(7) notifying the consumer that the MTU is ready for pickup via email or text message (0607);
(8) interacting with the consumer via a SML interface to verify their identity (0608);
(9) determining if DMC media is available in the ASU, and if not, proceeding to step (11) (0609);
(10) transporting the MTU from the ASU to the SML for consumer pickup (0610);
(11) dispensing the MTU from the SML when the consumer identity is validated (0611); and
(12) logging the consumer MTU pickup and generating a receipt for the MTU transaction (0612).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Anticipatory Media Duplication (0700)-(0800)

The present invention may be configured in some application contexts to anticipate consumer demand for a particular type of media and create bulk media copies based on the demand for particular media that has been analyzed based on the location of a particular kiosk. For example, the location of a particular kiosk may determine the selection of media that is most likely to be demanded by kiosk users in that location. By gathering data from all kiosks (and via Internet media requests), a host computer (or in some circumstances the computing device within the kiosk) may determine the anticipated demand for a given digital media content (DMC) at a particular kiosk.

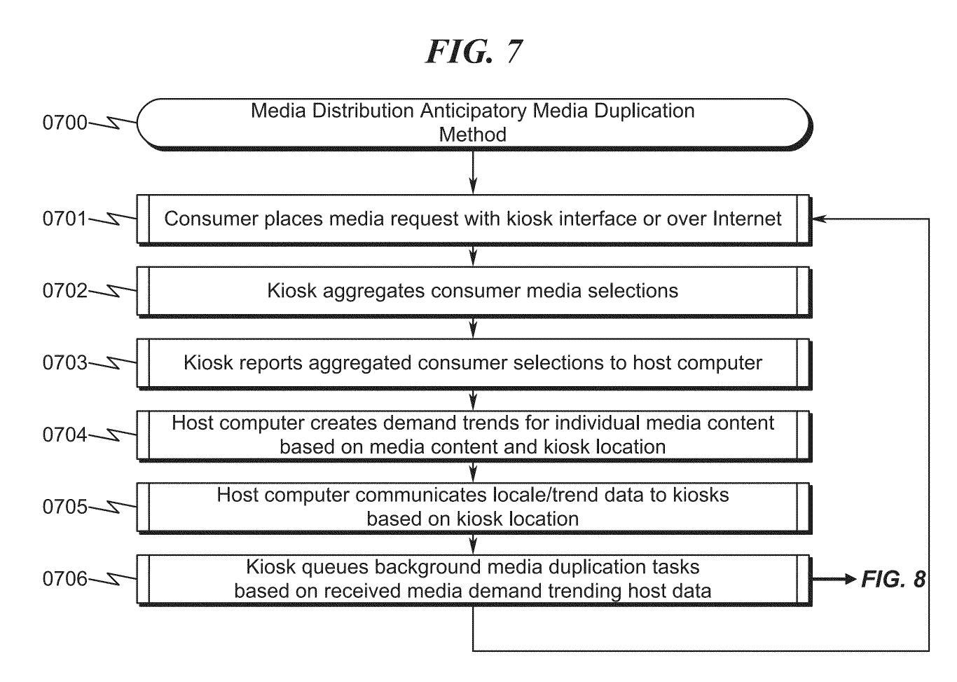

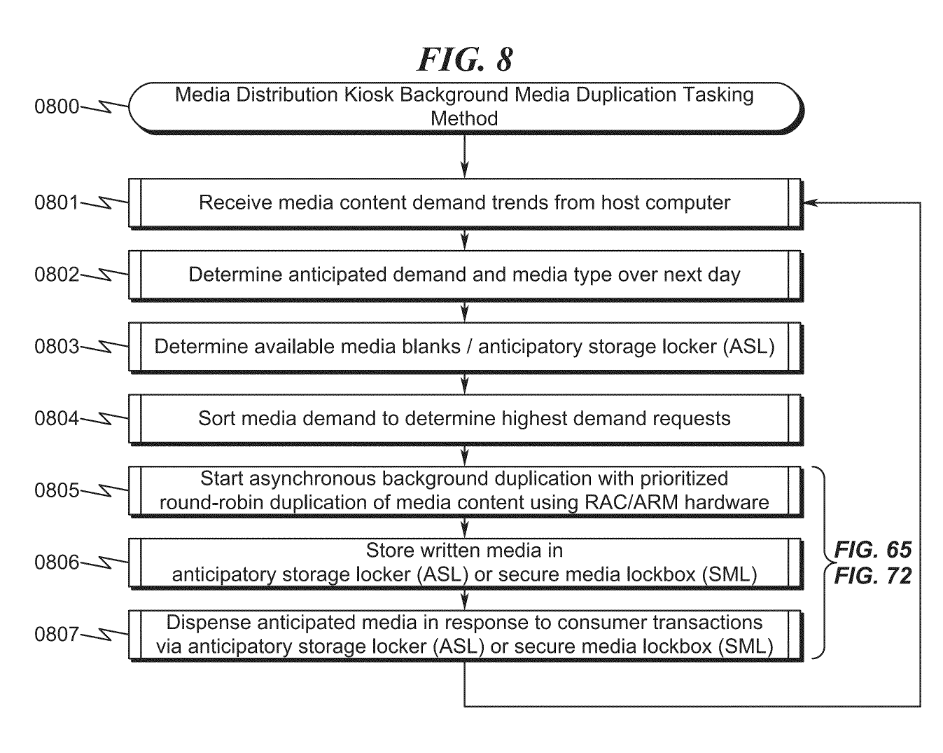

The general methodology to achieve this anticipatory media duplication task involves two cooperating processes as generally depicted in FIG. 7 (0700) and FIG. 8 (0800). An exemplary Media Distribution Anticipatory Media Duplication method is depicted in FIG. 7 (0700) and involves the following steps:
(1) Allowing a consumer to place a media request with a kiosk interface or over the Internet (0701);
(2) With the kiosk computing device, aggregating the consumer media selections (0702);
(3) With the kiosk computing device, reporting aggregated consumer selections to a host computer (or to a separate process on the kiosk computing device) (0703);
(4) With the host computer, creating demand trends for individual media content based on media content and kiosk location (0704);
(5) With the host computer, communicating locale/trend data to kiosks based on kiosk location and media content trending demands (0705); and
(6) With the kiosk computing device, queuing background media duplication tasks based on received media demand trending host data and proceeding to step (1) (0706).

This process cooperates with an asynchronous media duplication task running on the kiosk computing control device. An exemplary Media Distribution Kiosk Background Media Duplication Tasking method is depicted in FIG. 8 (0800) and involves the following steps:
(1) With the media kiosk computing control device, receive media content demand trends from a host computer (or a kiosk computing control device) (0801);
(2) With the kiosk computing device, determining the anticipated demand and media type over next day based on the host media demand data (0802);
(3) With the kiosk computing device, determining available media blanks and anticipatory storage locker (ASL) storage capacity. This allows the kiosk to plan the amount of anticipatory media to create based on the anticipated demand as well as available media and storage capabilities as well as anticipating the need for non-anticipatory media creation during this time period (0803);
(4) With the kiosk computing control device, sorting media demand to determine highest demand requests (thus prioritizing the most important anticipatory demands) (0804);
(5) With the kiosk computing control device, start asynchronous background media duplication with prioritized round-robin duplication of media content using RAC/ARM hardware (ensuring that the media content most in demand will be processed at a higher priority that other media that is anticipated for demand but at a lower demand level) (0805);
(6) With the kiosk computing device, store written media in an anticipatory storage locker (ASL) or a secure media lockbox (SML) and proceeding to step (1) (0806); and
(7) With the kiosk computing device and RAC/ARM hardware, dispensing anticipated media in response to consumer transactions via the anticipatory storage locker (ASL) or a secure media lockbox (SML) and proceeding to step (1) (0807).

One skilled in the art will recognize that these two cooperating processes may operate simultaneously on a single kiosk or in some circumstances one kiosk proximal to another kiosk may act as the “host” computer system. Furthermore, it should be noted that kiosks that are in the same general location may share the tasks of media duplication such that ASL or SML locations on a given kiosk may be allocated to a specific duplicated media content and a consumer may be directed to a particular kiosk having a previously recorded media content for pickup. This anticipatory writing of media content eliminates the delay normally associated with writing the media content in response to the real-time consumer interaction with the kiosk and thus improves overall consumer satisfaction with the system.

### Secure USB Thumb Drive (UTD) System (0900)-(1600)

### Hardware Overview (0900)

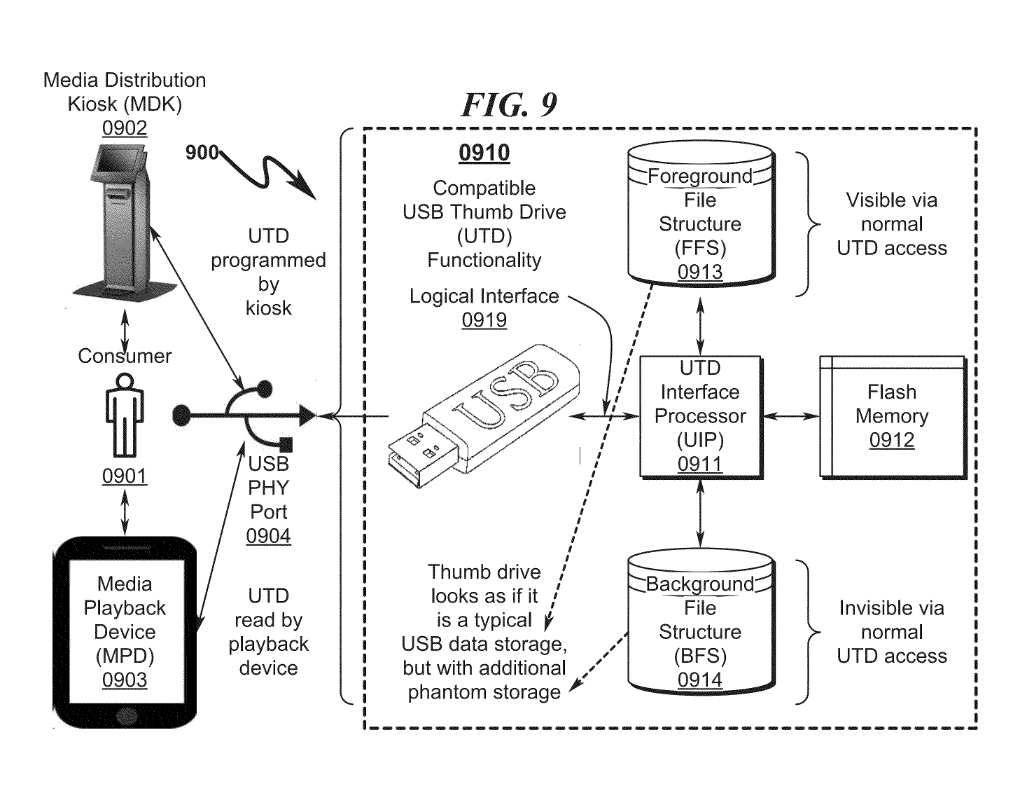

Several implementations of the present invention make use of a USB thumb drive (UTD) as the media transportation unit (MTU) that is written by the media duplication device (MDD). As generally depicted in FIG. 9 (0900), in this application context the consumer (0901) interacts with the media distribution kiosk (MDK) (0902) to obtain a USB compatible hardware thumb drive device (0910) that may be used to later playback stored media on a media playback device (MPD) (0903).

To this end, the difficulty in storing any type of media content on a USB compatible thumb drive (UTD) is the issue of security and how to ensure that the media content stored on the UTD (0910) is not duplicated in an unauthorized fashion. The present invention approaches this problem in the following manner. The UTD (0910) in this implementation contains special purposed hardware that provides a compatible USB thumb drive interface that may be read by a standard computer system. This physical (0904) and logical interface (0919) is provided by a UTD interface processor (0911) executing machine instructions from flash memory (0912) that has been loaded from master computer readable media in the factory.

This UTD interface processor (0911) maintains data in two separate file structures: a foreground file structure (FFS) (0913) and a background file structure (BFS) (0914). The FFS (0913) is read-only and can only be modified under certain conditions by the UTD interface processor (0911) and normally remains static after initial programming at the factory. The BFS (0914) contains the secure media content and is not available for read by the media playback device (MPD) (0903) unless access is provided by the UTD interface processor (0911).

On initial power-up (when the UTD (0910) is initially inserted into the media playback device (MPD) (0903)), the UTD interface processor (0911) activates the FFS (0913) and uses this as the data source for all data read requests from the USB physical interface (0904). This bootup configuration provides a typical AUTORUN.INF file for activation by the media playback device (MPD) (0903) and any additional software that may be necessary to activate media playback software on the media playback device (MPD) (0903). In this initial bootstrap mode, the BFS (0914) is invisible to the media playback device (MPD) (0903).

### Exemplary UTD Hardware Detail (1000)

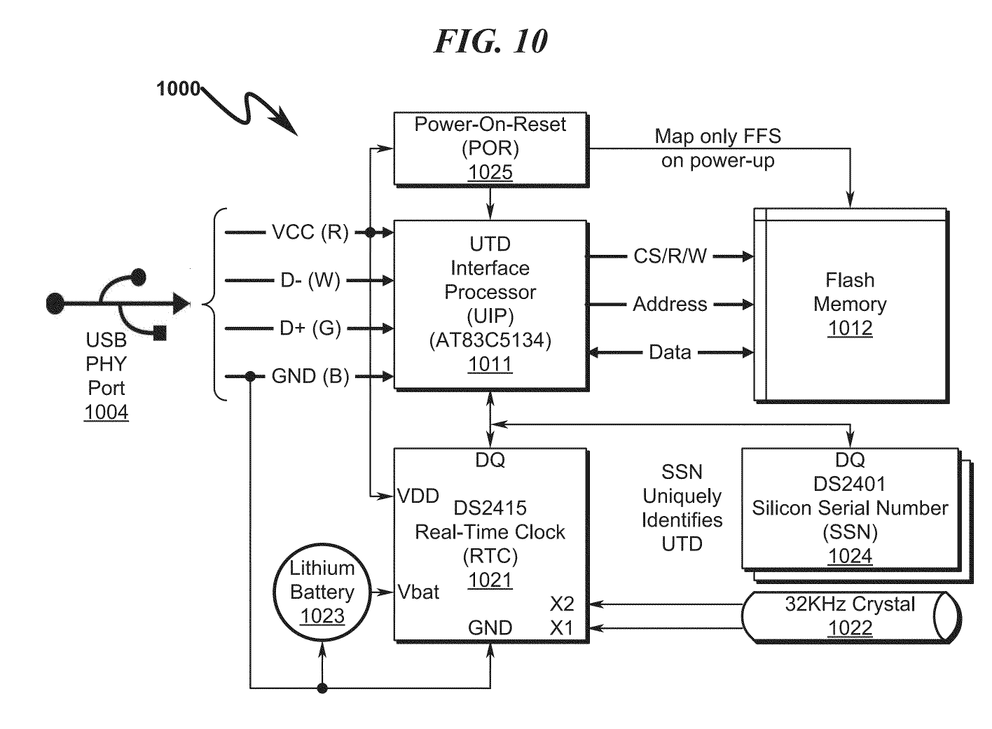

FIG. 10 (1000) depicts a typical hardware construction of the UTD Media Distribution Stick and incorporates unique hardware required to prevent software application hacking and unauthorized access to the media content stored on the UTD. Additional detail of the exemplary UTD implementation presented in FIG. 10 (1000) depicts special purpose USB hardware comprising a UTD interface processor (1011) implemented as an ATMEL AT83C5134 microcontroller interfacing an addressable flash memory (1012) for software booting and control instructions. The physical USB interface (1004) is handled by the UTD interface processor (1011) which serves as a secure barrier between the media playback device (MPD) and the media content stored in the flash memory (1012). While a conventional USB 1.0/2.0 interface is presented in this example, the present invention anticipates that a USB 3.0 interface may also be implemented to the UTD interface processor (1011).

The UTD incorporates a real-time clock (RTC) with battery backup to permit authentication of media playback device (MPD) requests. A real-time clock (1021) implemented as a Dallas Semiconductor DS2415 is tasked with keeping accurate calendar and time information to determine when media content is available for playback and is supported by a 32768 Hz crystal (1022). A lithium battery (1023) supports the real-time clock (1021) and crystal (1022) to ensure that the calendar/time information remains accurate when the UTD is not powered by the media playback device (MPD) or media distribution kiosk (MDK). A unique silicon serial number (SSN) (1024) implemented as a Dallas Semiconductor DS2401 provides a unique hardware identifier for the UTD that cannot be changed or overwritten by software. This unique serial number allows the UTD to be matched with media content such that access to the media content is prevented without knowledge of the serial number associated with the UTD. As depicted in the diagram, the UTD may be configured with multiple (SSN) (1024) information. One or more of the (SSN) (1024) may be visible to the USB port, while other of the (SSN) (1024) may be hidden by and not available to the USB port. This permits a media distribution kiosk (MDK) to identify the UTD device but still have information within the UTD which is not available via the USB port. Finally, a power-on reset (POR) circuit (1025) provides a positive reset to the UTD interface processor (1011) such that the UTD interface processor (1011) is forced to prevent access to the BFS on initial insertion to the media playback device (MPD) or media distribution kiosk (MDK).

### Flash Memory Detail (1100)

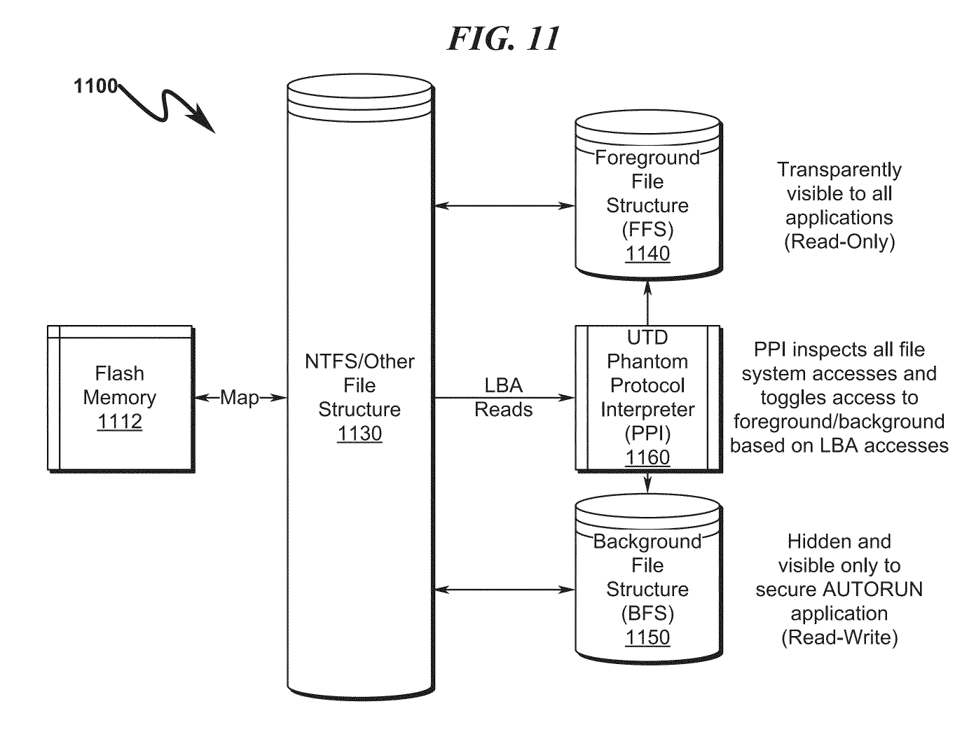

Additional detail of the structure of the flash memory used with the UTD is presented in FIG. 11 (1100), wherein the flash memory (1112) is structured into a NTFS or other file structure (1130) comprising a foreground file structure (FFS) (1140) that is transparently visible and read-only to all software applications accessing the USB interface, and a background file structure (BFS) (1150) that is normally hidden from view and visible only to secure AUTORUN applications and is read-write by the media distribution kiosk (MDK).

Which file structure (FFS (1140) or BFS (1150)) that is presented to the USB interface is determined by a UTD phantom protocol interpreter (PPI) (1160) which constantly inspects and monitors all file system accesses to the USB thumb drive based on logical block address (LBA) accesses. This PPI (1160) normally only allows access to the FFS (1140), but when a particular LBA access protocol is matched, the PPI (1160) activates access to the BFS (1150). The access protocol is driven based on the values of LBA that are accessed by the media playback device (MPD) or the media distribution kiosk (MDK). The particular sequence of LBA accesses is determined in part by the SSN or some other unique identification bit string associated with the UTD.

### Foreground File System (FFS) Detail (1200)

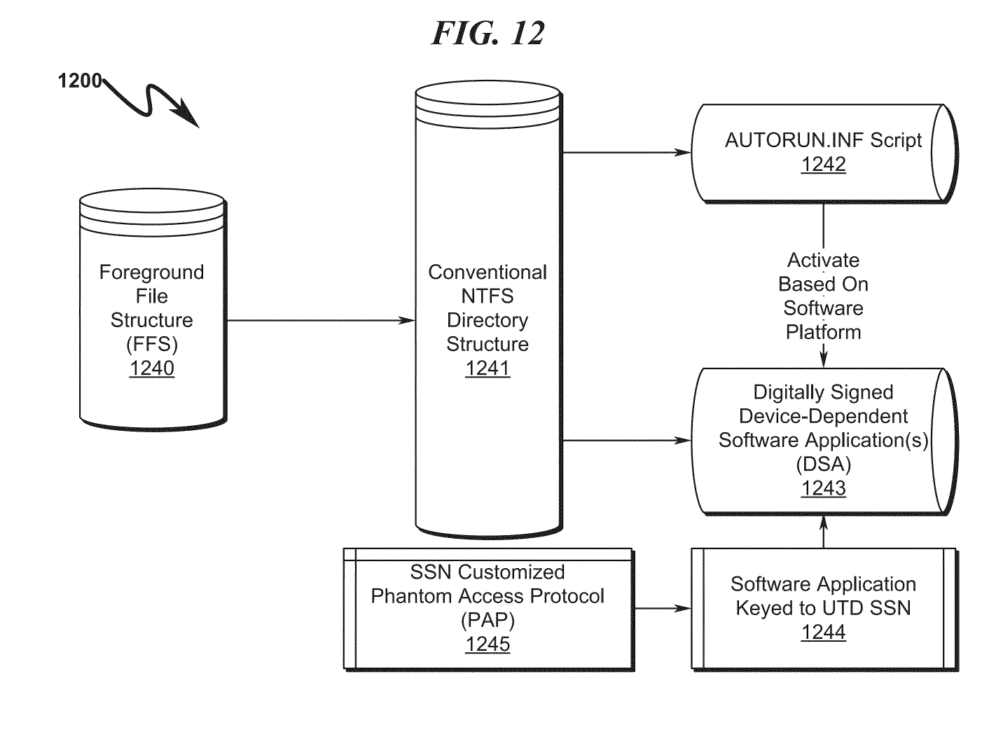

Additional detail of an exemplary foreground file system (FFS) is depicted in FIG. 12 (1200) wherein the FFS (1240) comprises a conventional MICROSOFT® WINDOWS® NTFS file directory structure (1241) further comprising an AUTORUN.INF script file (1242) or some other script that may be automatically activated based on the software environment present on the media playback device (MPD). The automatically activated script file (1242) activates one or more digitally signed device-dependent software applications (DSA) (1243) that has been keyed (1244) to the SSN of the UTD and incorporates a SSN customized phantom access protocol (PAP) (1245) enabling access to the BFS within the UTD flash memory via triggering of the PPI logic within the UTD interface processor.

Note that the DSA software loaded on each UTD is unique to that UTD because it incorporates software protocols that are keyed to the SSN of each individual UTD. Thus, copying the software from one UTD to a second UTD would not enable access to the underlying BFS on that second UTD, as the SSN of the second UTD will not match that of the first UTD. It is this hardware uniqueness that ensures that media content on one UTD cannot be accessed by duplicating the flash memory of the UTD to another device.

### Exemplary UTD Configuration Process (1300)

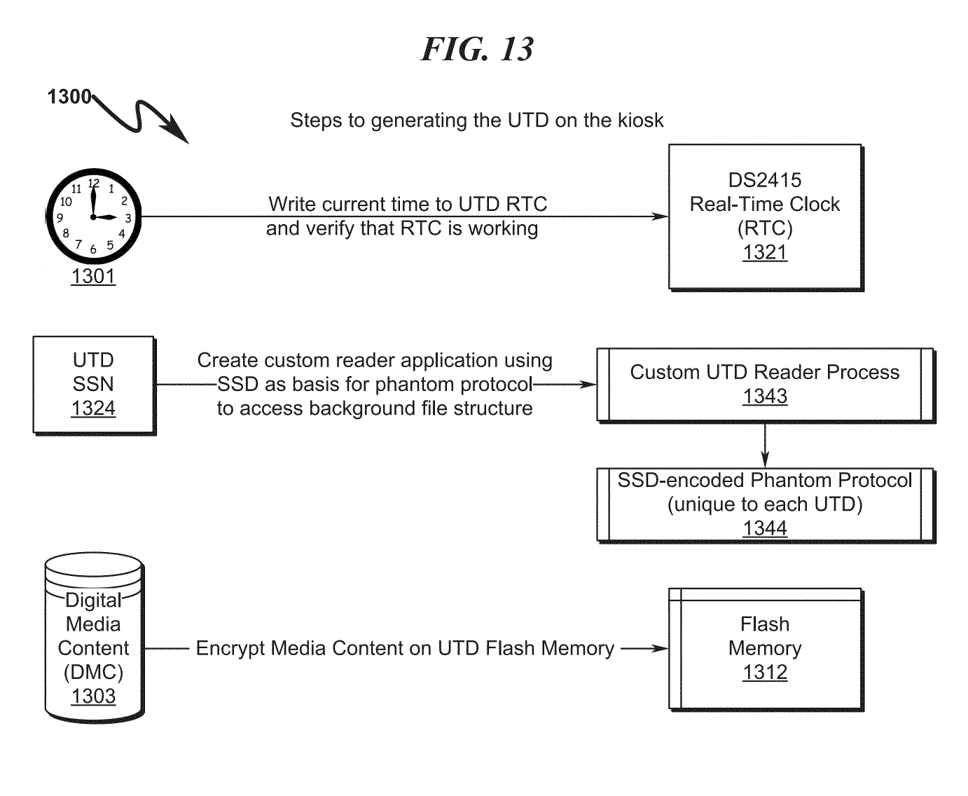

An exemplary methodology to configure the UTD for use by the media playback device (MPD) is depicted in FIG. 13 (1300). The general method includes the following steps:
(1) The current time (1301) is written to the real-time clock (RTC) (1321) on the UTD and once initially written, it is prevented from being updated or rewritten by the UIP. The functionality of the RTC (1321) is verified to ensure that it is functioning properly.
(2) The UTD SSN (1324) is used to generate a custom reader application using the SSD as a basis for a phantom protocol to access the background file structure (BFS) within the UTD flash memory. This involves creating a custom UTD reader process (1343) that uses the SSN to generate specific LBN reads to the UTD. This protocol as generated is tied to the UTD SSN and is mated to the PPI (1344) within the UIP.
(3) The digital media content (1303) is then encrypted and written to the UTD flash memory (1312). The decryption keys are contained within the BFS that is only available after the PPI (1344) has matched the SSN-generated protocol within the custom UTD reader process (1343).

Once written, the UTD is ready to be activated by the media playback device (MPD). Once activated, the AUTORUN.INF file activates the SSN-specific customized application on the UTD FFS memory which then goes through a unique series of accesses to the UTD to trigger activation of the BFS. Once the BFS is readable, encryption keys may be retrieved in addition to the encrypted media content and the two merged to extract media for playback on the MPD.

### Exemplary Media Content Playback Process (1400)

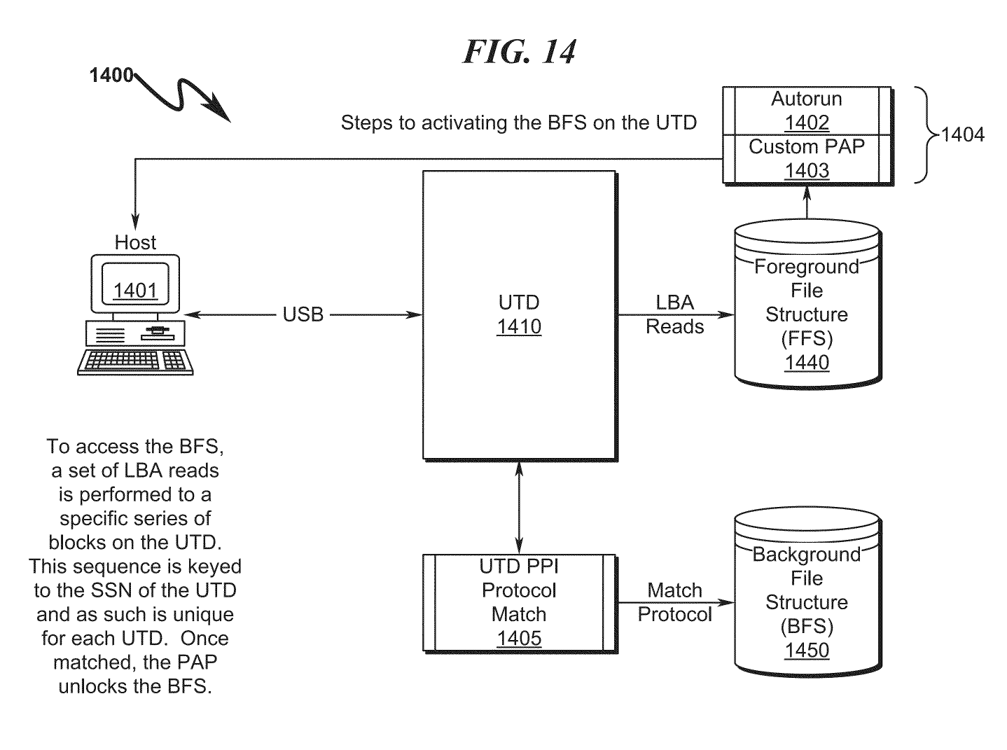

An exemplary methodology to playback the media content contained on the UTD by the media playback device (MPD) (or a host computer system) is depicted in FIG. 14 (1400). The general method includes the following steps:
(1) The UTD (1410) is inserted into the media playback device (host computer) (1401).
(2) The UTD presents in the FFS (1440) the AUTORUN script (1402) and custom phantom access protocol (PAP) (1403) application to the MPD (1401) for execution by the MPD (1401).
(3) The MPD (1401) executes LBA reads to the FFS (1440) through the UTD (1410) matching the BFS access protocol that has been customized in the custom PAP using the UTD SSN. This activates a UTD PPI protocol match (1405).
(4) The BFS (1450) is then activated permitting the custom PAP (1403) access to the media encryption keys and encrypted media content within the BFS (1450). This media content information is then decrypted by the MPD and displayed to the consumer.

In some embodiments the UTD may be responsible for decrypting the media content stored in the flash memory using the stored encryption keys and allowing the MPD access to a plaintext view of LBAs within the flash memory that represent the media content to be displayed to the consumer.

### UTD Registration (1500)

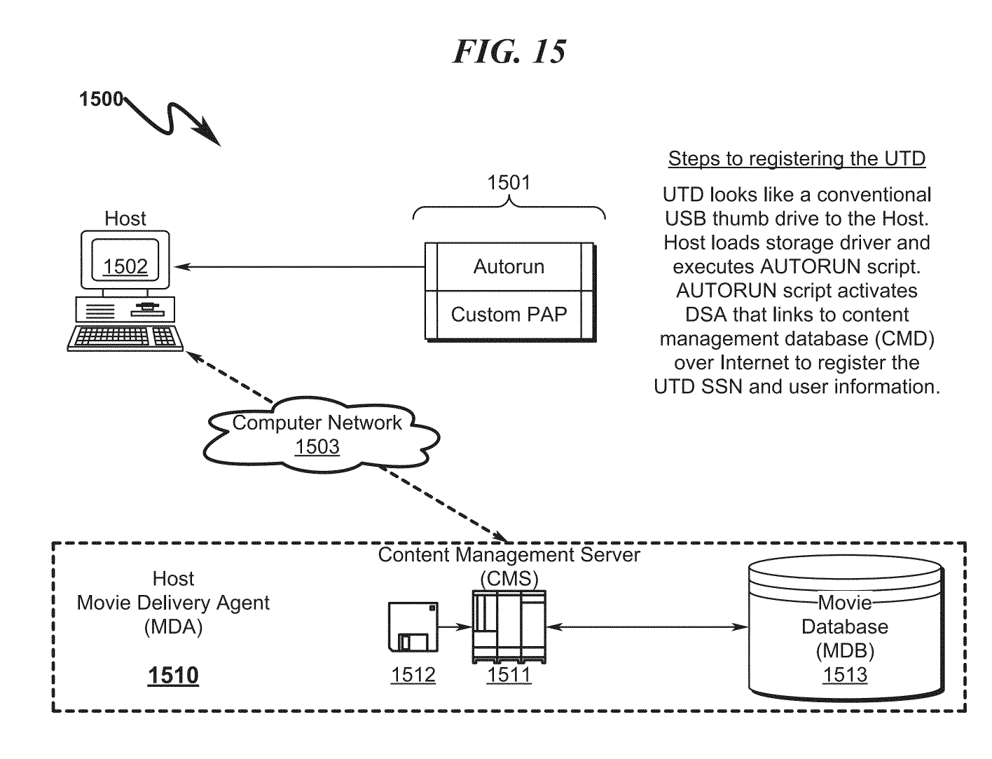

As depicted in FIG. 15 (1500), in some circumstances it may be desirable for the UTD to be registered with a movie delivery agent (MDA) before media content on the UTD is made available for use by a consumer. Here the AUTORUN/CUSTOM PAP application (1501) retrieved from the UTD is executed on the MPD host (1502) which communicates through the Internet (or another computer network) (1503) to a movie delivery agent (MDA) (1510) comprising a content management server (CMS) (1511) executing machine instructions read from a computer readable medium (1512). Here the CMS (1511) accesses a movie database (MDB) (1513) that has links between SSNs of various UTDs and the media content that is associated with the particular UTD. Once verification that the remote UTD is associated with the proper media content, a media activation message may be sent to the MPD (1502) to allow the media to be activated for use by the consumer. This process may involve the downloading of specific activation restrictions based on time, number of media content accesses, and other restrictions regarding media content use.

DMC Playback from the UTD (1600)

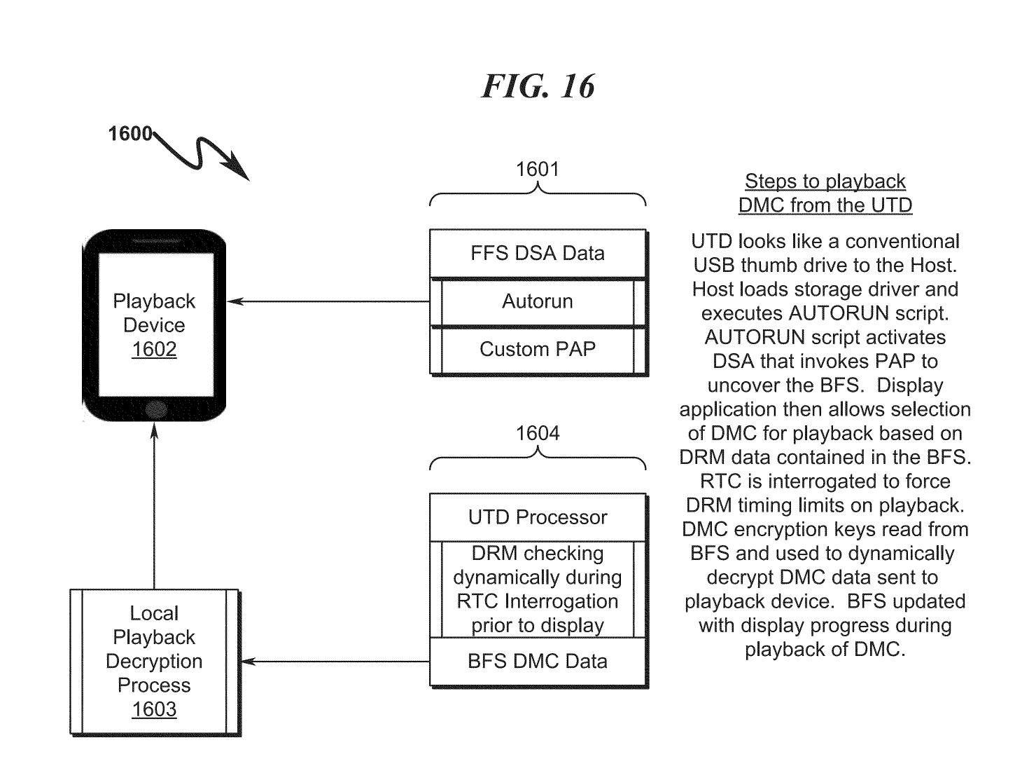

As depicted in FIG. 16 (1600), playback of digital media content (DMC) starts with accessing the unique FFS DSA data (1601) from the UTD by the MPD (1602). This causes a local playback decryption process (1603) read from the UTD FFS to run on the MPD (1602) that communicates with the UIP (1604) to perform digital rights management (DRM) checking dynamically during access to the encrypted media content stored in the UTD flash memory. As depicted, this may involve real-time access to the UTD RTC to ensure that accesses to the DMC on the UTD comply with distribution time restrictions associated with the DMC.

### Secure USB Thumb Drive (UTD) Methods (1700)-(2400)

### UTD Media Distribution Kiosk Recording Method (1700)

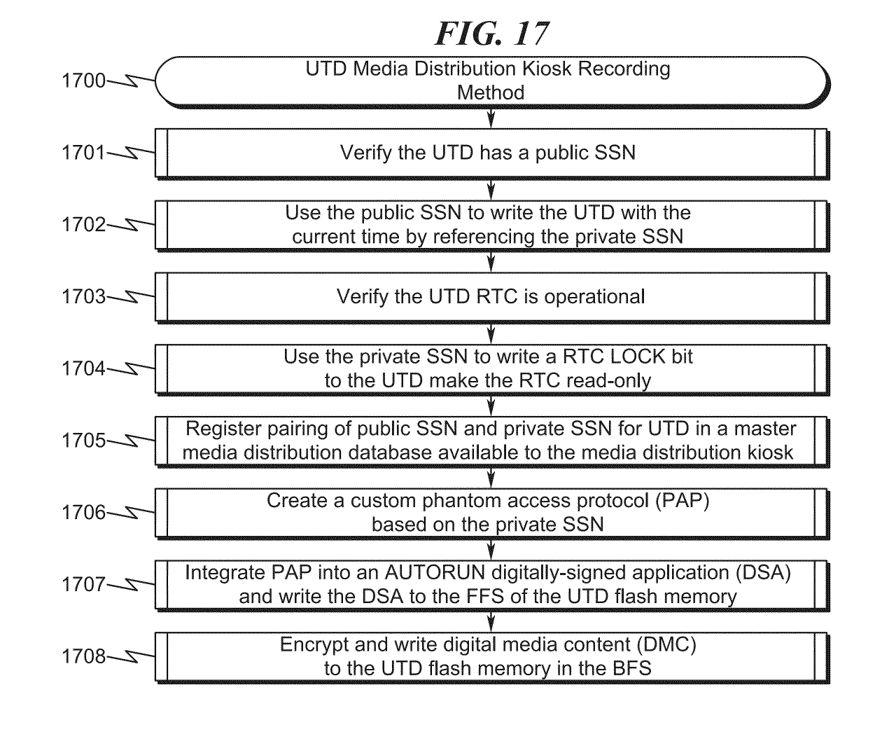

While several methods to record media content on the UTD are anticipated, several are preferred. One such preferred exemplary recording method is depicted in FIG. 17 (1700) and comprises the following steps:
(1) Verifying the UTD has a public SSN (1701). This step verifies that the UTD in question has the proper hardware complement including a SSN.
(2) Using the public SSN to write the UTD with the current time by referencing the private SSN (1702). The private SSN is linked to the public SSN and the match between these two identifiers is known at UTD manufacture and can be used to key access to the UTD.
(3) Verifying the UTD RTC is operational (1703).
(4) Using the private SSN to write a RTC LOCK bit to the UTD make the RTC read-only (1704).
(5) Registering the pairing of public SSN and private SSN for the UTD in a master media distribution database available to the media distribution kiosk (1705).
(6) Creating a custom phantom access protocol (PAP) based on the private SSN (1706).
(7) Integrating the PAP into an AUTORUN digitally-signed application (DSA) and writing the DSA to the FFS of the UTD flash memory (1707).
(8) Encrypting and writing digital media content (DMC) to the UTD flash memory in the BFS (1708).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### UTD Registration Method (1800)

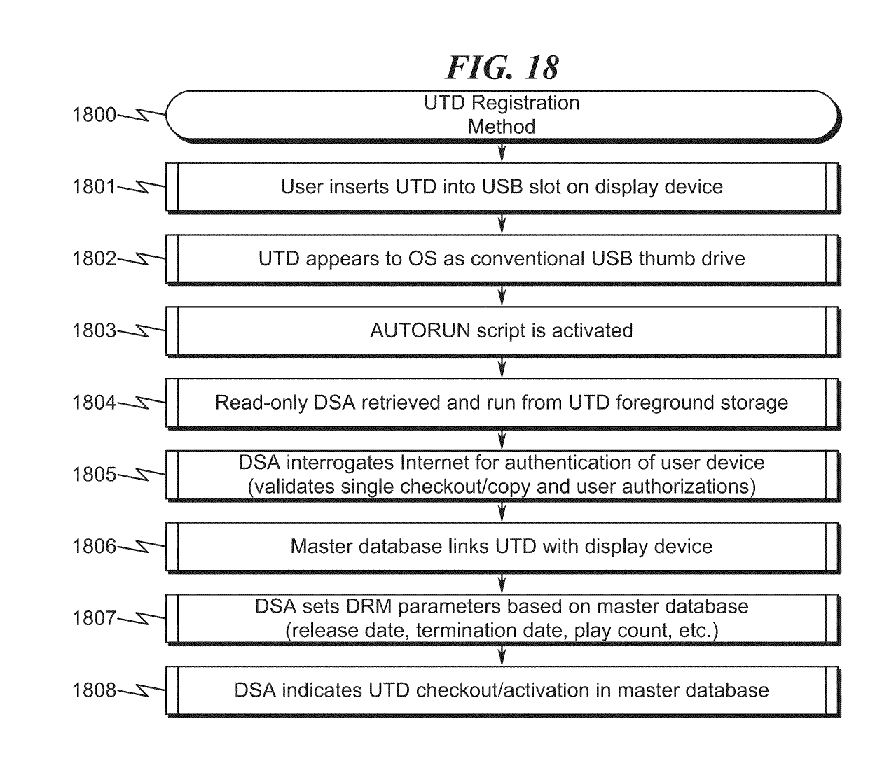

As described above, the UTD must be registered in some circumstances before media content may be retrieved from the UTD flash memory. An exemplary method to implement this registration is depicted in FIG. 18 (1800) and comprises the following steps:
(1) Inserting the UTD into a USB slot on a media playback device (MPD) (1801).
(2) Accessing the UTD as a normal USB thumb drive by the MPD (1802).
(3) Activating an AUTORUN script on the UTD (1803).
(4) Reading the DSA from the UTD under control of the AUTORUN script from the UTD FFS (1804).
(5) With the DSA, interrogating the Internet for authentication of the UTD to validate a single checkout/copy of the UTD against a public SSN database (1805).
(6) Linking the UTD SSN with the MPD (1806).
(7) With the DSA, setting the DRM parameters associated with the media content based on information from a master database (1807). This may include information such as release date, termination date, play count, etc.
(8) With the DSA, indicating UTD checkout/activation in a master database (1808).

Further to this process the DSA may incorporate an authentication screen to verify the identity of the customer and/or incorporate payment information necessary for a financial transaction to take place over the Internet.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### UTD Playback Method (1900)

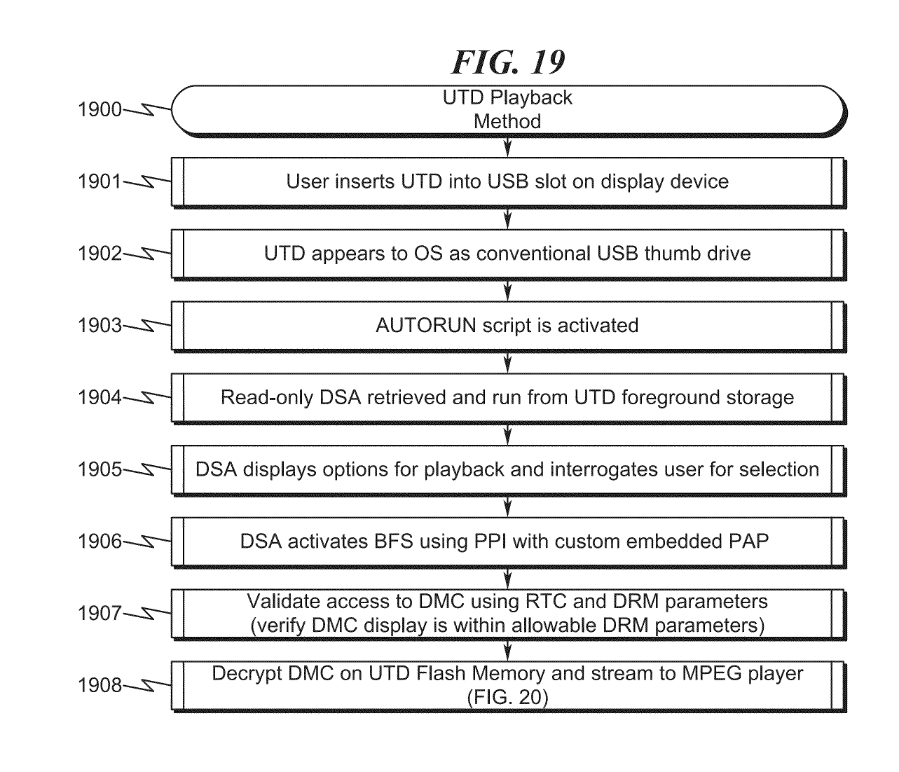

As described above, the UTD presents to the MPD as a standard USB thumb drive on insertion and then proceeds to activate special procedures and hardware that transform the “look” of the device to the MPD. An exemplary method to implement media playback using this hardware is depicted in FIG. 19 (1900) and comprises the following steps:
(1) Inserting the UTD into a USB slot on a media playback device (MPD) (1901).
(2) Accessing the UTD as a normal USB thumb drive by the MPD (1902).
(3) Activating an AUTORUN script on the UTD (1903).
(4) Reading the DSA from the UTD under control of the AUTORUN script from the UTD FFS (1904).
(5) With the DSA, displaying options for media playback to the user and prompting for a user selection of media content on the UTD (1905).
(6) With the DSA, activating the BFS on the UTD using the PPI with customized embedded PAP software (1906).
(7) With the DSA, validating access to the DMC on the UTD using the UTD RTC and DRM parameters stored in the UTD BFS flash memory and verifying that the DMC display is within allowable DRM parameters (1907). This may include restrictions on playback such as release date, termination date, play count, etc.).
(8) With the DSA, decrypting the DMC from the UTD flash memory and streaming the media content to the MPD for presentation to the user (1908).

Further to this process the DSA may convert the information from MPEG or other compressed format to raw video suitable for presentation to the user via the MPD.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### UTD Playback Termination (2000)

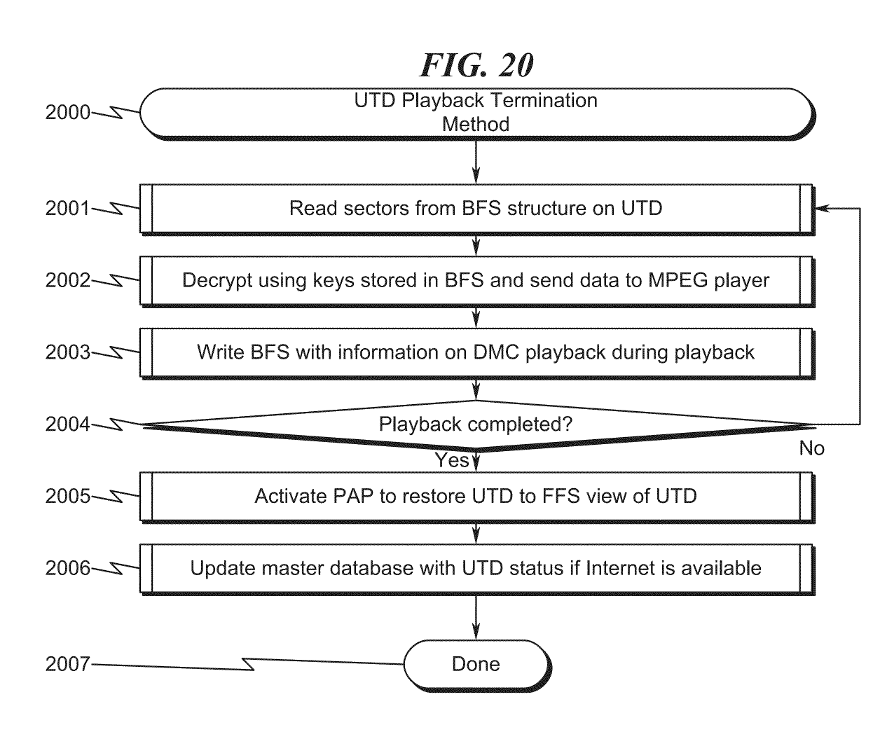

As described above, the UTD permits access to the BFS upon activation of the AUTORUN script logic that activates the PAP to unlock the BFS and switch from presentation of the FFS to the USB interface. Upon termination of media playback to the consumer, a corresponding playback termination procedure is executed which secures the UTD BFS from inspection by the USB interface. An exemplary method to implement this playback termination using this hardware is depicted in FIG. 20 (2000) and comprises the following steps:
(1) Reading sectors from the BFS structure on the UTD flash memory (2001).
(2) Decrypting these sectors using decryption keys stored in the BFS and sending this information to a MPEG decoder in the MPD (2002).
(3) Writing the BFS with information on DMC playback during the media playback operation to log access to the DMC access by the consumer (2003).
(4) Determining if DMC playback is complete, and if not, proceeding to step (1) (2004).
(5) Activating the PAP to restore the UTD to a FFS view of the flash memory on the UTD (2005).
(6) Updating a master database with the UTD status if the Internet or other computer communication network is available (2006).

Further to this process the DSA may convert the information from MPEG or other compressed format to raw video suitable for presentation to the user via the MPD. Note also that the UTD reverts to FFS mode if the UTD is physically disconnected from the MPD or upon initial insertion of the UTD into the USB slot of the MPD.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### UTD Content Management (2100)-(2200)

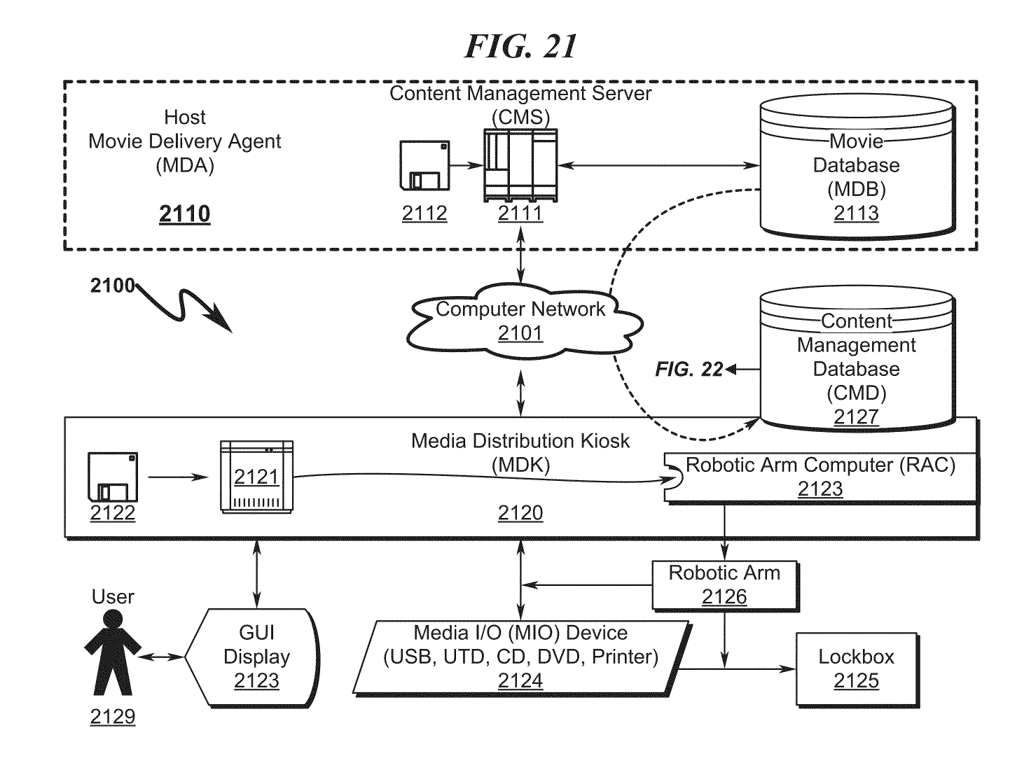

The UTD software that operates on the MPD may incorporate content management logging as depicted in FIG. 21 (2100). Here as depicted a host movie delivery agent (MDA) (2110) comprising a content management server (2111) executing machine instructions from a computer readable medium (2112) may deploy media content from a movie database (MDB) (2113) over a computer network (2101) to a remote media distribution kiosk (MDK) (2120) employing a special purpose kiosk control computer (KCC) (2121) executing instructions from a computer readable medium (2122). The MDK (2120) is integrated with a robotic arm computer (RAC) (2123) that interfaces with a media I/O system (2124) to duplicate media automatically based on content from the MDB (2113). Duplicated media is place in a lockbox (2125) by a robotic arm (2126) controlled by the RAC (2123).

Within this context the content management database (CMD) (2127) communicates with the MDK (2120) special purpose kiosk control computer (KCC) (2121) to verify the activation of media placed in the MIO (2124) by the robotic arm (2126) under control of the RAC (2123). Once properly loaded with media content by the media duplication device (MDD) via the MIO (2124), the media transportation unit (MTU) is disengaged and removed from the MIO (2124) by the robotic arm (2126) and placed in a lockbox (2125) for later secure access by the consumer (2129).

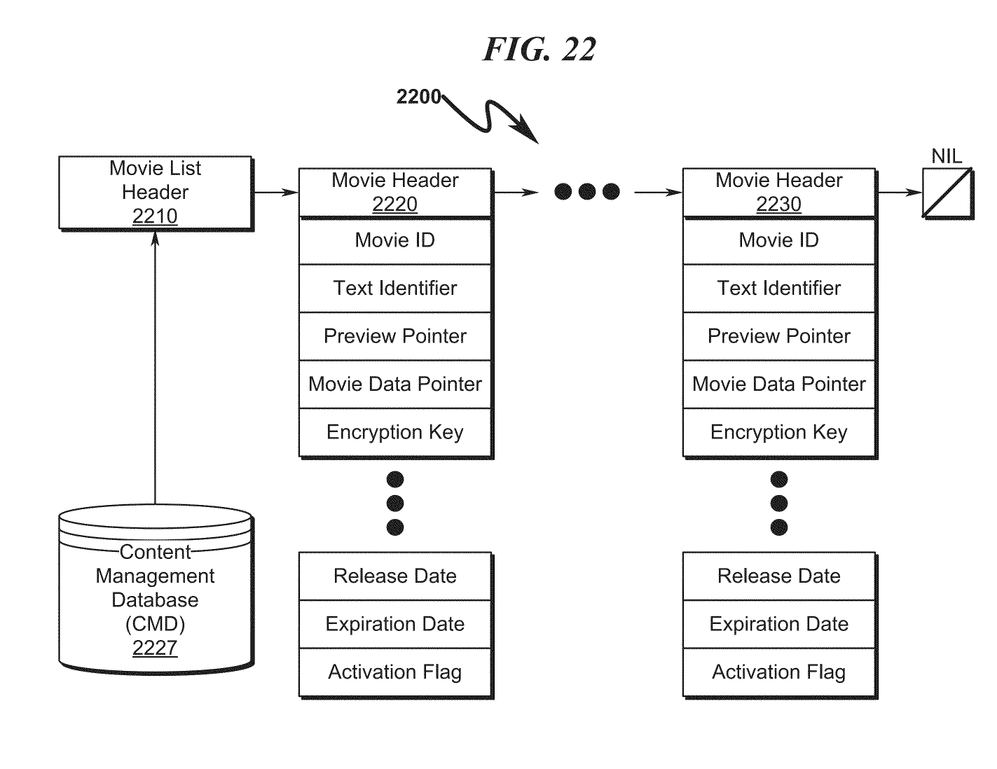

The content management database (2127, 2227) is further detailed in FIG. 22 (2200) and depicts the information associated with a movie list header (2210) having multiple movie list data structures (2220, 2230) that provide information on the movie identification, text identifier, preview display pointer, full movie pointer, encryption key, release date, expiration data, and activation flag. This information permits a given movie or other media content to be limited to a particular release date, expiration date, or inhibited from activation for a particular physical media deployed by the MDD.

### Movie Expiration Management (2300)

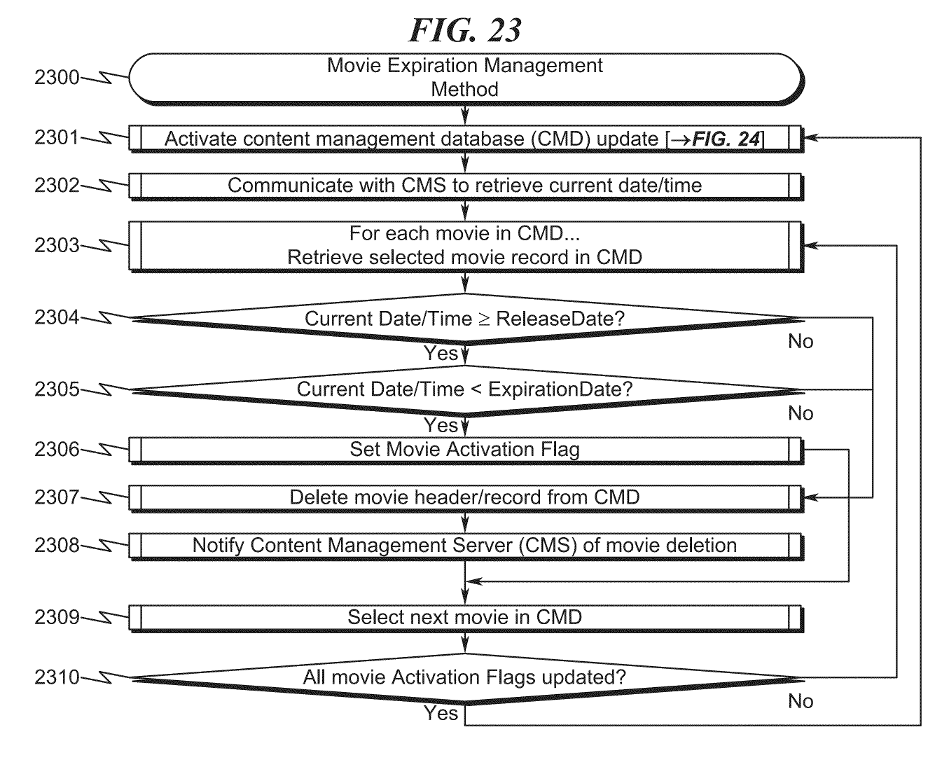

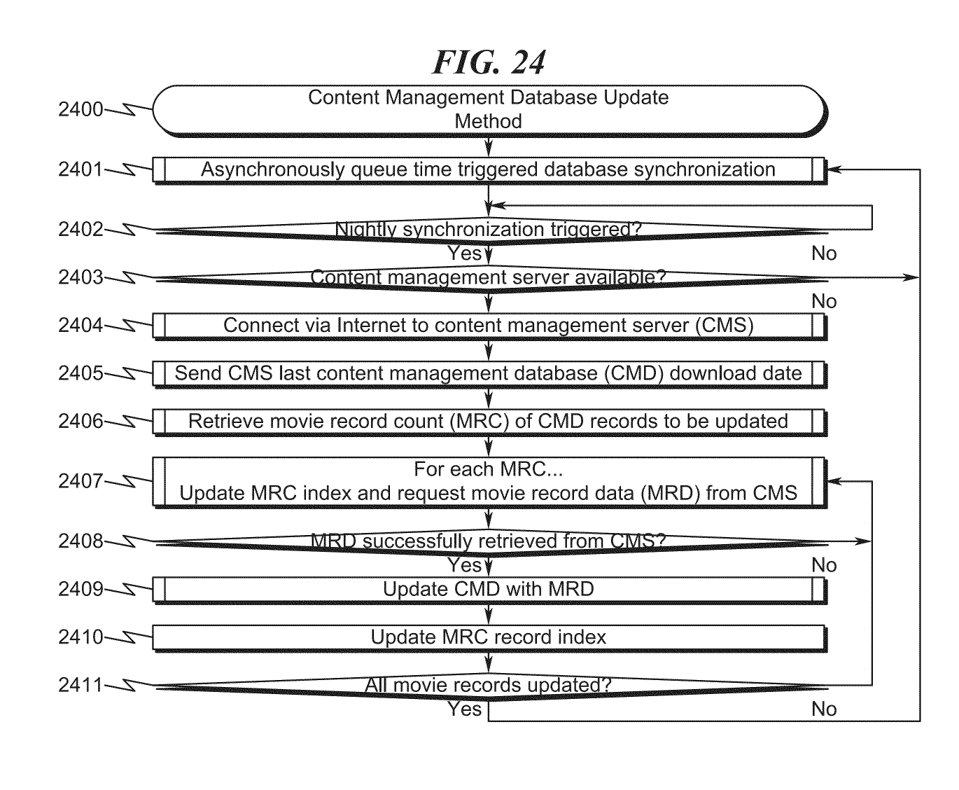

The content management server (CMS) described above can implement a movie expiration management method as generally depicted in FIG. 23 (2300) that limits the access to the particular movie or media content based on absolute date/time stored in the UTD. Generally, the steps involved in this method comprise:
(1) Activating a content management database (CMD) update process (as generally depicted in FIG. 24) (2301).
(2) With the MDK, communicating with the CMS to retrieve a current date/time (2302).
(3) For each movie in the CMD, retrieving a selected movie record in the CMD (2303).
(4) Determining if the current date/time is greater than or equal to the release date in the CMD, and if not, proceeding to step (7) (2304).
(5) Determining if the current date/time is less than the expiration date contained within the CMD, and if not, proceeding to step (7) (2305).
(6) Setting the movie activation flag in the CMD and proceeding to step (9) (2306).
(7) Deleting the movie header/record from the CMD (2307).
(8) Notifying the content management server (CMS) of the movie deletion from the CMD (2308).
(9) Selecting the next movie in the CMD for processing (2309).
(10) Determining if all movie activation flags in the CMD have been updated, and if not, proceeding to step (3), otherwise proceeding to step (1) (2310).

Using this process the media content contained within the MDK will be flagged as to its availability for distribution to the customer. Additionally, in the event that a particular media content has become stale, its status will be reported to the CMS to verify it has been deleted from the MDK. This ensures the security of the media content.

Since the content management database (CMD) is local to the MDK, it may be interrogated locally to determine whether media content contained in the MDK may be deployed to the customer via the MIO/MDD.

### Content Management Database Update (2400)

The content management server (CMS) described may be configured to automatically update the content management database (CMD) as generally depicted in FIG. 24 (2400) describing an exemplary update method useful in some invention embodiments. Generally, the steps involved in this method comprise:
(1) Asynchronously queuing a time-triggered database synchronization of the CMD (2401).
(2) Determining if a nightly synchronization has been triggered, and if not, proceeding to step (2) (2402).
(3) Determining if the content management server is available, and if not, proceeding to step (1) (2403).
(4) Connecting via the Internet to the content management server with the kiosk control computer (KCC) (2404).
(5) Sending the CMS the last content management database (CMD) download date (2405).
(6) Retrieving a movie record count (MRC) of CMD records to be updated (2406).
(7) For each MRC, updating the MRC index and requesting movie record data (MRD) from the CMS (2407).
(8) Determining if the MRD was successfully retrieved from the CMS, and if not, proceeding to step (7) (2408).
(9) Updating the CMD with the MRD (2409).
(10) Updating the MRC record index (2410).
(11) Determining if all movie records have been updated, and if not, proceeding to step (7), otherwise proceeding to step (1) (2411).

Using this process the local media content management database can be updated and permit kiosk operations to continue absent any communication with the content management server.

### Exemplary User Console (2500)-(2800)

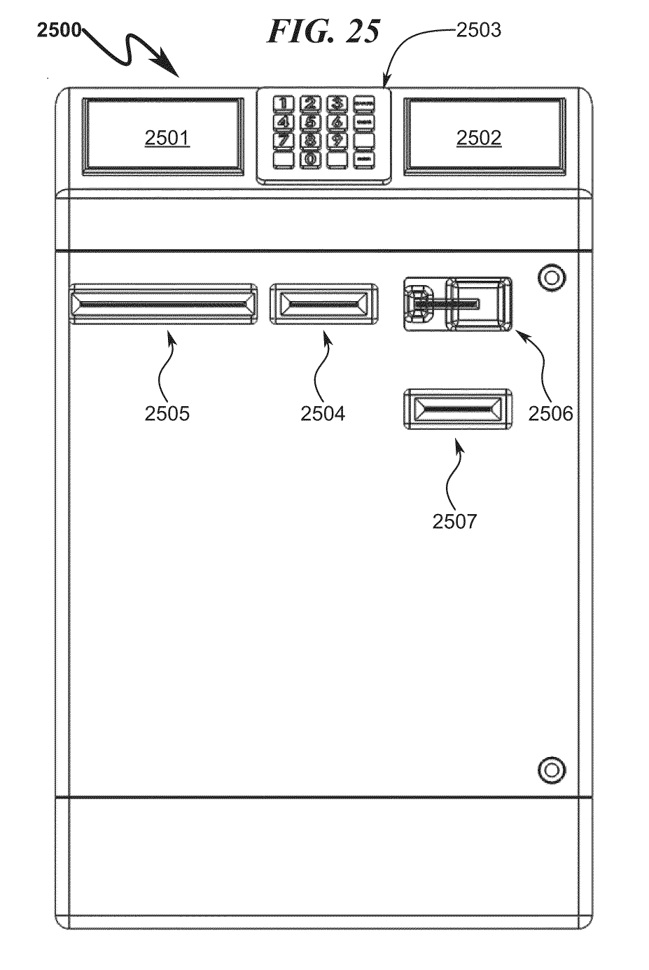

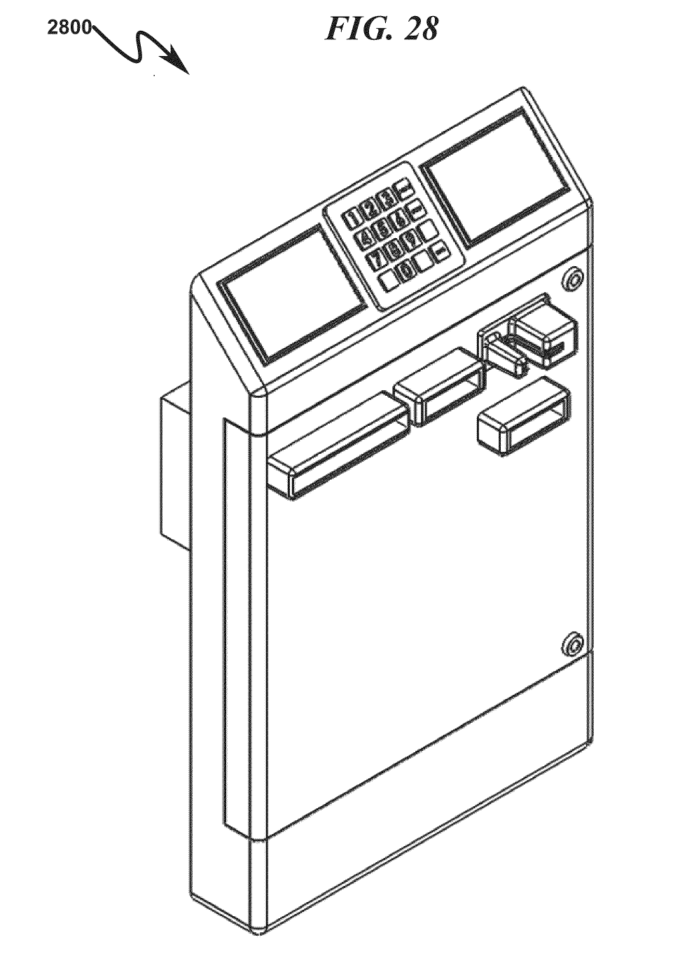

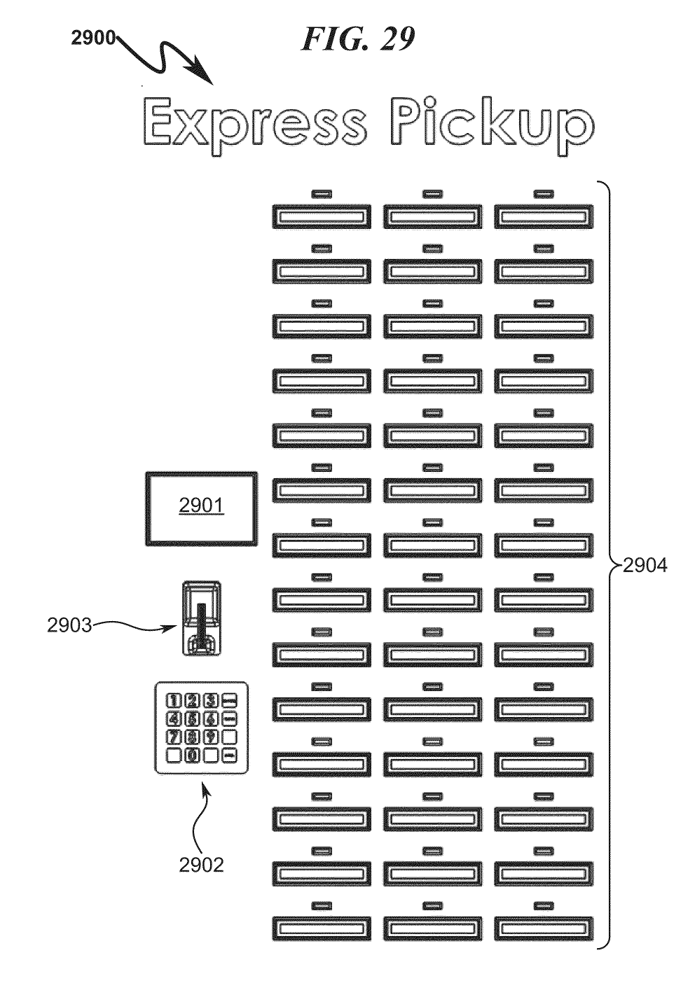

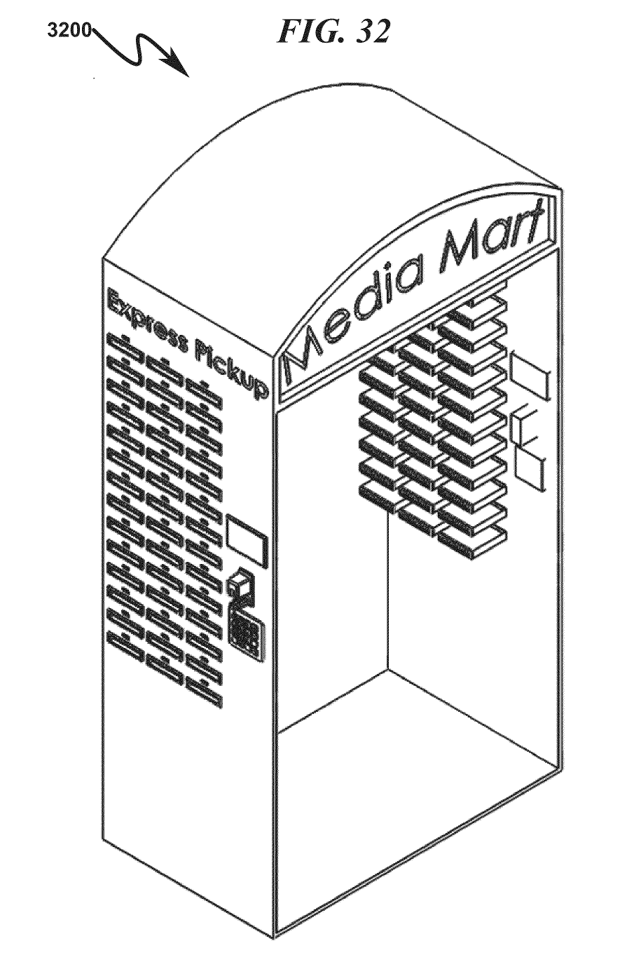

FIG. 25 (2500)-FIG. 28 (2800) provide additional detail regarding the user console interface to the system. The user console interface typically comprises one or more displays (2501, 2502), input keypad (2503), cash receptor (2504), cash dispenser and/or coin return (2505), credit card reader (2506), paper receipt printer (2507), USB interface, and a secure media lockbox (SML) (depicted in FIG. 29 (2900)-FIG. 32 (3200)). The SML may be contained proximal to or on the side of the kiosk as depicted in FIG. 29 (2900)-FIG. 32 (3200).

### Exemplary Lockbox Interface (2900)-(3200)

FIG. 29 (2900)-FIG. 32 (3200) provide additional detail regarding the secure media lockbox (SML) interface to the system. This interface provides for a display (2901), keyboard input (2902), credit card reader (2903), and a plurality of secure media lockboxes (SMLs) (2904) that may be accessed upon entry of identifying information via the keypad (2902) and/or a proper credit card in the credit card reader (2903). Once authorization is validated, the proper SML (2904) is opened and media contained in this lockbox may be retrieved by the consumer. While a plurality of SMLs (2904) is depicted in this embodiment, the number of SMLs (2904) on a given kiosk will vary based on application context.

### Single-User Media Distribution System (3300)-(4000)

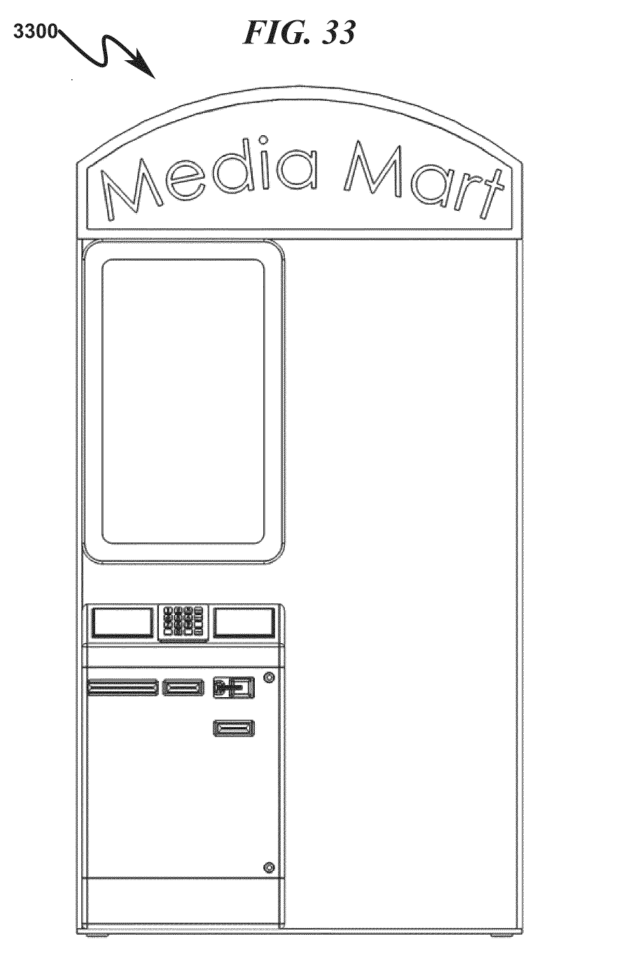

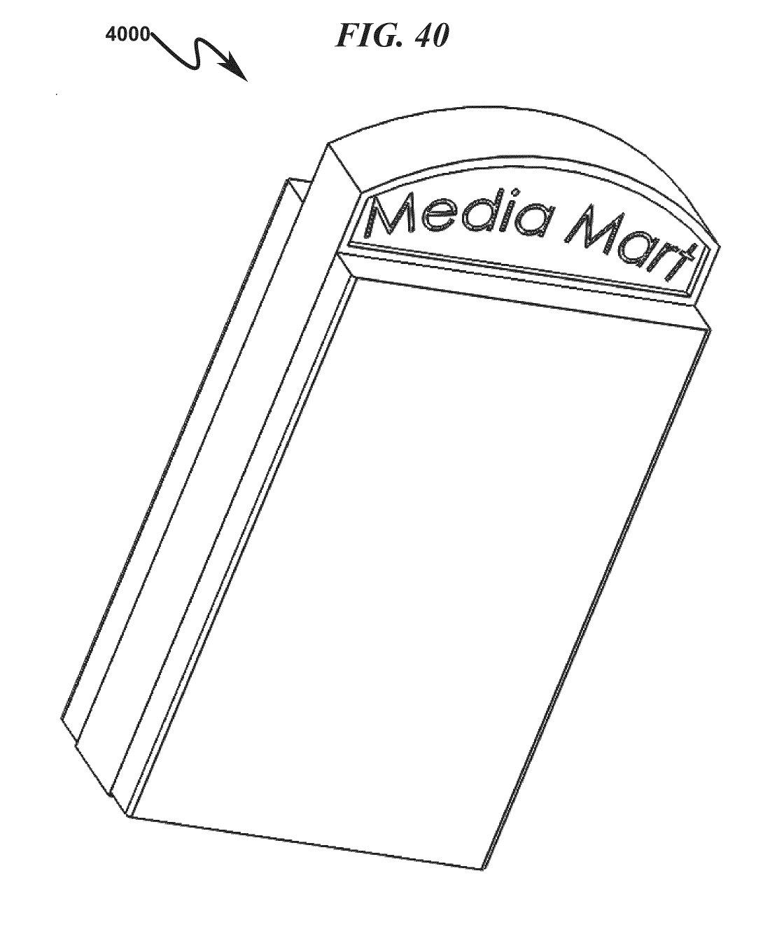

An exemplary embodiment of a single-user media distribution system is depicted in FIG. 33 (3300)-FIG. 40 (4000). Here the user interface keypad, video display, cash input device, credit card reader, cash output device, receipt printer, USB interface, and secure media lockbox are all presented on the front face of the kiosk system and provide for a single point of customer contact.

### Dual-User Media Distribution System (4100)-(4800)

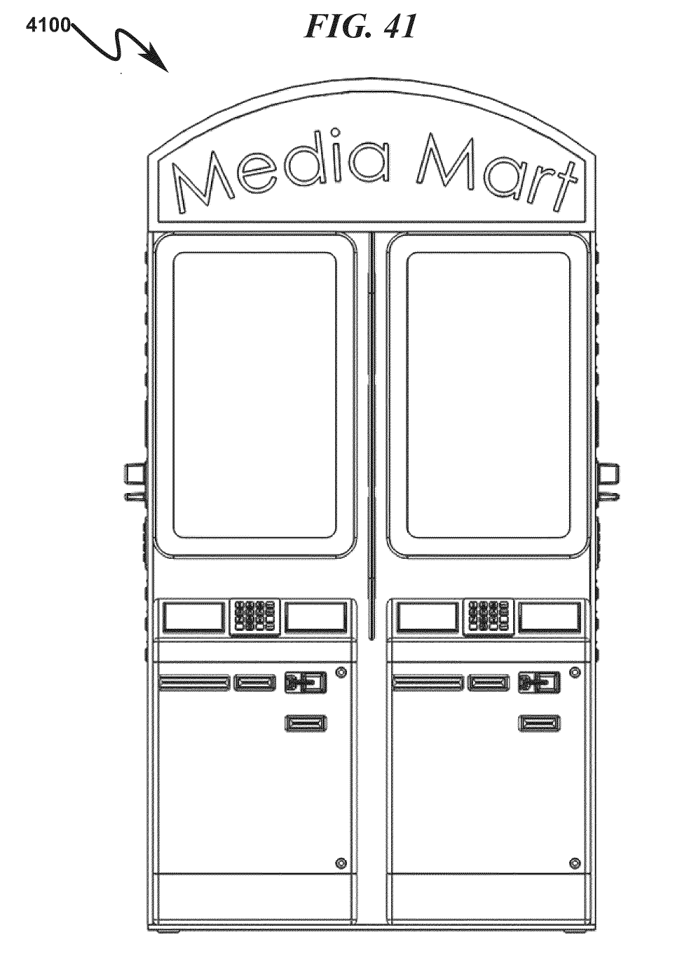

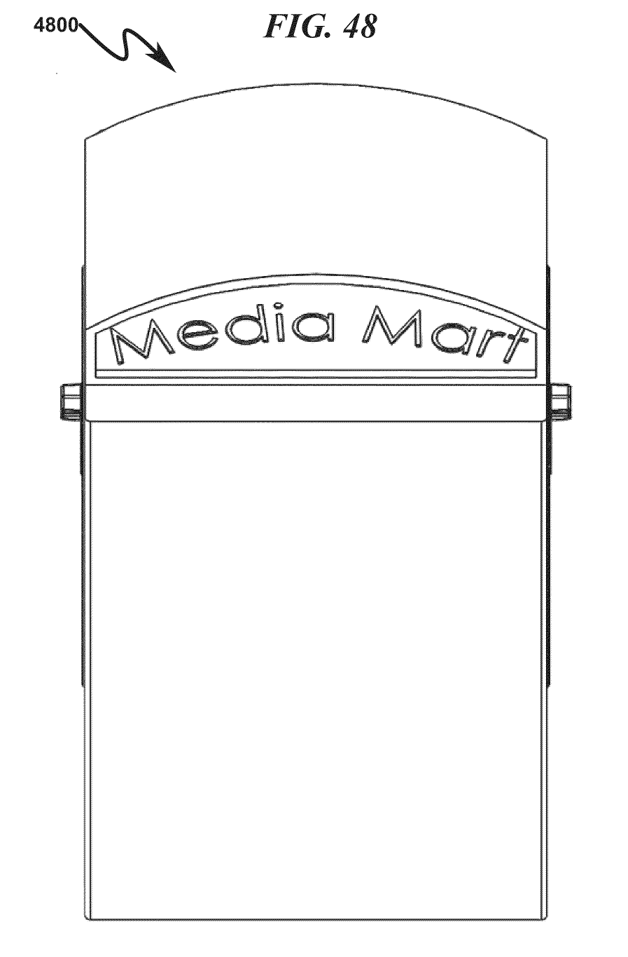

An exemplary embodiment of a dual-user media distribution system is depicted in FIG. 41 (4100)-FIG. 48 (4800). Here the system provides for dual user interface keypad, video display, cash input device, credit card reader, cash output device, receipt printer, USB interface, and secure media lockbox all present on the front face of the kiosk system and provide for a single point of contact for two simultaneous customers. Duplicated digital media content may be retrieved from secure media lockboxes (SML) located on both sides of the kiosk.

### Mirrored Dual-User Media Distribution System (4900)-(5600)

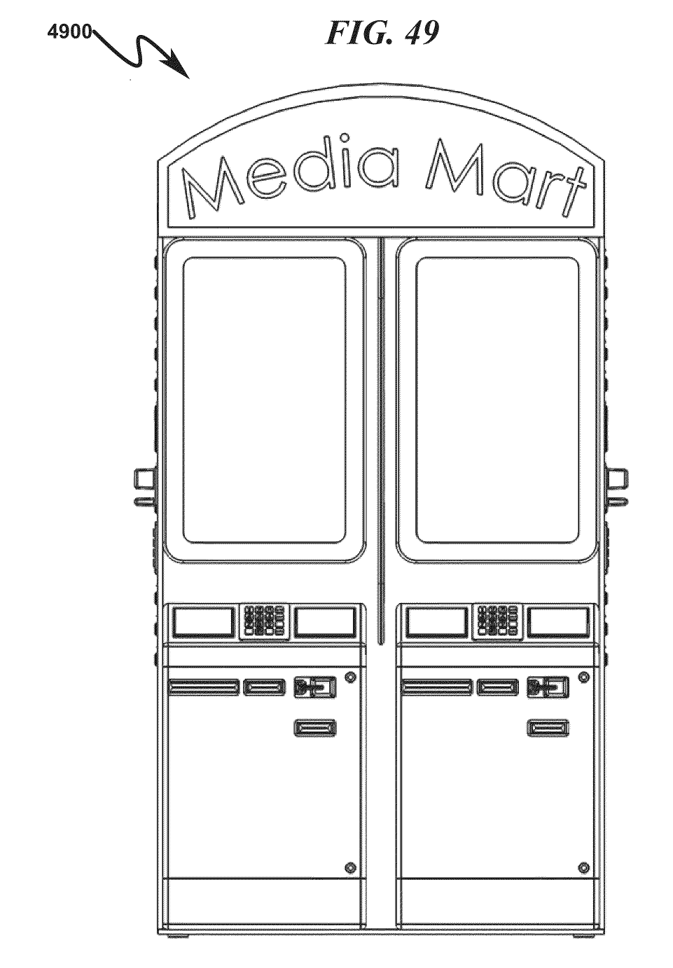

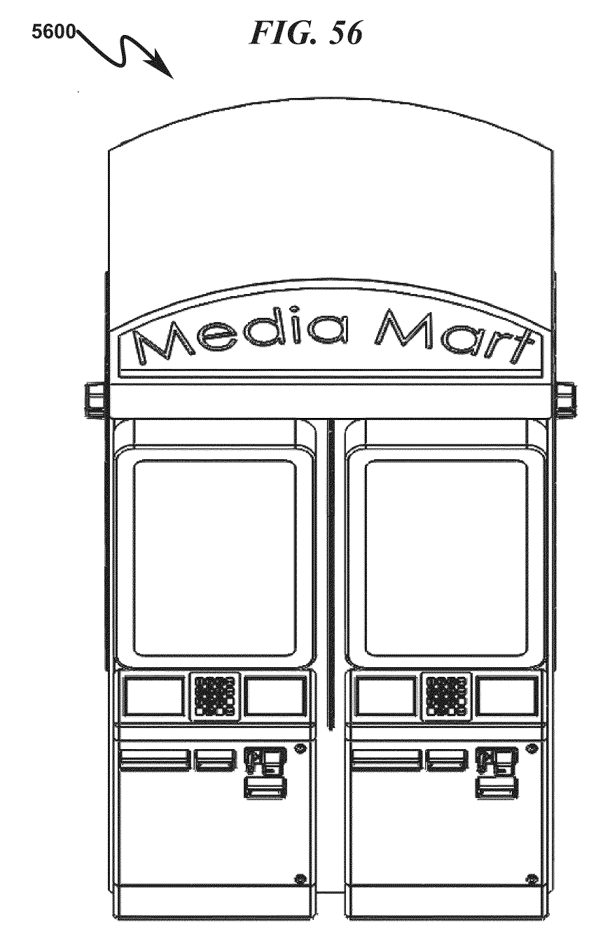

An exemplary embodiment of a mirrored dual-user media distribution system is depicted in FIG. 49 (4900)-FIG. 56 (5600). This system is identical to that presented in FIG. 41 (4100)-FIG. 48 (4800) but provides for four simultaneous customer interfaces and allows customers to retrieve recorded media from secure media lockboxes (SML) located on both sides of the kiosk.

### Triad Dual-User Media Distribution System (5700)-(6400)

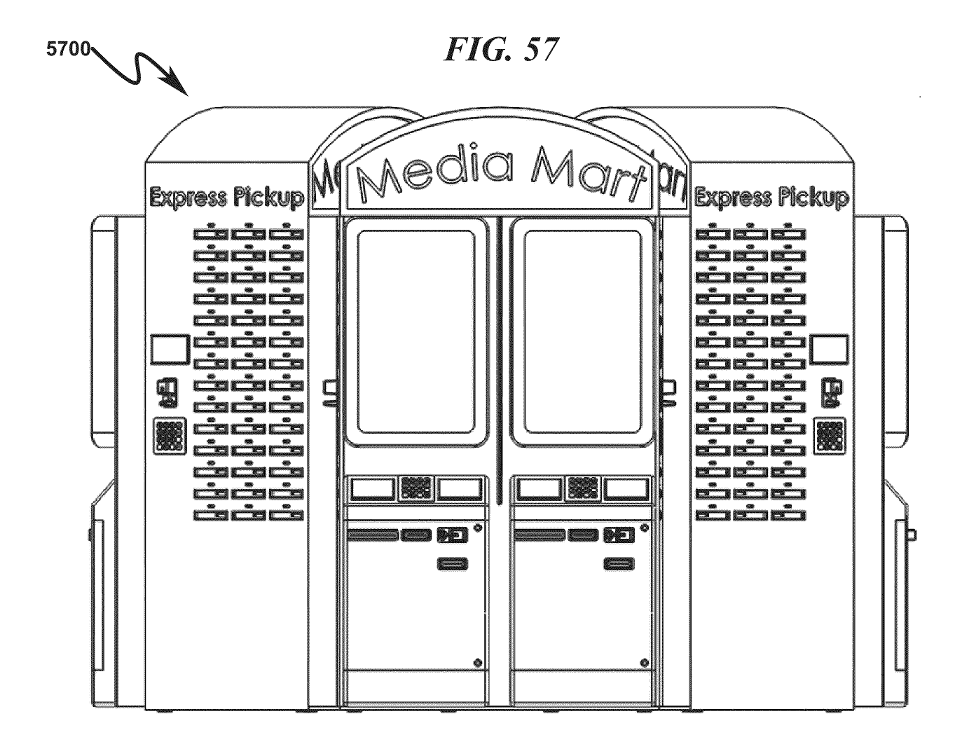

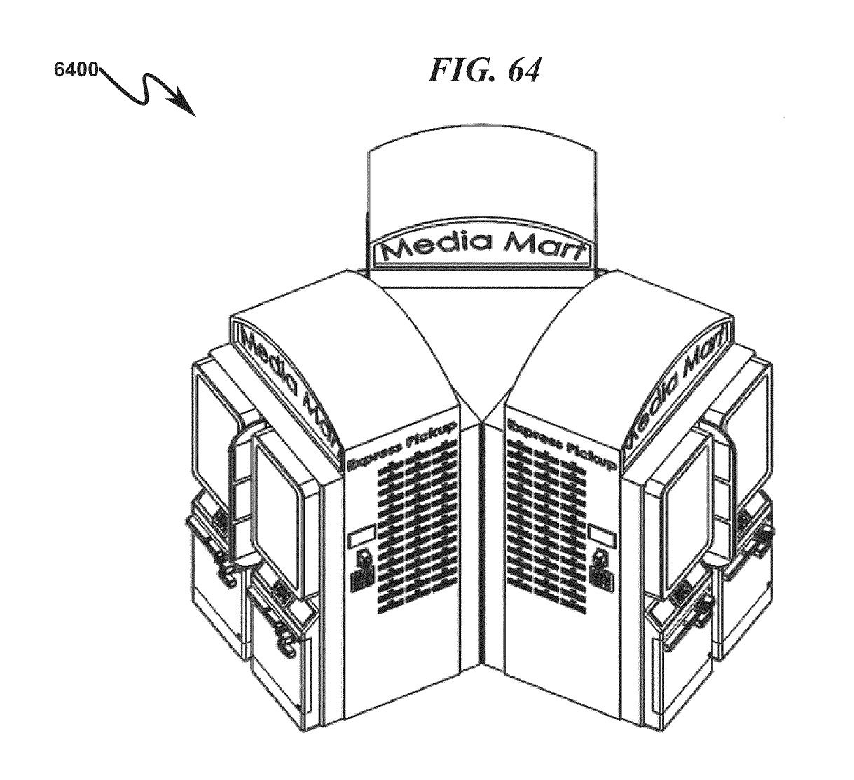

An exemplary embodiment of a triad-based dual-user media distribution system is depicted in FIG. 57 (5700)-FIG. 64 (6400). This system is identical to that presented in FIG. 41 (4100)-FIG. 48 (4800) but provides for six simultaneous customer interfaces and allows customers to retrieve recorded media from secure media lockboxes (SML) located on any of six sides of the kiosks.

### Robotic Arm Computer (RAC) and Articulating Robotic Arm (ARM) (6500)-(7200)

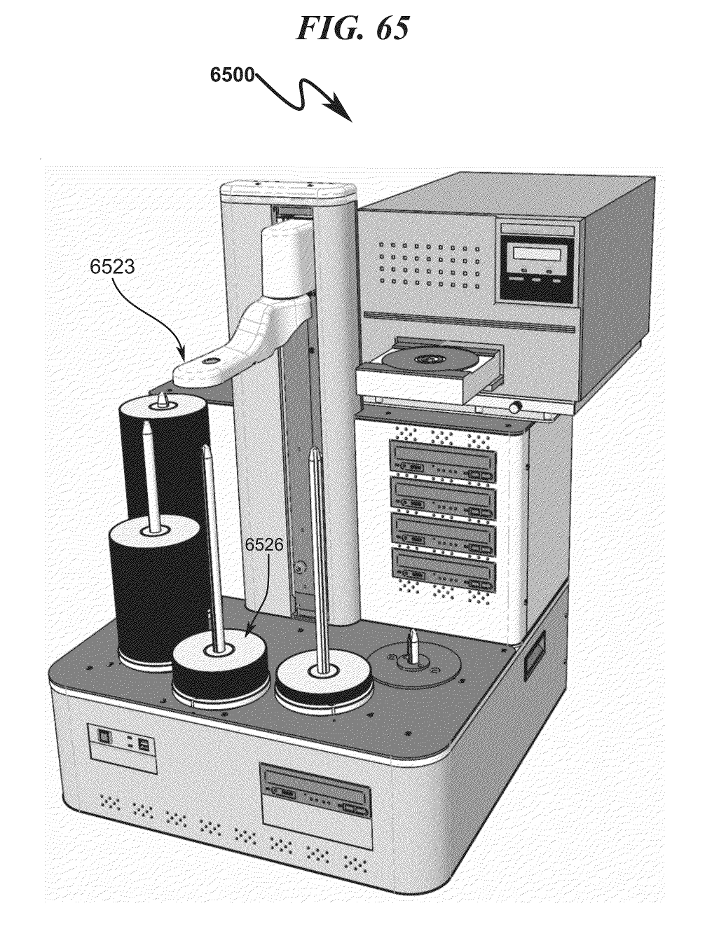

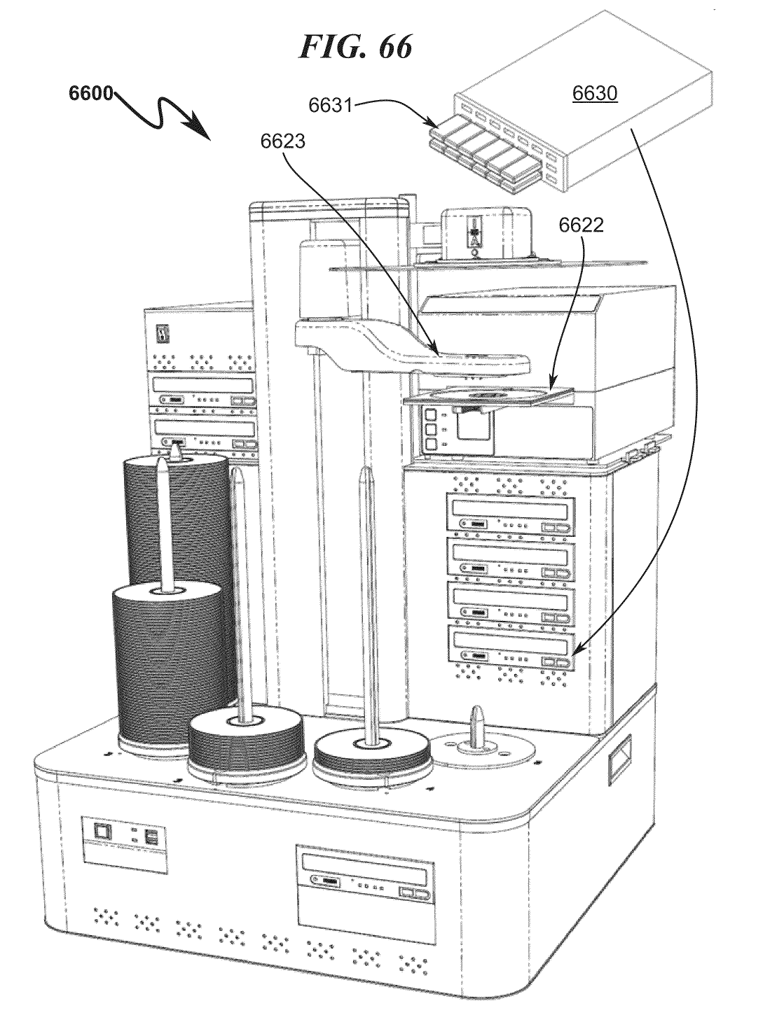

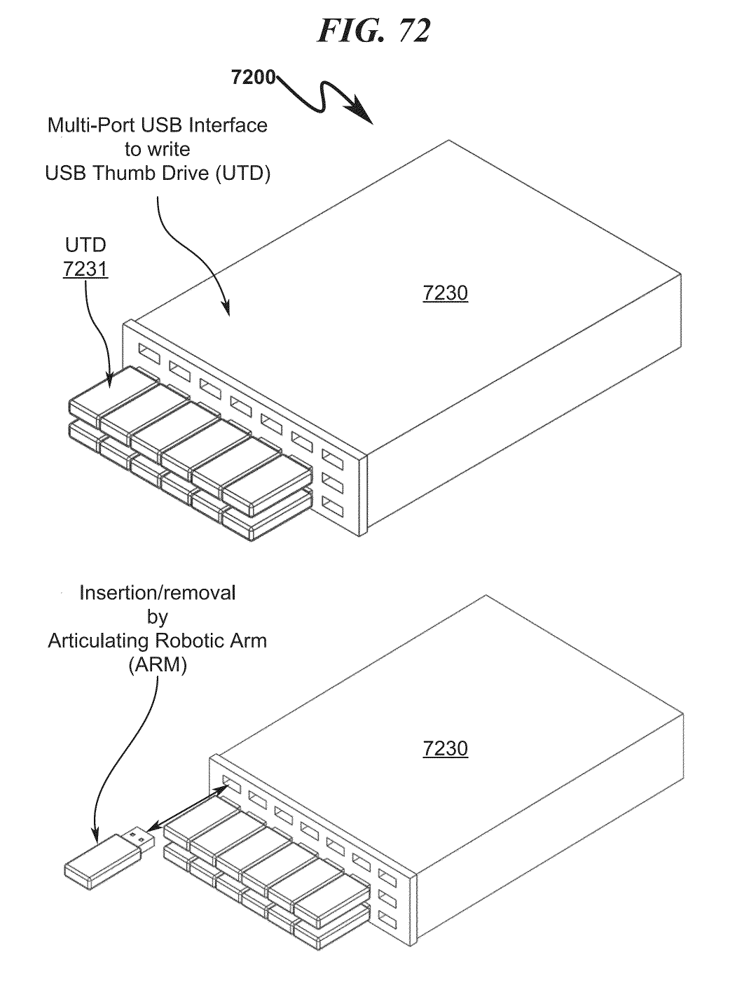

Exemplary implementations of the robotic arm computer (RAC) and articulating robotic arm (ARM) are generally depicted in FIG. 65 (6500)-FIG. 72 (7200). An exemplary RAC/ARM configuration is depicted in perspective views of FIG. 65 (6500) and FIG. 66 (6600) wherein the ARM (6523, 6623) is positioned over a source media stack (6526) and a media duplicator (6622) in which the media is written.

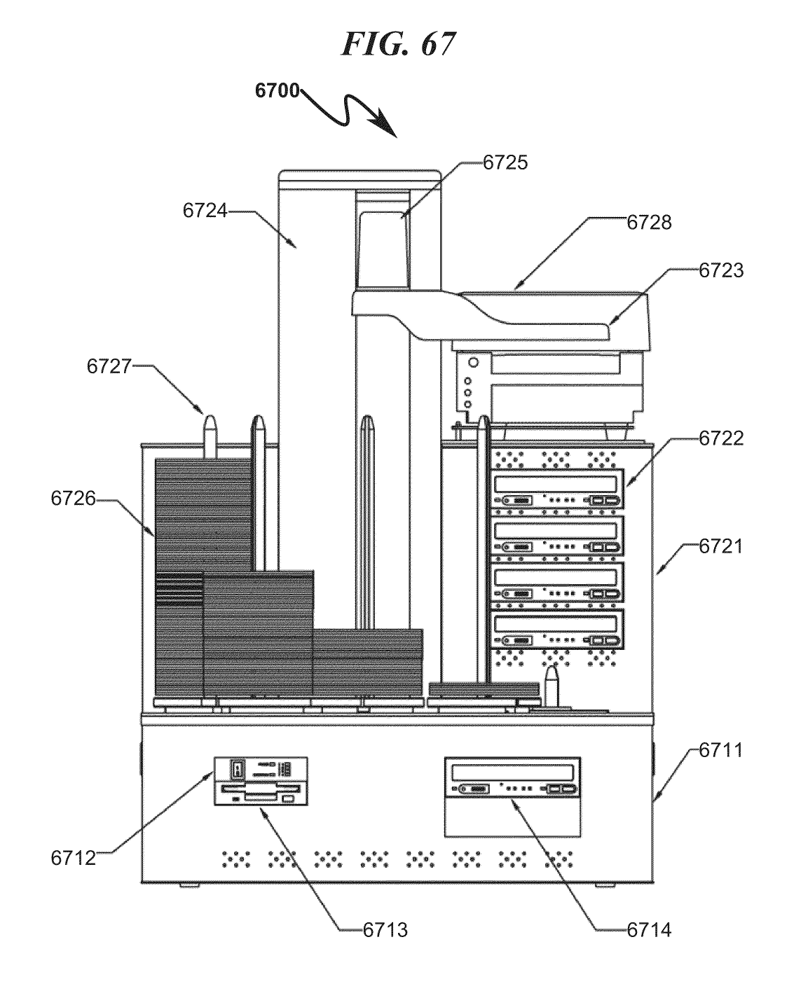

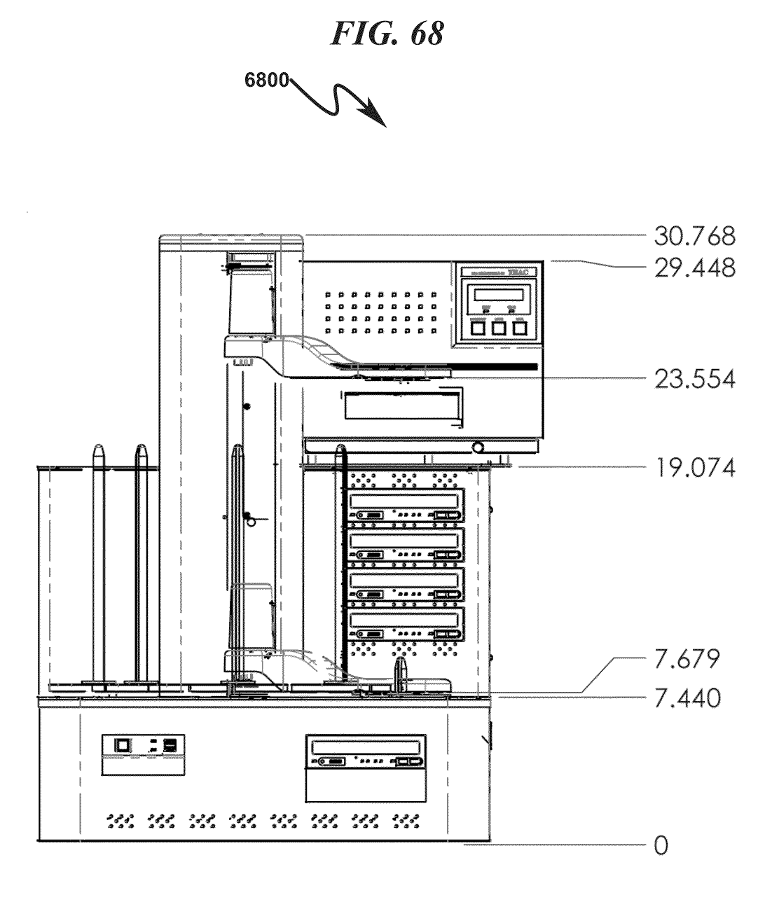

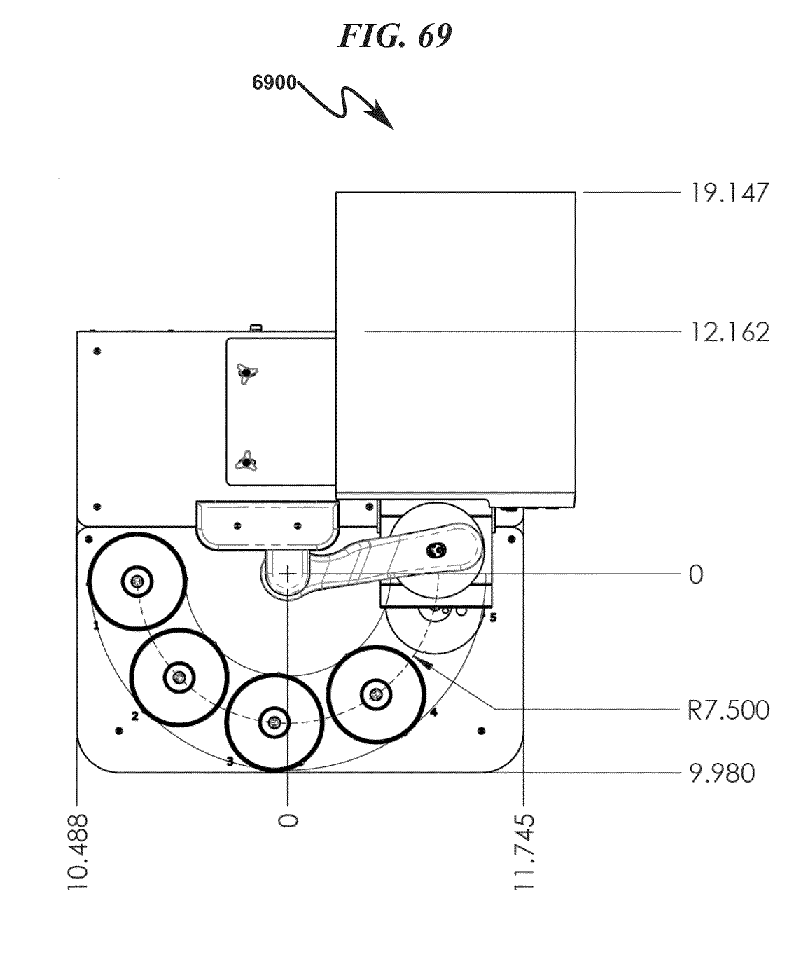

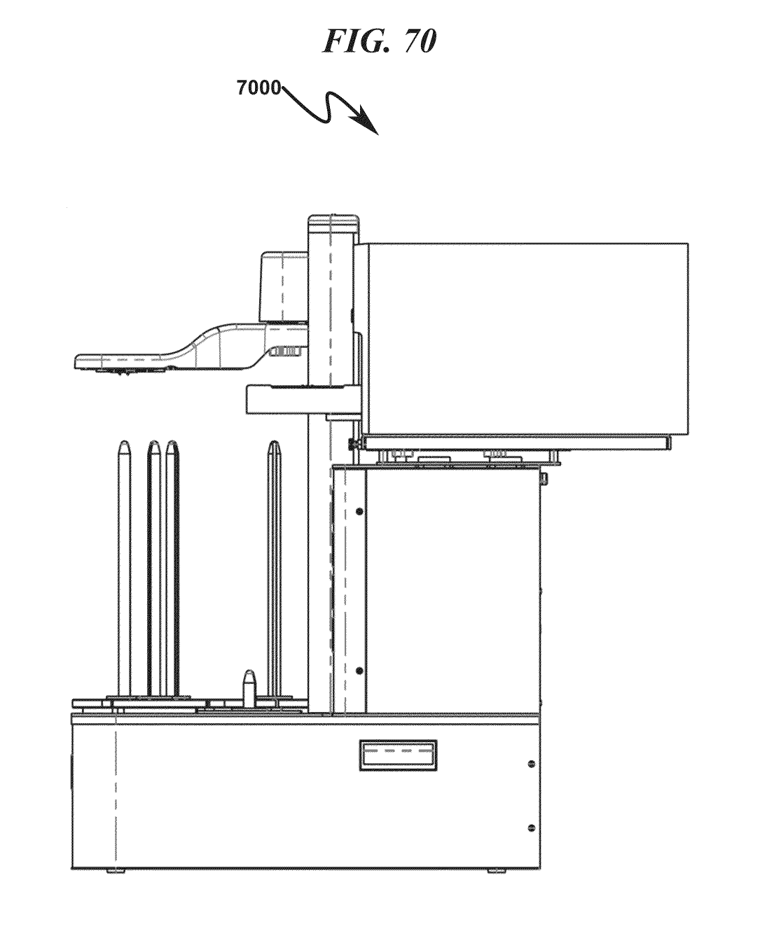

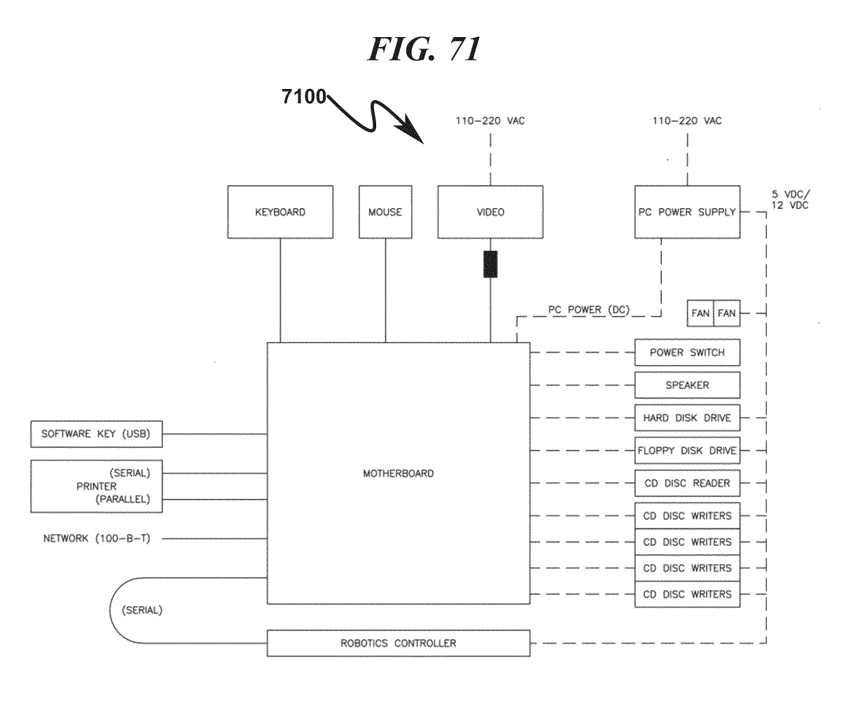

As depicted in FIG. 67 (6700), the RAC comprises an enclosure (6711) comprising custom computer motherboard, power supply, and local hard drive storage, power switch and indicators (6712), floppy disk drive for loading computer readable media (6713), and a disk reader drive (6714) for manually loading software and/or data into the RAC. A drive enclosure (6721) housing media writing duplicators (6722) is interfaced with a transport arm and gripper (6723) that is controlled by a transport elevator and robotics arm controller (6724) under direction of the RAC to articulate the transport arm and gripper (6723) via a transport hoist (6725) to retrieve media (6726) from disc storage spindles (6727) for placement in the media writing duplicators (6722) and later transport to the secure media lockboxes (SML). A disc printer (6728) permits customized labeling of the disc media during this process to identify the multimedia content written to the disc media (6726). The front view of FIG. 68 (6800) and top view of FIG. 69 (6900) provide exemplary system dimensions in centimeters. FIG. 70 (7000) provides a side view of the system depicting the relationship between the robotic arm, source media stacks, and media duplicator. Additional detail of a typical hardware configuration is depicted in the system block diagram of FIG. 71 (7100).

While the system depicted in FIG. 65 (6500)-FIG. 72 (7200) illustrates a disc duplication system, a corresponding robotic arm computer (RAC) and articulating robotic arm (ARM) system may be constructed utilizing USB thumb drive (UTD) media as the duplication media of choice. In this scenario the UTDs are loaded in bulk into bins and retrieved by the ARM under control of the RAC. Once retrieved from the storage bin, the UTD is inserted into one of a number of USB ports coupled to the kiosk media duplicator by the RAC and securely loaded with media content as described herein. An exemplary USB port interface (6630, 7230) with inserted UTD media (6631, 7231) is depicted in FIG. 66 (6600) and FIG. 72 (7200). Once securely loaded with media content, the UTD is removed from the USB port in the RAC and placed in the secure media lockbox (SML) by the ARM. This method of duplication is more efficient than that of typical disc media duplicators because the aggregate bandwidth of the customized RAC to the USB ports on the system may be considerably higher than that possible using prior art disc media duplicators. Additionally, due to the size constraints of typical media duplicators, a large number of USB ports may be provided in the duplication system for each disc duplicator front panel footprint. For example a typical disc duplication writer has a form factor of approximately 5.8 x 1.6 inches. This panel space can support approximately 21 or more UTD devices (6631, 7231) simultaneously in the USB port matrix (6630, 7230) as depicted by the example illustrated in FIG. 66 (6600) and FIG. 72 (7200).

### Cooperating CCD Media Duplication/Distribution

As mentioned elsewhere herein, the CCDs within the kiosks may communicate with each other to allow duplication of digital media content to occur on any cooperating media distribution kiosk, and also allow pickup of completed media on any of the secure media lockboxes contained within each kiosk. Thus, rather than waiting for a media duplication to occur, a customer may be redirected to a media kiosk having prerecorded media ready for distribution.

### System Summary

The present invention system anticipates a wide variety of variations in the basic theme of construction, but can be generalized as a media distribution system comprising:
(a) computing control device (CCD);
(b) media duplication device (MDD);
(c) cash currency receptor (CUR);
(d) cash currency dispenser (CUD);
(e) media content printer (MCP);
(f) media content labeler (MCL);
(g) robotic arm computer (RAC);
(h) articulating robotic arm (ARM);
(i) secure media lockbox (SML);
(j) media lockbox interface (MLI);
(k) media storage unit (MSU); and
(l) computer communication network (CCN);
wherein:
the MTU comprises hardware configured to securely store digital media content;
the MSU is configured to store a plurality of unwritten media transportation unit (MTU) elements;
the CCD further comprises a user input keypad (UIK) and video display device (VDD);

the CCD is configured to retrieve digital media content (DMC) from a remote computer server via the CCN and store the DMC on a digital storage device (DSD) proximal to the CCD;
the CCD is configured to accept digital media content requests (DMR) from the UIK or via the CCN by way of a website server connected to the CCN;
the CCN is configured to match the DMR with data stored on the DSD;
the CCN is configured to send instructions to the RAC to articulate the ARM to retrieve an unwritten MTU from the MSU and place the unwritten MTU in control of the MDD;
the CCN is configured to transfer matching DMR data stored on the DSD to the MDD for storage in the unwritten MTU to form a written MTU;
the CCN is configured to send instructions to the RAC to articulate the ARM to retrieve the written MTU from the MDD and place the written MTU in one or more of the SML;
the MCL is configured to label the written MTU with information relating to the DMR; and
the CCN is configured to receive instructions from the MLI to control access to the SML and the written MTU.

This general system summary may be augmented by the various elements described herein to produce a wide variety of invention embodiments consistent with this overall design description.

### METHOD SUMMARY

The present invention method anticipates a wide variety of variations in the basic theme of implementation, but can be generalized as a media distribution method comprising:
(1) with a computing control device (CCD), accepting digital media content requests (DMR) from a user input keypad (UIK) and video display device (VDD) or via a computer communication network (CCN) by way of a website server connected to the CCN;
(2) with the CCD, retrieving digital media content (DMC) from a remote computer server via the CCN and storing the DMC on a digital storage device (DSD) proximal to the CCD;
(3) with the CCN, matching the DMR with data stored on the DSD;
(4) with the CCN, sending instructions to a robotic arm computer (RAC) to position an articulating robotic arm (ARM) to retrieve an unwritten media transportation unit (MTU) from a media storage unit (MSU) and placing the unwritten MTU in control of a media duplication device (MDD);
(5) with the CCN, transferring matching DMR data stored on the DSD to the MDD for storage in the unwritten MTU to form a written MTU;
(6) with the CCN, securely storing the matching DMR data stored on the DSD to the MTU;
(7) with the CCN, sending instructions to the RAC to articulate the ARM to retrieve the written MTU from the MDD and place the written MTU in one or more of a secure media lockbox (SML);
(8) with a media content labeler (MCL), labeling the written MTU with information relating to the DMR; and
(9) with the CCN, receiving instructions from a media lockbox interface (MLI) to control access to the SML and the written MTU.

This general method summary may be augmented by the various elements described herein to produce a wide variety of invention embodiments consistent with this overall design description.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the MTU comprises a secure USB thumb drive (UTD) having a USB interface processor (UIP) supporting a USB thumb drive file storage interface and a plurality of file systems implemented using flash memory contained within the UTD.
An embodiment wherein the MTU comprises a secure USB thumb drive (UTD) having a USB interface processor (UIP), foreground file system (FFS) implemented using flash memory contained within the UTD, and background file system (BFS) implemented using flash memory contained within the UTD.
An embodiment wherein the MTU comprises a secure USB thumb drive (UTD) having a foreground file system (FFS) flash memory configured for read-only access containing an AUTORUN.INF script file and device-dependent software application (DSA) wherein the AUTORUN.INF script is configured to execute the DSA in the context of a mobile playback device (MPD) and the DSA comprises machine instructions that are uniquely selected based on a private silicon serial number (SSN) contained within the UTD.
An embodiment wherein the MTU comprises a secure USB thumb drive (UTD) having a background file system (BFS) flash memory configured for access via a phantom access protocol (PAP) that is linked to a private silicon serial number (PRN) contained within the UTD.
An embodiment wherein the MTU comprises a secure USB thumb drive (UTD) having a lithium battery-backed real-time clock (RTC).
An embodiment wherein the MTU comprises a secure USB thumb drive (UTD) having a public silicon serial number (PUN) and private silicon serial number (PRN) pair uniquely identifying the UTD wherein the PUN is publically available for read access but the PRN is not publically available for read access.
An embodiment wherein the MTU comprises a secure USB thumb drive (UTD) having a private silicon serial number (PRN) that defines a phantom access protocol (PAP) read sequence to the UTD that unlocks a background file system (BFS) implemented in flash memory on the UTD.
An embodiment wherein the MTU comprises a secure USB thumb drive (UTD) having a plurality of silicon serial numbers (SSNs) uniquely identifying the UTD.
An embodiment wherein the MTU comprises a secure USB thumb drive (UTD) configured to limit access to a background file system (BFS) based on digital rights management (DRM) time information including RELEASE DATE and EXPIRATION DATE stored within the BFS that is compared against data retrieved in real-time from a real-time clock (RTC) contained within the UTD.
An embodiment wherein the MTU comprises a DVD encoded with anti-copying track information.
An embodiment wherein the CCD is configured to coordinate the operation of the RAC and the MDD to duplicate a plurality of the MTUs in anticipation of future customer demand, the duplicated MTUs stored in a plurality of the SMLs.
An embodiment wherein the CCD is configured to track consumer demand for the DMC and coordinate the operation of the RAC and the MDD to duplicate a plurality of the MTUs in anticipation of future customer demand for the DMC, the duplicated MTUs stored in a plurality of the SMLs.
An embodiment wherein the CCD is configured to coordinate the operation of the RAC and the MDD to copy the DMC to the MTU in response to a remote customer request to the website server, the MTU being placed in the SML by the ARM under direction of the RAC for delivery to a local customer.
An embodiment wherein the CCD is configured to coordinate the operation of the RAC and the MDD to copy the DMC to the MTU in response to a remote customer request to the website server and notify the remote customer via electronic mail or text message when the DMC transfer to the MTU is complete and the MTU has been placed in the SML and is ready for pickup.
An embodiment wherein the CCD is configured to communicate to a CCD in a second media distribution system to direct the pickup of a MTU by a customer from a SML on the second media distribution system.
An embodiment wherein the system is configured in a paired unit having side-by-side customer interfaces to the CCD and with the SMLs being positioned on the sides of the paired units.
An embodiment wherein the system is configured in a mirrored double-sided paired unit, wherein each paired unit is configured with side-by-side customer interfaces to the CCD and with the SMLs being positioned on the sides of the mirrored double-sided paired unit and shared among front and rear customer interfaces to the CCD.
An embodiment wherein the system is configured in a triad of paired units, with each of the paired units having side-by-side customer interfaces to the CCD and with the SMLs being positioned on the sides of each of the paired units.
An embodiment wherein the CCD is configured to communicate to a CCD in a second media distribution system to direct the pickup of a MTU by a customer from a SML on the second media distribution system.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A media distribution system and method incorporating parallel delivery of media content has been disclosed. The system/method incorporates a media distribution kiosk (MDK) having a media duplication device (MDD) to write media transportation unit (MTU) with secure media content to be distributed to a consumer. The MTU is electrically coupled to the MDD via a media robotic arm (MRA) under direction of a computing control device (CCD). The MDD stores media content retrieved from a media storage server (MSS) on the MTU in response to a local or remote consumer media transaction (CMT) with the MDK. Once written, the MTU is decoupled from the MDD by the MRA and placed in a secure media lockbox (SML). The SML is associated with the CMT by the CCD such that the consumer may access the lockbox via a secure keypad and/or credit/debit card reader.

### CLAIMS INTERPRETATION

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. §112(f) and such claim shall be construed to cover the corresponding structure, material, or acts described in the specification and equivalents thereof.
The phrase “MEANS FOR” specifically invokes the means-plus-function claims limitation recited in 35 U.S.C. §112(f) and such claim shall be construed to cover the corresponding structure, material, or acts described in the specification and equivalents thereof.
The phrase “STEP FOR” specifically invokes the step-plus-function claims limitation recited in 35 U.S.C. §112(f) and such claim shall be construed to cover the corresponding structure, material, or acts described in the specification and equivalents thereof.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

1. A media distribution system comprising:
(a) computing control device (CCD);
(b) media duplication device (MDD);
(c) cash currency receptor (CUR);
(d) cash currency dispenser (CUD);
(e) media content printer (MCP);
(f) media content labeler (MCL);
(g) robotic arm computer (RAC);
(h) articulating robotic arm (ARM);
(i) secure media lockbox (SML);
(j) media lockbox interface (MLI);
(k) media storage unit (MSU); and
(l) computer communication network (CCN);
wherein:
said MTU comprises hardware configured to securely store digital media content;
said MSU is configured to store a plurality of unwritten media transportation unit (MTU) elements;
said CCD further comprises a user input keypad (UIK) and video display device (VDD);
said CCD is configured to retrieve digital media content (DMC) from a remote computer server via said CCN and store said DMC on a digital storage device (DSD) proximal to said CCD;
said CCD is configured to accept digital media content requests (DMR) from said UIK or via said CCN by way of a website server connected to said CCN;
said CCN is configured to match said DMR with data stored on said DSD;
said CCN is configured to send instructions to said RAC to articulate said ARM to retrieve an unwritten MTU from said MSU and place said unwritten MTU in control of said MDD;
said CCN is configured to transfer matching DMR data stored on said DSD to said MDD for storage in said unwritten MTU to form a written MTU;
said CCN is configured to send instructions to said RAC to articulate said ARM to retrieve said written MTU from said MDD and place said written MTU in one or more of said SML;
said MCL is configured to label said written MTU with information relating to said DMR; and
said CCN is configured to receive instructions from said MLI to control access to said SML and said written MTU.

2. The media distribution system of claim 1 wherein said MTU comprises a secure USB thumb drive (UTD) having a USB interface processor (UIP) supporting a USB thumb drive file storage interface and a plurality of file systems implemented using flash memory contained within said UTD.

3. The media distribution system of claim 1 wherein said MTU comprises a secure USB thumb drive (UTD) having a USB interface processor (UIP), foreground file system (FFS) implemented using flash memory contained within said UTD, and background file system (BFS) implemented using flash memory contained within said UTD.

4. The media distribution system of claim 1 wherein said MTU comprises a secure USB thumb drive (UTD) having a foreground file system (FFS) flash memory configured for read-only access containing an AUTORUN.INF script file and device-dependent software application (DSA) wherein said AUTORUN.INF script is configured to execute said DSA in the context of a mobile playback device (MPD) and said DSA comprises machine instructions that are uniquely selected based on a private silicon serial number (SSN) contained within said UTD.

5. The media distribution system of claim 1 wherein said MTU comprises a secure USB thumb drive (UTD) having a background file system (BFS) flash memory configured for access via a phantom access protocol (PAP) that is linked to a private silicon serial number (PRN) contained within said UTD.

6. The media distribution system of claim 1 wherein said MTU comprises a secure USB thumb drive (UTD) having a lithium battery-backed real-time clock (RTC).

7. The media distribution system of claim 1 wherein said MTU comprises a secure USB thumb drive (UTD) having a public silicon serial number (PUN) and private silicon serial number (PRN) pair uniquely identifying said UTD wherein said PUN is publically available for read access but said PRN is not publically available for read access.

8. The media distribution system of claim 1 wherein said MTU comprises a secure USB thumb drive (UTD) having a private silicon serial number (PRN) that defines a phantom access protocol (PAP) read sequence to said UTD that unlocks a background file system (BFS) implemented in flash memory on said UTD.

9. The media distribution system of claim 1 wherein said MTU comprises a secure USB thumb drive (UTD) having a plurality of silicon serial numbers (SSNs) uniquely identifying said UTD.

10. The media distribution system of claim 1 wherein said MTU comprises a secure USB thumb drive (UTD) configured to limit access to a background file system (BFS) based on digital rights management (DRM) time information including RELEASE DATE and EXPIRATION DATE stored within said BFS that is compared against data retrieved in real-time from a real-time clock (RTC) contained within said UTD.

11. The media distribution system of claim 1 wherein said MTU comprises a DVD encoded with anti-copying track information.

12. The media distribution system of claim 1 wherein said CCD is configured to coordinate the operation of said RAC and said MDD to duplicate a plurality of said MTUs in anticipation of future customer demand, said duplicated MTUs stored in a plurality of said SMLs.

13. The media distribution system of claim 1 wherein said CCD is configured to track consumer demand for said DMC and coordinate the operation of said RAC and said MDD to duplicate a plurality of said MTUs in anticipation of future customer demand for said DMC, said duplicated MTUs stored in a plurality of said SMLs.

14. The media distribution system of claim 1 wherein said CCD is configured to coordinate the operation of said RAC and said MDD to copy said DMC to said MTU in response to a remote customer request to said website server, said MTU being placed in said SML by said ARM under direction of said RAC for delivery to a local customer.

15. The media distribution system of claim 1 wherein said CCD is configured to coordinate the operation of said RAC and said MDD to copy said DMC to said MTU in response to a remote customer request to said website server and notify said remote customer via electronic mail or text message when said DMC transfer to said MTU is complete and said MTU has been placed in said SML and is ready for pickup.

16. The media distribution system of claim 1 wherein said CCD is configured to communicate to a CCD in a second media distribution system to direct the pickup of a MTU by a customer from a SML on said second media distribution system.

17. The media distribution system of claim 1 wherein said system is configured in a paired unit having side-by-side customer interfaces to said CCD and with said SMLs being positioned on the sides of said paired unit.

18. The media distribution system of claim 1 wherein said system is configured in a mirrored double-sided paired unit, wherein each paired unit is configured with side-by-side customer interfaces to said CCD and with said SMLs being positioned on the sides of said mirrored double-sided paired unit and shared among front and rear customer interfaces to said CCD.

19. The media distribution system of claim 1 wherein said system is configured in a triad of paired units, with each said paired unit having side-by-side customer interfaces to said CCD and with said SMLs being positioned on the sides of each said paired unit.

20. The media distribution system of claim 1 wherein said CCD is configured to communicate to a CCD in a second media distribution system to direct the pickup of a MTU by a customer from a SML on said second media distribution system.

21. A media distribution method comprising:
(1) with a computing control device (CCD), accepting digital media content requests (DMR) from a user input keypad (UIK) and video display device (VDD) or via a computer communication network (CCN) by way of a website server connected to said CCN;
(2) with said CCD, retrieving digital media content (DMC) from a remote computer server via said CCN and storing said DMC on a digital storage device (DSD) proximal to said CCD;
(3) with said CCN, matching said DMR with data stored on said DSD;
(4) with said CCN, sending instructions to a robotic arm computer (RAC) to position an articulating robotic arm (ARM) to retrieve an unwritten media transportation unit (MTU) from a media storage unit (MSU) and placing said unwritten MTU in control of a media duplication device (MDD);
(5) with said CCN, transferring matching DMR data stored on said DSD to said MDD for storage in said unwritten MTU to form a written MTU;
(6) with said CCN, securely storing said matching DMR data stored on said DSD to said MTU;
(7) with said CCN, sending instructions to said RAC to articulate said ARM to retrieve said written MTU from said MDD and place said written MTU in one or more of a secure media lockbox (SML);
(8) with a media content labeler (MCL), labeling said written MTU with information relating to said DMR; and
(9) with said CCN, receiving instructions from a media lockbox interface (MLI) to control access to said SML and said written MTU.

22. The media distribution method of claim 21 wherein said MTU comprises a secure USB thumb drive (UTD) having a USB interface processor (UIP) supporting a USB thumb drive file storage interface and a plurality of file methods implemented using flash memory contained within said UTD.

23. The media distribution method of claim 21 wherein said MTU comprises a secure USB thumb drive (UTD) having a USB interface processor (UIP), foreground file method (FFS) implemented using flash memory contained within said UTD, and background file method (BFS) implemented using flash memory contained within said UTD.

24. The media distribution method of claim 21 wherein said MTU comprises a secure USB thumb drive (UTD) having a foreground file method (FFS) flash memory configured for read-only access containing an AUTORUN.INF script file and device-dependent software application (DSA) wherein said AUTORUN.INF script is configured to execute said DSA in the context of a mobile playback device (MPD) and said DSA comprises machine instructions that are uniquely selected based on a private silicon serial number (SSN) contained within said UTD.

25. The media distribution method of claim 21 wherein said MTU comprises a secure USB thumb drive (UTD) having a background file method (BFS) flash memory configured for access via a phantom access protocol (PAP) that is linked to a private silicon serial number (PRN) contained within said UTD.

26. The media distribution method of claim 21 wherein said MTU comprises a secure USB thumb drive (UTD) having a lithium battery-backed real-time clock (RTC).

27. The media distribution method of claim 21 wherein said MTU comprises a secure USB thumb drive (UTD) having a public silicon serial number (PUN) and private silicon serial number (PRN) pair uniquely identifying said UTD wherein said PUN is publically available for read access but said PRN is not publically available for read access.

28. The media distribution method of claim 21 wherein said MTU comprises a secure USB thumb drive (UTD) having a private silicon serial number (PRN) that defines a phantom access protocol (PAP) read sequence to said UTD that unlocks a background file method (BFS) implemented in flash memory on said UTD.

29. The media distribution method of claim 21 wherein said MTU comprises a secure USB thumb drive (UTD) having a plurality of silicon serial numbers (SSNs) uniquely identifying said UTD.

30. The media distribution method of claim 21 wherein said MTU comprises a secure USB thumb drive (UTD) configured to limit access to a background file method (BFS) based on digital rights management (DRM) time information including RELEASE DATE and EXPIRATION DATE stored within said BFS that is compared against data retrieved in real-time from a real-time clock (RTC) contained within said UTD.
